(19) United States
(12) Patent Application Publication
(10) Pub. No.: US 2026/0249993 A1
(43) Pub. Date: Aug. 27, 2026

(54) AUTONOMOUS DELIVERY VEHICLE AND SYSTEM

(71) Applicant: Zipline International Inc., South San Francisco, CA (US)

(72) Inventors: Zoltan Laszlo, Pacifica, CA (US); Joseph Mardall, San Francisco, CA (US); Keenan Wyrobek, Half Moon Bay, CA (US); Gregoire Vandenbussche, San Francisco, CA (US); Tristan Semmelhack, San Francisco, CA (US); Scott Johnston, San Francisco, CA (US); Simon Colliss, Redwood City, CA (US); William Dannemann, San Francisco, CA (US); Nagy Hakim, San Francisco, CA (US); Mihika Hemmady, San Francisco, CA (US); Danielle Fallon, San Francisco, CA (US); Echo Wood, San Francisco, CA (US); Bryan Hood, Belmont, CA (US); Cedric Bosch, San Jose, CA (US); Devin Williams, Denver, CO (US); Ryan Wolcott, Ann Arbor, MI (US); Andrew James Frantz, Ann Arbor, MI (US); Karthik Lakshmanan, Sunnyvale, CA (US); Brian Boomgaard, Half Moon Bay, CA (US)

(21) Appl. No.: 19/161,583

(22) PCT Filed: Mar. 4, 2024
(86) PCT No.: PCT/US2024/018347

§ 371 Date: Sep. 2, 2025

Related U.S. Application Data
(60) Provisional application No. 63/449,547, filed on Mar. 2, 2023.
(60) Provisional application No. 63/524,393, filed on Jun. 30, 2023.

(51) Int. Cl. B64D 5/00; B64U 10/60; B64U 30/26; B64U 70/20; B64U 101/64; B64U 101/67

(52) U.S. Cl. CPC B64D 5/00; B64U 10/60; B64U 30/26; B64U 70/20; B64U 2101/64; B64U 2101/67; B64U 2201/10

(57) ABSTRACT

Various examples of an aerial vehicle and/or aerial vehicle system are disclosed. In one example, an aerial vehicle configured to be coupled to a main aerial vehicle is disclosed. The aerial vehicle may include a propulsion unit coupled to the body to enable independent thrust generation by the aerial vehicle.

### CROSS REFERENCE TO RELATED APPLICATIONS

This application claims the benefit of priority to U.S. Provisional Application No. 63/524,393, filed Jun. 30, 2023, and U.S. Provisional Application No. 63/449,547, filed Mar. 2, 2023, all of which are incorporated by reference herein in their entireties.

This application is related to U.S. Application No. 63/449,552, filed on Mar. 2, 2023 and titled Docking Configurations for Aerial Vehicles, U.S. Application No. 63/449,536, filed on Mar. 2, 2023 and titled Aerial Vehicle and Aerial Vehicle Systems, and U.S. Application No. 63/449,547 filed on Mar. 2, 2023 and titled Aerial Delivery Vehicle System, all of which are incorporated herein for all purposes in their entireties.

This application is related to International Patent Application No. PCT/US2024/016087, filed on Feb. 16, 2024, and titled “Docking Configurations for Aerial Vehicles,” and International Patent Application No. PCT/US2024/017632, filed on Feb. 28, 2024 and titled “Aerial Vehicle and Aerial Vehicle Systems,” all of which are incorporated by reference in their entireties.

### FIELD

The described embodiments relate generally to an aerial vehicle, such as one that may be used to deliver payloads (e.g., packages).

### BACKGROUND

Aerial vehicles, such as airplanes and unmanned vehicles (e.g. drones), have many uses. Recently, aerial vehicles are becoming a viable option for package delivery vehicles. Such aerial vehicles can take many forms, such as, but not limited to, rotorcraft (e.g., helicopters, quadrotors, and so on) as well as fixed-wing aircraft. Conventionally, package delivery from aerial vehicles has been limited to solutions like dropping a package from above a delivery location and allowing the package to fall to the delivery location either by using a parachute, using a packaging solution to protect the items being delivery, or passively lowering a package via a line to avoid having to land the aerial vehicle at the delivery site. However, these passive types of solutions may result in the package landing at an incorrect location or an unpleasant or unsafe delivery experience for a customer. For example, wind or errors in timing or releasing the payload from the aerial vehicle may result in a package failing to arrive at the intended delivery location or require a wider margin of error for a delivery location. The unpredictability of a landing location for a package and limits on controlling the package during deployment may limit the types of goods that may be shipped by conventional aerial vehicles. Additionally, uncontrolled packages falling from overhead may present safety or damage risks to bystanders or objects near the delivery location.

As aerial vehicles are used more frequently for package deliveries, there is a need for improved overall systems that allow reliable delivery of a package to a delivery location and provide an ability to safely carry a diverse array of goods in a wide range of environments to precise locations using autonomous delivery systems that create a smooth and pleasant delivery experience for a recipient.

### SUMMARY

In one example, an aerial vehicle configured to be coupled to a main aerial vehicle is provided. The aerial vehicle includes a body, a first thruster coupled to a first side of the body, and a second thruster coupled to a second side of the body.

In one example, an aerial vehicle coupled to a main aerial vehicle is disclosed. The aerial vehicle includes a body and a propulsion unit coupled to the body.

In one example, an aerial vehicle is disclosed. The aerial vehicle including a body, a thruster coupled to the body, and a duct in fluid communication with the thruster, wherein the duct is configured as an intake and outlet for the thruster.

In one example, an aerial vehicle is disclosed. The aerial vehicle including a body, a thruster coupled to the body, and a duct in fluid communication with the thruster, wherein the duct defines an opening.

In one example, an aerial vehicle is disclosed. The aerial vehicle including a body including a payload bay and at least two feet extending from a bottom surface of the body adjacent to an opening of the payload pay, wherein the at least two feet extend away from the bottom surface at an angle and act to support the body above a support surface.

In one example, an aerial vehicle is disclosed. The aerial vehicle including a body defining a payload bay, a first access cover positioned on a top surface of the body and movable between a first position covering a first aperture to the payload bay and a second position uncovering the first aperture, and a second access cover positioned on a bottom surface of the body and movable between a first position covering a second aperture to the payload bay and a second position uncovering the second aperture, wherein the first aperture is smaller than the second aperture.

In one example, an aerial vehicle is disclosed. An aerial vehicle including a body defining a payload bay accessible by a first aperture defined at a first surface of the body and a second aperture defined at a second surface of the body, a first access cover positioned on the first surface of the body and selectively covering the first aperture, and a second access cover positioned on the second surface of the body and selectively covering the second aperture.

In one example, a latch assembly for a payload bay is disclosed and includes a lid configured to be coupled to a body of the aerial vehicle, a securing member configure to lock to a corresponding receiving member on the body, and a sensing member coupled to the securing member and configured to generate a signal to indicate that the securing member is secured to the receiving member.

In one example, a door assembly for providing access to a payload bay within a body is disclosed and includes a door positioned over a portion of the payload bay, a drive gear positioned adjacent to the payload bay, and a helix gear coupled to the door and the drive gear, wherein the helix gear is arranged at an angle relative to the drive gear and movement of the drive gear causes the door to move relative to the portion of the payload bay.

In one example, a door assembly for providing access to a payload bay within a body is disclosed. The door assembly includes a door positioned over a portion of the payload bay, a link coupled to the door, a drive mechanism positioned adjacent to the payload bay, and a guide feature operatively coupled to the link and the drive gear, wherein translational movement of the drive gear causes the door to move relative to the portion of the payload bay.

In one example, a locking assembly for a vehicle id disclosed. The locking assembly including a tether assembly extending away from the vehicle and coupled to a tether, an actuated feature coupled to the tether assembly, wherein as the tether is moved past a locking location and tension on the tether is released, the spring loaded detent transitions to a lock configuration.

In one example, a locking assembly for selectively coupling a first vehicle and a second vehicle is disclosed. The locking assembly includes a tether assembly extending away from the second vehicle and coupled to a tether extending from the first vehicle, a receiving assembly coupled to the first vehicle, and an actuated feature selectively movable to couple the tether assembly and the receiving assembly.

In one example, an aerial vehicle is disclosed. The aerial vehicle including a body and a camera assembly coupled to a bottom surface of the body and arranged to have a field of view below the body.

In one example, an aerial vehicle is disclosed. The aerial vehicle including a body and a sensor assembly coupled to a bottom surface of the body.

In one example, an aerial vehicle is disclosed. The aerial vehicle including a body, a parachute container coupled to the body, wherein the parachute container is configured to introduce stiffness into the body.

In one example, a method of navigating a secondary aerial vehicle from a primary vehicle to a delivery location is disclosed. The method includes receive delivery location, obtain a satellite determined location of the secondary vehicle when the secondary vehicle is deployed from the primary vehicle, and navigate to the delivery location using the satellite determined location and input from at least two of a satellite receiver, an inertial measurement unit and visual sensors located on the secondary vehicle.

In one example, a method of navigating an aerial vehicle to a delivery location is disclosed. The method includes gathering, using one or more sensors on the aerial vehicle, two dimensional image data of an environment during descent of the aerial vehicle, utilizing a neural network to obtain depth information for pixels in the two dimensional image data, and navigating to a delivery location using at least the depth information.

In one example, a method is disclosed and includes generating training data from aerial vehicles in a plurality of environments, the training data including stereo camera data from the aerial vehicles and LiDAR data associated with the plurality of environments, training one or more neural networks using the training data, and navigating an additional aerial vehicle utilizing the one or more neural networks.

In one example, an aerial vehicle system is disclosed. The aerial vehicle system includes a first aerial vehicle having a first body having a first center of gravity, a second aerial vehicle having a second body having a second center of gravity, and a non-conductive tether extending between and coupling the first aerial vehicle and the second aerial vehicle.

In one example, an aerial delivery system is disclosed that includes a first aerial vehicle and a second aerial vehicle mechanically and electrically coupled to the first aerial vehicle, wherein the second aerial vehicle is configured to generate propulsion forces separate from forces provided due to movement of the aerial vehicle.

An aerial vehicle system where the second aerial vehicle includes a payload bay, where the payload bay includes a first access location and a second access location where the first access location and the second access location are positioned on different surfaces of the second aerial vehicle.

An aerial vehicle system where the first access location includes an aperture on a top surface of the second aerial vehicle and is configured to enable loading of payload into the payload bay and the second access location includes an aperture on a bottom surface of the second aerial vehicle and is configured to enable exit of the payload from the payload bay.

An aerial vehicle system where the second aerial vehicle includes a stabilizer extending from a top surface towards a direction of the first aerial vehicle.

An aerial vehicle system where the stabilizer is configured as a rigid structure or a rigid tube and is configured to couple to a tether extending from the first aerial vehicle.

An aerial vehicle system where the second aerial vehicle includes a thruster configured to generate propulsion forces, the forces configured to generate thrust in any direction. The thruster may be positioned within a duct of the second aerial vehicle and the duct may extend between two surfaces of the second aerial vehicle.

An aerial vehicle system where the second aerial vehicle includes one or more depth sensors to assist with a delivery of a payload from the second aerial vehicle.

An aerial vehicle system where the second aerial vehicle is configured to support a payload therein, where the payload is positioned on a rigid surface or a rigid member while stowed within the second aerial vehicle. The rigid surface may be a bottom surface of the second aerial vehicle.

An aerial vehicle system where a delivery height for a payload is configured as a height no greater than 12 inches above a ground or support surface.

A number of feature refinements and additional features are applicable in the first aspect and contemplated in light of the present disclosure. These feature refinements and additional features may be used individually or in any combination. As such, each of the following features that will be discussed may be, but are not required to be, used with any other feature combination of the first aspect.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts a bottom right perspective view of an example aerial vehicle system including a primary aerial vehicle and a secondary aerial vehicle.

FIG. 2 depicts a right elevation view the aerial vehicle system of FIG. 1 with the secondary vehicle stowed in the primary vehicle.

FIG. 3 depicts a top right perspective view of an example secondary vehicle.

FIG. 4A depicts a right elevation view of an example secondary vehicle.

FIG. 4B depicts a right elevation view of another example secondary vehicle.

FIG. 5 depicts a front elevation view of an example secondary vehicle.

FIG. 6 depicts a plan view of an example secondary vehicle.

FIG. 7 depicts a bottom plan view of an example secondary vehicle.

FIG. 8A depicts a cross sectional view of the example secondary vehicle of FIG. 6 as indicated by line 6-6.

FIG. 8B depicts a cross sectional view of another example secondary vehicle.

FIG. 8C depicts an exploded view of a portion of the body of the secondary vehicle of FIG. 8B.

FIG. 9 depicts a top right perspective view of an example secondary vehicle and payload.

FIG. 10A depicts a top left perspective view of a lid assembly of an example secondary vehicle.

FIG. 10B depicts a close up perspective view of the example secondary vehicle of FIG. 10A.

FIG. 11A depicts a top left perspective view of a lid assembly of an example secondary vehicle.

FIG. 11B depicts a perspective view of a frame of the lid assembly of FIG. 11A.

FIG. 11C depicts a cross section of a hinge portion of the lid assembly of FIG. 11A.

FIG. 12A depicts a front right perspective view of a payload release assembly of an example secondary vehicle.

FIG. 12B depicts a front elevation view of the secondary vehicle of FIG. 12A.

FIG. 13 depicts a perspective view of a payload release assembly of an example secondary vehicle.

FIG. 14A depicts a rear right perspective view of another example of the payload release assembly of an example secondary vehicle.

FIG. 14B depicts an example of the drive mechanism of the payload release assembly of FIG. 14A.

FIG. 14C depicts a view of the example payload release assembly of FIG. 14A in a semi-open configuration.

FIG. 15 depicts a perspective view of a tether assembly of an example secondary vehicle.

FIG. 16A depicts a perspective view of a tether assembly and retraction assembly of an example aerial vehicle system.

FIG. 16B depicts a cross sectional view of a tether assembly and retraction assembly of an example aerial vehicle system.

FIG. 17A depicts an enlarged view of the cross section of FIG. 17 with the tether assembly in a ready to lock configuration.

FIG. 17B depicts an enlarged view of the cross section of FIG. 17 with the tether assembly in a locked configuration.

FIG. 17C depicts an enlarged view of the cross section of FIG. 17 with the tether assembly in an unlocked and unreleased configuration.

FIG. 17D depicts an enlarged view of the cross section of FIG. 17 with the tether assembly in an unlocked and released configuration.

FIG. 17E depicts an enlarged view of the cross section of FIG. 17 showing an example tether assembly and receiver.

FIG. 18A depicts a portion of another example of a tether assembly.

FIG. 18B depicts a perspective view of a portion of the tether assembly of FIG. 18A.

FIG. 18C depicts a perspective view of another example of a portion of the receiver assembly.

FIG. 18D depicts a cross sectional view of another example of the tether assembly.

FIG. 18E depicts an exploded view of the example tether assembly and receiver assembly of FIGS. 18D and 18C, respectively.

FIG. 18F depicts a bottom perspective view of a portion of the receiver assembly.

FIG. 18G depicts a perspective view of another portion of the receiver assembly.

FIG. 18H depicts a perspective view of another portion of the receiver assembly.

FIG. 18I depicts a cross sectional view of another portion of the receiver assembly.

FIG. 19A depicts a cross section of a locking step to couple the example receiver assembly and tether assembly.

FIG. 19B depicts a perspective view of another locking step to couple the example receiver assembly and tether assembly.

FIG. 19C depicts a cross section of the locking step of FIG. 19B to couple the example receiver assembly and tether assembly.

FIG. 19D depicts a cross section of another locking step to couple the example receiver assembly and tether assembly.

FIG. 19E depicts a perspective view of the locking step of FIG. 19D to couple the example receiver assembly and tether assembly.

FIG. 19F depicts a cross section of another locking step to couple the example receiver assembly and tether assembly.

FIG. 19G depicts a perspective view of the locking step of FIG. 19F to couple the example receiver assembly and tether assembly.

FIG. 19H depicts a cross section of an example locked configuration of the example receiver assembly and tether assembly.

FIG. 19I depicts a perspective view of the locked configuration of FIG. 19H of the example receiver assembly and tether assembly.

FIG. 20 is a top perspective view of an example secondary aerial vehicle.

FIG. 21 is a top cross sectional view of the example secondary vehicle of FIG. 20.

FIG. 22A is a front cross sectional view of the example secondary vehicle of FIG. 20.

FIG. 22B is a rear cross sectional view of the example secondary vehicle of FIG. 20.

FIG. 23A is a top cross sectional view of another example secondary vehicle.

FIG. 23B is a front cross sectional view of another example secondary vehicle.

FIG. 23C is a rear cross sectional view of another example secondary vehicle.

FIG. 24 is a rear left perspective view of a rear propulsion assembly of an example secondary vehicle.

FIG. 25 is a cross sectional view of the example rear propulsion assembly of FIG. 24.

FIG. 26A is a front perspective view of an example secondary vehicle with the access cover removed.

FIG. 26B is a front perspective view of another example secondary vehicle with a portion of the front or body removed.

FIG. 27 shows an example recovery assembly.

FIG. 28 shows a cross section of the example recovery assembly of FIG. 27.

FIG. 29A is a top left perspective view of an example power source for a secondary vehicle.

FIG. 29B is a partial exploded view of the power source of FIG. 29A.

FIG. 30A is a bottom left perspective view of another example of a power source for the secondary vehicle.

FIG. 30B is a cross sectional view of the power source of FIG. 30A.

FIG. 31 is a bottom view of an example secondary vehicle showing an example power source and sensor assembly.

FIG. 32A is a perspective view of the example sensor assembly of FIG. 31.

FIG. 32B is a bottom view of the example sensor assembly of FIG. 32A with the housing removed.

FIG. 33C is a rear right perspective view of the sensor assembly of FIG. 31-32B and a partial aft thruster assembly.

FIG. 34A is a bottom view of an example secondary vehicle showing another example of the sensor assembly.

FIG. 34B is a perspective view of the example sensor assembly of FIG. 33A.

FIG. 35 is a schematic diagram of compute resources in an aerial vehicle, in accordance with various examples of the disclosure.

FIG. 36 illustrates example input to and output from stereo depth estimation and semantic understanding models, in accordance with various examples of the disclosure.

FIG. 37 illustrates example depth information generated using the semantic understanding model and/or the depth estimation model.

FIG. 38 illustrates a flow chart for an example method of navigating an aerial vehicle in an environment using depth information for the environment, in accordance with various examples of the disclosure.

FIG. 39 illustrates a flow chart for an example method of training neural networks for navigation of an aerial vehicle, in accordance with various examples of the disclosure.

FIG. 40 illustrates a flow chart for an example method of navigating a secondary aerial vehicle from a primary aerial vehicle to a delivery location, in accordance with various examples of the disclosure.

FIG. 41 is a schematic diagram of an example computer system for implementing various embodiments in the examples described herein.

### DETAILED DESCRIPTION

The description that follows includes sample systems, methods, and apparatuses that embody various elements of the present disclosure. However, it should be understood that the described disclosure may be practiced in a variety of forms in addition to those described herein.

The examples described herein are generally directed to aerial vehicles or systems utilizing aerial vehicles. The aerial vehicles may be utilized in a delivery system configured to pick up a payload or a package at a shipping location and deliver a payload or package to a delivery location in a rural and/or urban environment.

An example aerial vehicle delivery system may include a primary aerial vehicle, also referred to as a first, main, or carrier aerial vehicle, and a secondary aerial vehicle, which may be a delivery, deployable, or ancillary aerial vehicle. The primary aerial vehicle may carry or hold the secondary aerial vehicle and the secondary aerial vehicle may house or carry a payload for delivery. The payload may be a good or package including consumer goods, food, medical supplies, or other items. Additional variations of the primary aerial vehicle and/or the secondary aerial vehicle may include types of rotorcraft (e.g., helicopters, quadrotors, and so on) or similar vehicles that generate thrust through the use of rotating components, as well as fixed-wing aerial vehicles.

The primary aerial vehicle may enable flights over a distance, such as from a payload receiving location to a payload drop or delivery location. The payload receiving location may include a retail, wholesale, industrial, mail carrier, or other site in which payloads and packages are processed for delivery to a customer. The payload drop or delivery location may include an area or physical location in which the payload or package is delivered, including, without a limitation, a residential or commercial location. The delivery location may be designated as a specific portion of a building or area, such as a door, a window, a deck, a roof, a parking area, or other locations accessible by a delivery recipient. In this regard, the primary aerial vehicle may transport the secondary aerial vehicle between the payload receiving location and the payload delivery location. At the payload delivery location, the primary aerial vehicle may hover or otherwise fly in a stable or consistent flight configuration. The primary aerial vehicle may be configured to release the secondary aerial vehicle at a designated delivery location adjacent to a ground or to a receiving surface at the delivery location. At the designated delivery location, the secondary aerial vehicle may deliver the payload or package for subsequent retrieval by the customer.

The secondary aerial vehicle may be coupled to the primary aerial vehicle via a retraction assembly including a tether between the primary aerial vehicle and the secondary aerial vehicle. The primary aerial vehicle and secondary aerial vehicle may be in operative communication with each other, such as through wireless networks, cell networks, radio frequencies, wired, or other communication methods. At the delivery location, the secondary aerial vehicle may descend from the primary aerial vehicle toward a delivery area (e.g., the ground or a landing platform) at the delivery location. The descent or ascent may be controlled by a feature of the primary aerial vehicle, such as the retraction or winch assembly, controlling the rate at which the tether is released or retracted. Either, or both, of the primary aerial vehicle and the secondary aerial vehicle may control the rate of descent or ascent of the secondary aerial vehicle via the retraction assembly.

The secondary aerial vehicle may include a tether assembly to connect the second aerial vehicle with the primary aerial vehicle. The secondary aerial vehicle may include a tether mount to receive an end of the tether. A tether lock or lock mechanism may be coupled with the tether or to one of the primary aerial vehicle or secondary aerial vehicle to secure the tether to the tether mount and to removably and selectively secure the secondary aerial vehicle within the primary aerial vehicle when the tether is retracted.

The secondary aerial vehicle may include a variety of systems and assemblies to control the orientation, position, rate of travel or similar aspects of the secondary aerial vehicle during the travel between the primary aerial vehicle and the delivery location. The secondary aerial vehicle may have passive or active features to assist in stabilizing or controlling the secondary aerial vehicle. To that end, although various embodiments may be discussed with respect to the secondary aerial vehicle, in some embodiments, features may be incorporated into a primary aerial vehicle and/or payload delivering vehicle (that may or may not be coupled to another vehicle).

The secondary aerial vehicle may have a body with an aerodynamic shape and features to align the secondary aerial vehicle after the secondary aerial vehicle detaches from the primary aerial vehicle. The aerodynamic shape and features may also stabilize the secondary aerial vehicle during deployment from the primary aerial vehicle.

The body of the secondary aerial vehicle may include a volume or feature to house the payload, e.g., a payload bay. In some examples, the payload bay may be accessible through one or more apertures by one or more selectively openable assemblies, such as a lid or doors, to place a payload in the bay or to remove the payload from the bay at the delivery location. In some locations, a loading aperture and an exit aperture may be defined in separate surfaces of the delivery vehicle.

The secondary aerial vehicle may include a propulsion assembly allowing the secondary aerial vehicle to move relative to the primary aerial vehicle. The propulsion assembly may provide active control of the secondary aerial vehicle during deployment. The propulsion assembly may include one or more thrusters allowing the secondary aerial vehicle to move forward and rearward. The propulsion assembly may include one or more thrusters for translation or rotation of the secondary aerial vehicle. The thrusters may be positioned or configured to enable generation of thrust irrespective of the position of the secondary aerial vehicle. The propulsion assemblies may enable precise and stable delivery of the payload at the payload destination, e.g., by counteracting wind forces. For example, the secondary aerial vehicle may include active thrust generators that enable the secondary aerial vehicle to navigate the environment in multiple directions, allowing it to change directions and velocity quickly and regardless of the orientation of the secondary aerial vehicle. In instances where the secondary aerial vehicle has a single directional thruster and/or more limited movement capabilities, it may have to reach a particular orientation (e.g., slowly turn itself to face a particular direction) before then actuating a desired movement. Such time delays can impact the ability to counteract experienced forces (e.g., wind gusts) and may extend the delivery time, resulting in both spilled or destroyed payloads and poor delivery experience for the recipient.

To facilitate navigation, the secondary aerial vehicle may include a navigation assembly to determine an orientation or a position of the secondary aerial vehicle. The navigation assembly may include one or more sensors, processors, or communication modules. The navigation assembly may assist in directing or navigating the secondary aerial vehicle to a delivery location. In some embodiments, the navigation assembly may include sensors positioned on the secondary aerial vehicle and sensors positioned on or in communication with the first aerial vehicle.

The secondary aerial vehicle may further include a power source, such as a battery, to provide energy for the secondary aerial vehicle. In some examples, the battery may be charged by the primary aerial vehicle or via connections to a power source through the primary aerial vehicle. For example, the tether assembly may include electrical connections to interface with the primary aerial vehicle. In some examples, the tether may provide an electrical connection. The battery may be cooled by one or more of the thrusters during use.

The secondary aerial vehicle may also include one or more safety features. For example, the secondary aerial vehicle may include a parachute or similar recovery mechanism deployable in the event the tether becomes disconnected from the primary aerial vehicle. The secondary aerial vehicle and, or primary aerial vehicle may further include a line cutter to release the secondary aerial vehicle from the primary aerial vehicle if the secondary aerial vehicle was unable to be retracted back to the primary aerial vehicle. Additionally, the previously described assemblies may include redundancies or configurations that increase safety or reliability of the aerial vehicle system.

The aerial vehicle systems described herein may be adapted to small, medium, and large-scale integration with existing infrastructure. Existing infrastructure may include, without limitation, retail, wholesale, industrial locations, and so on. More generally, existing infrastructure may include any location at which packages may be processed for delivery to a customer. To facilitate the foregoing, the aerial vehicle systems may interact with docking or landing systems at a pickup or delivery location. The landing systems may provide assemblies to receive or secure the secondary aerial vehicle for loading and unloading a payload.

In various examples, the aerial system and actively controlled second aerial vehicle allows quick and stable delivery. For example, methods that require slowly or passively lowering a package (e.g., a “dead,” passive, or un-steerable package) from a line may require an aircraft to hover over a delivery location for an extended period of time, which can increase overall risk, noise, or other disruptions. Further, slow or passive lowering of a package in wind or weather conditions may result in swinging or otherwise uncontrolled movement of a package during delivery. The actual and perceived uncontrolled motion may undermine the delivery quality and experience for a delivery recipient. On the contrary, the present system and methods overcome such issues, resulting in a reduced or less intrusive noise and fast delivery of packages or payloads from an aerial vehicle. For example, the various features enable an aerodynamically stable package (e.g., second aerial vehicle) in multiple types of conditions (e.g., even when being deployed during wind gusts, cross-winds, etc.) that maintains its orientation, helping to reduce spillage or damage to the payload. Moreover, such stability during deployment provides a comforting and appealing process to the delivery recipient, as compared to dead or passive packages that may freefall or swing and can be frightening for the recipient.

Further, the system may reduce the potential energy for any payload within the payload bay during delivery, e.g., be configured to be close above the ground before opening a payload bay for the package to help reduce the amount of force experienced by the payload during delivery and help to prevent damage to the delivery surface or location.

Reference will now be made to the accompanying drawings, which assist in illustrating various features of the present disclosure. The following description is presented for purposes of illustration and description. Furthermore, the description is not intended to limit the inventive aspects to the forms disclosed herein. Consequently, variations and modifications commensurate with the following teachings, and skill and knowledge of the relevant art, are within the scope of the present inventive aspects.

### Aerial Delivery System

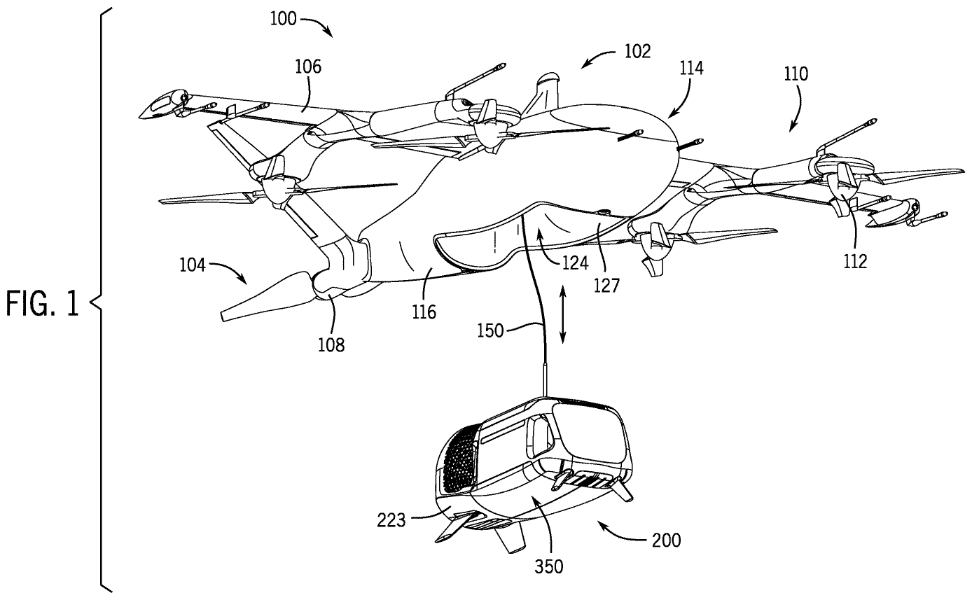

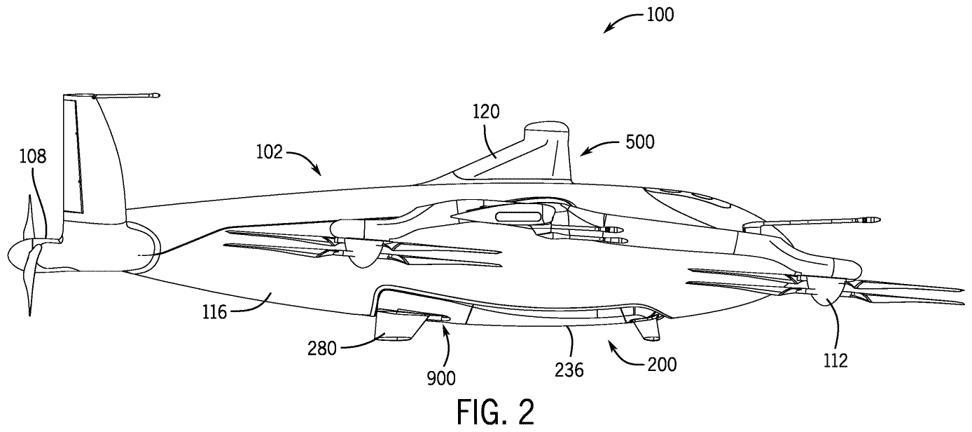

FIGS. 1 and 2 depict an example aerial vehicle delivery system 100 enabling aerial delivery of a payload 175, such as packages, food, or other items, to a delivery location. The system 100 may include a first or primary aerial vehicle 102. The system 100 may further include a secondary or ancillary aerial vehicle 200. The secondary aerial vehicle 200 may be selectively attached to and/or stored within the primary aerial vehicle 102 during flight to or from the delivery location. The primary aerial vehicle 102 provides propulsion systems 104 for flights over a distance, such as from a pickup location to the delivery location. As shown in FIG. 2, the secondary aerial vehicle 200 may be attached to, partially inside, nested, or otherwise coupled or stored within the primary aerial vehicle 102 in a retracted or stowed position. At a desired location, such as at a delivery location, the secondary aerial vehicle 200 can be deployed from the primary aerial vehicle 102 to deliver a payload 175.

At the delivery location, the propulsion systems 104, 110 of the primary aerial vehicle 102 may enable hovering flight over the delivery location at a first altitude or height above the delivery location (e.g., may include cruise and hover propellers). The secondary aerial vehicle 200 may be deployable from the primary aerial vehicle 102 at the first altitude to the delivery location. For example, the secondary aerial vehicle 200 may be released and allowed (using gravitational force) to descend downwards from the primary aerial vehicle 102 and after delivery, can be retracted back into the primary aerial vehicle 102. The descent may be controlled by a retraction assembly 500 or another mechanism. In various embodiments, the secondary aerial vehicle 200 may be configured to support a payload 175 therein on a rigid surface, e.g., a bottom surface 224, 225 of the vehicle 200, and configured to open the rigid surface at a delivery location, such as at a distance of 12 inches or fewer above a ground or delivery surface. This enables a low “drop” of the payload 175, which reduces the potential energy for the payload 175 as it falls due to gravity. Often, the distance may be a few inches or fewer.

With continued reference to the primary aerial vehicle 102, the primary aerial vehicle 102 may include forward propulsion systems 104, stationary or hover propulsion systems 110, an aerodynamic body 114 to assist in generating lift, a retraction assembly 500, and a vehicle compartment or bay 124 to store the secondary aerial vehicle 200 in the retracted or stowed position.

The forward propulsion system 104 may include wings 106 and one or more forward rotor assemblies 108 to generate a forward thrust and lift for the primary aerial vehicle 102. The forward propulsion system 108 may provide energy efficient flight over a distance. The hover propulsion systems 110 may include one or more rotor assemblies 112 oriented to primarily provide a vertical lift for the primary aerial vehicle 102. In one example, the hover propulsion system 110 includes four rotor assemblies 112. In another example, the forward rotor assembly 108 may be articulable from a forward flight position to a second hover flight position and assist in providing vertical lift.

The body 114 and exterior components of the primary aerial vehicle may have rounded or smoothed edges to reduce drag during flight. The bottom surface 116 of the primary aerial vehicle may have a generally convex profile to assist in generating lift during flight. The vehicle compartment 124 may be a recess or opening in the bottom surface 116 of the primary aerial vehicle 102. As viewed from the side, such as in FIG. 2, the vehicle compartment 124 may define a first length at the entrance to the vehicle compartment 124 and a second length at an interior 127 of the vehicle compartment 124, shorter than the first length. The bay 124 may have a trapezoidal shape. Similarly, the primary aerial vehicle 102 may define a first width at the entrance to the secondary aerial vehicle bay 124 and a second width at an interior 127 of the bay 124, shorter than the first width.

The secondary aerial vehicle 200 may have a corresponding shape to nest in the vehicle compartment 124. For example, the secondary aerial vehicle 200 may have a tapering shape, such as in the lengthwise or widthwise directions. The nesting may result in a more secure stowing of the secondary aerial vehicle 200. When the secondary aerial vehicle 200 is stowed in the primary aerial vehicle 102, the bottom surface 236 of the secondary aerial vehicle 200 may align with the bottom surface 116 of the primary aerial vehicle 102 to define a single bottom surface, e.g., the bottom surface 236 of the secondary vehicle 200 may be adjacent to the bottom surface 116 of the primary vehicle 102 to define an almost continuous bottom surface. When stowed, some examples of the fins or feet 280 of the secondary aerial vehicle 200 may provide additional stability or assist in balancing the primary aerial vehicle 102 during forward flight. For example, the fins 280 may have a foil shape to provide lift or assist in stabilizing the aerial vehicle system 100 during flight.

The vehicle compartment 124 may be defined around a center of gravity of the primary aerial vehicle 102. For example, the vehicle compartment 124 may be located at, near, or defined around a position corresponding with the center of gravity of the primary aerial vehicle 102. When the secondary aerial vehicle 200 is connected to the primary aerial vehicle 102, or nested in the vehicle compartment 124, a center of gravity of the secondary aerial vehicle 200 may be positioned to correspond with the center of gravity of the primary aerial vehicle 102. For example, the secondary aerial vehicle's 200 center of gravity may be positioned in alignment with or adjacent the primary aerial vehicle 102 center of gravity. Reducing a distance between the center of gravities of the primary aerial vehicle 102 and the secondary aerial vehicle 200 may assist in stabilizing operation of the system 100, such as during forward flight or deployment of the secondary aerial vehicle 200. The system 100 may be stabilized by reducing or eliminating a moment between the primary 102 and secondary 200 aerial vehicles caused by distances between the centers of gravities.

As used in this specification, center of gravity may be a center of mass of the referenced component or a combined center of mass of an assembly containing the component. A center of lift may be the resultant location of the combined thrust or lift vectors generated by one or more components. A center of pressure may be a resultant location of the sum of an air pressure or drag on the referenced component. In some examples, during hovering flight the center of lift of the hover propulsion assembly 110 aligns with or is located adjacent to the center of gravity of the primary aerial vehicle 102, which may improve stability of the primary aerial vehicle 102. Positioning the bay 124, and in turn the secondary aerial vehicle 200, around the center of gravity may create a stable configuration to deploy and retract the secondary aerial vehicle 200 from or to the primary aerial vehicle 102 during hover flight.

A retracting assembly 500 may be contained within a fin 120 of the primary aerial vehicle 102. As described in detail below, the retraction assembly 500 may lower the secondary aerial vehicle 200 from or retract the secondary aerial vehicle 200 into the primary aerial vehicle 102 via a tether or cable 150 or other mechanical connection. The tether 150 may extend into or out of the bay 124 and align with or be adjacent to the center of gravity of the primary aerial vehicle 102. By positioning the tether 150 at or near the center of gravity, a moment on the primary aerial vehicle 102 generated by the deployment or retraction of the secondary aerial vehicle 102 may be reduced. When retracted, a tether assembly 400 of the secondary aerial vehicle may be received within the fin 120 or retraction assembly 500 to assist in aligning or securing the secondary aerial vehicle 200 to or within the primary aerial vehicle 102.

The secondary aerial vehicle 200 may include one or more propulsion assemblies 600 to maneuver relative to the primary aerial vehicle 102. In one example, the propulsion assemblies 600 of the secondary aerial vehicle 200 are arranged to provide forward or rearward and/or side-to-side translation of the secondary aerial vehicle 200, or rotation of the vehicle 200 about the tether 150. The tether 150 and the retraction assembly 500 may control vertical movement of the secondary aerial vehicle 200 relative to the primary aerial vehicle 102. Accordingly, maintaining tension in the tether 150 may assist in controlling a configuration of the secondary aerial vehicle 200.

One or more sensors, or systems, of the secondary aerial vehicle 200 or primary aerial vehicle 102 may detect or determine a tension on the tether 150. In response to the detected tension, the primary aerial vehicle 102 may move relative to the delivery location to maintain the position of the secondary aerial vehicle 200 relative to the delivery location or to increase or decrease a tension on the tether 150 as needed. Alternatively or additionally, the retraction assembly 500 may increase or decrease the length of tether 150 dispensed from the primary aerial vehicle 102 to maintain the position of the secondary aerial vehicle 200 relative to the delivery location.

With reference to the aerial vehicle system 100, either or both of the pickup or delivery locations may be a warehouse, restaurant, retail store, service center, residential building or a similar location where delivery services may be utilized. A delivery recipient may designate the delivery location as a specific portion of a building or area, such as a door, a window, a deck, a roof, a parking area, or other locations accessible by a delivery recipient.

Either or both of the primary aerial vehicle 102 and secondary aerial vehicle 200 may include one or more processing elements and sensors to assist in traversing a flight path, such as from the pickup to the delivery location, or in returning to the pickup location or a service station. The primary aerial vehicle 102 or the secondary aerial vehicle 200 may be autonomous, partially autonomous, or navigated by a user from a controlling location. The aerial vehicle system 100 may operate in rural or urban locations. Accordingly, the primary aerial vehicle 102 may deploy the secondary aerial vehicle 200 in a variety of locations and environmental conditions.

### Housing and Body of the Secondary Aerial Vehicle

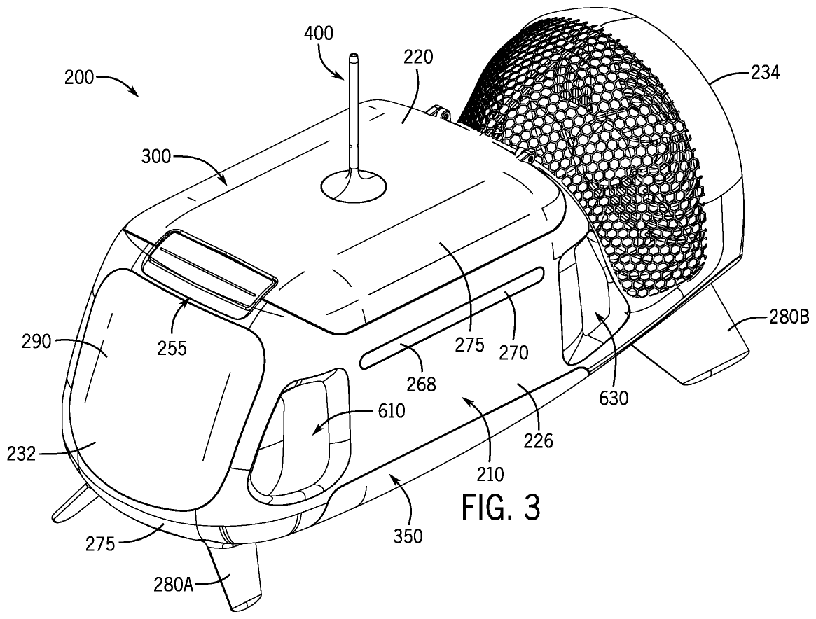

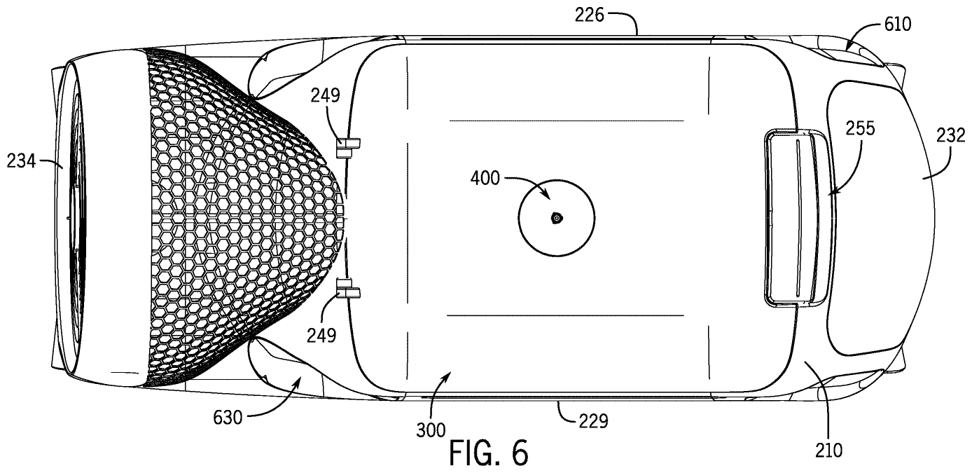

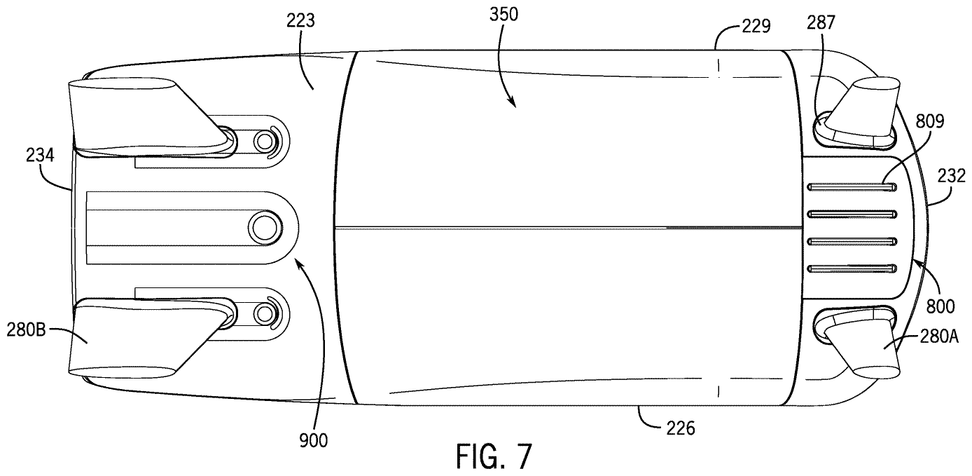

With reference to FIGS. 3-8C, an example secondary aerial vehicle 200 is provided. The secondary aerial vehicle 200 may be an aerial vehicle associated with a primary vehicle 102, such as the primary aerial vehicle 102 described above.

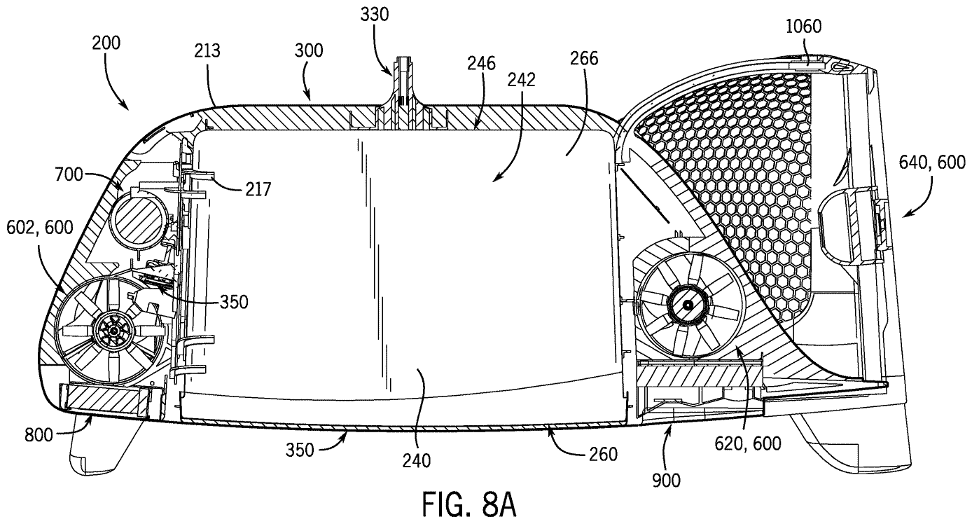

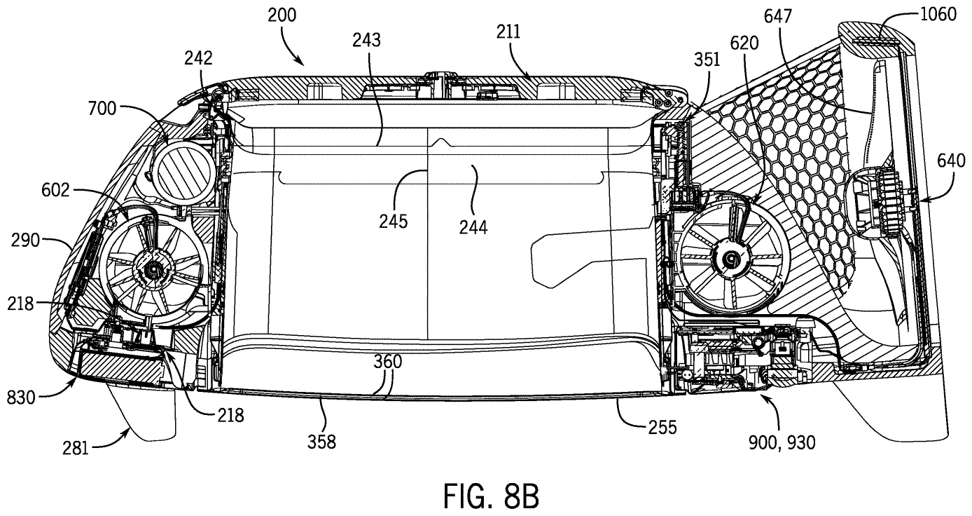

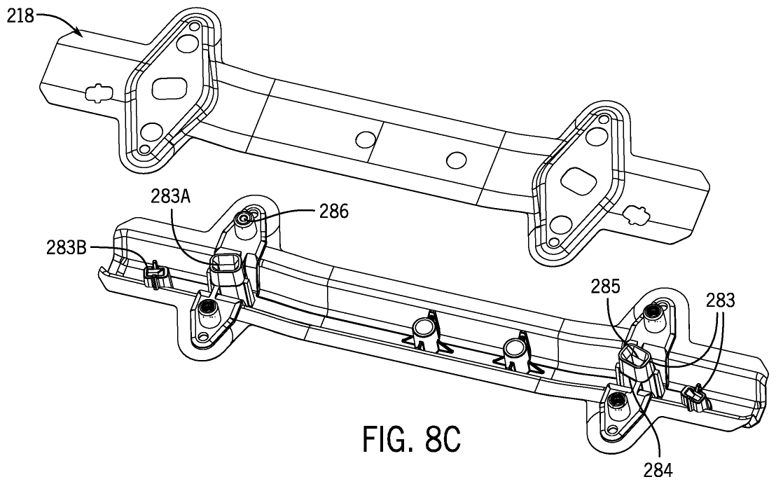

FIGS. 8A and 8B provide cross sections of example secondary aerial vehicles 200. The secondary aerial vehicle 200 may include a body 210 of the secondary vehicle 200 to house various components or assemblies of the secondary aerial vehicle 200.

With continued reference to FIGS. 3-8, the body 210 of the secondary aerial vehicle 200 may be shaped for attaching to or stowing in a primary aerial vehicle 102 such as the primary aerial vehicle 102. In some examples, the body 210 may be a primary chassis or structure of the secondary aerial vehicle 200. The body 210 may house or include one or more components of the secondary aerial vehicle 200. In some examples, the body 210 may include an outer shell 213 and an internal body 216. The body 210 may define or include the payload bay 242 or other internal compartment for storage and securement of a payload 175. The body 210 may be shaped for aerodynamic purposes, such as passive alignment relative to the wind during deployment of the secondary aerial vehicle 200 (e.g., may have a tapered shape for nesting within the primary aerial vehicle 102). The body 210 may be shaped to improve thrust performance under higher and/or low wind conditions. In some examples, the body 210 may be shaped for aesthetic purposes or characteristics.

In one example, the body 210 of the secondary aerial vehicle 200 may have a tapered or trapezoidal shape when viewed from the front 232 or rear 234 sides, or from the left 226 or right 229 sides. For example, the body 210 may define a first or bottom side 223 longer than a second or top side 220 where a third side or surface extends between the first side and the second side (e.g. the left 226 or right side 229, or the front side 232). In one example, the bottom 223 of the aerial vehicle 200 is approximately or substantially aligned in parallel with and has a length or width dimension greater than the top side 220, and one of the left 226 and right 229 or front 232 and rear 234 sides extend between the bottom 223 and top 220 at an angle.

In some examples, the bay 124 of the primary aerial vehicle 102 may have a corresponding shape to the shape of the secondary aerial vehicle 200. For example, the vehicle bay 124 may have tapered or trapezoidal shape, such as in the lengthwise or widthwise directions, corresponding with the body 210 of the vehicle 200.

The body 210 may provide structural support or rigidity to the secondary aerial vehicle 200. Additionally, the body 210 may provide one or more attachment points for the assemblies of the secondary aerial vehicle 200. The body 210 may be defined in part by a relatively light but durable material. The body 210 may be a single material or two or more materials joined together or in combination. The body 210 may be made from a foam material, such as expanded polypropylene, polystyrene, or the like. The foam material may allow the body 210 of the secondary aerial vehicle to break at a lower force upon impact in the event the secondary aerial vehicle 200 becomes detached from the primary aerial vehicle and/or the recovery assembly 700 fails to deploy. In some examples, assemblies or components of the secondary aerial vehicle 200 may provide additional structural support and rigidity for the secondary aerial vehicle 200 as a whole.

The body 210 may include a frame or frame elements 217 to provide structure, rigidity for the vehicle 200 as a whole and/or define structural locations for attachment or coupling points for various components of the vehicle 200. The frame elements 217 may be made from the same or similar foam material as the body 210, a different foam material, plastic features, metallic features, or a combination of the materials. In some examples, the frame elements 217 may be formed from one or more layers of a carbon fiber material impregnated with a polymer or resin. In some examples, the carbon fiber frame elements 217 may be approximately between 50-80% carbon fiber, and between approximately 20-50% impregnated material. In one example, the carbon fiber frame elements 217 may be approximately 60% carbon fiber to 40% impregnated material. Carbon fiber frame elements 217 may provide strength and rigidity at a low or reduced weight. For the portions or examples of the frame elements 217 including carbon fiber, the frame elements 217 may include a polymer or plastic, PVA, nylon, foam, or other material positioned between or attached to layers of the carbon fiber material. The added material may provide increased volume at a reduced weight, improved thermal properties, structural support, or attachment locations for additional components to the frame 217 or body 210. The frame elements 217 may be connected or attached to the foam body 210, or the foam body 210 may be overmolded on or to the frame elements 217. In some examples, the frame elements 217 may be formed with one or more drain ports to prevent water from being trapped within the body 210.

The body 210 may optionally include an outer shell 213 or outer material layer. The outer shell 213 may be a relatively light but durable material. The shell 213 may also provide structural support or rigidity to the secondary aerial vehicle 200. The shell 213 may be substantially or completely resistant to moisture (e.g. “waterproof”) to prevent or limit the amount of moisture and/or debris that can enter the secondary aerial vehicle 200, payload bay 242, or secondary aerial vehicle assemblies. The surface of the shell 213 may also have a smooth exterior surface to reduce drag during deployment. The outer shell 213 may be a single uniform component or two or more pieces joined to form the outer shell 213. For example, the outer shell 213 may be two or more pieces configured to fit over a portion of the body 210 and join together. The material of the outer shell 213 may be a plastic, carbon fiber, foam or similar material. In one example, the outer shell 213 is two or more foam pieces joined together with or over the body 210.

The frame elements 217 or other portions of the aerial vehicle 200 including carbon fiber sheets or layers may be formed under compression and heat. Heat may be applied to an impregnated carbon fiber sheet to prepare the impregnated material for moulding. The one or more sheets may be positioned between two rigid tools, such as steel portions, under pressure to define the shape of the intended frame element 217. The rigid tools may be cold or cooled during compression to set the shape of the carbon fiber sheets. In examples where two or more carbon fiber sheets are used to define a frame element 217, two sheets may be aligned such that their perimeters, or regions intended for connection are in contact. Heat and pressure may be reapplied to melt or mold the perimeters or connection portions of the two sheets together to form the frame element 217. The frame element 217 may be hollow. In examples where an additional material is included in the frame element 217, the material may be placed in contact with an impregnated carbon fiber sheet or between the two or more sheets prior to, or during, heating. In some examples, the additional material may be heated or placed under pressure to bond with or attach to the carbon fiber sheets.

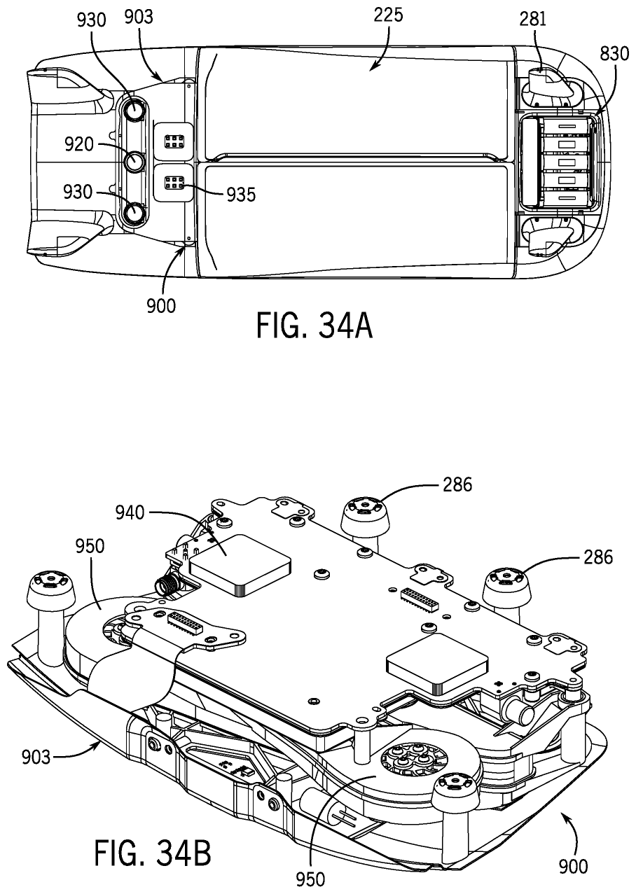

In some examples, the components of the secondary vehicle 200 may be coupled to the foam of the body 210, 211. However, directly connecting to the foam may provide less resilient connections that may result in separation under loading as compared to over molded techniques. To increase the connections, or tolerated forces before separation, spin boss connectors 286 may be attached or coupled to the foam. An example spin boss connector 286 may be depicted in FIG. 8C or 34B. A spin boss connector 286 may be a thermoplastic or heat moldable feature inserted into and bonded with the foam. The spin boss connector 286 may define a connection feature on a side opposite the side intended for moulding. The connection features may provide an interface to couple with other features or components of the vehicle 200, such as frame elements 217.

The spin boss connector 286 may be attached to the foam or body 210, 211 by rotating the connector 286 at a high rate of speed while positioned within the substrate or body to melt a portion of the connector 286 and foam of the body 210. The connector 286 is then stopped rapidly and once the material has re-hardened, it forms a bond between the connector 286 and the foam at the areas of intersection. For example, the foam flows onto and around the outer surface of the connector and then hardens in place securing the connector 286 to the foam. In some examples, one or both of the foam or the spin boss 286 may be preheated prior to contact. For example, the pre-heated connector 286 may be inserted into the foam, spun, further heating the connector 286 and material, to increase the amount of melted material and/or reduce the time to melt the material. In some examples, a portion of the foam may be removed, such as by drilling, to define a receptacle for the spin boss connector 286. Various spin boss connectors 286 may be formed having different lengths or depths or a variety of diameters. Spin boss connectors 286 having smaller diameters may have a decreased surface area, or may generate less friction heat due to a comparatively slower rotational speeds, such as at an outer perimeter. For the smaller diameter spin boss connectors 286, the rate of rotation may be comparatively increased and/or the connector 286 may be pre-heated to provide increased heat from friction between the connectors 286 and the foam.

The secondary aerial vehicle 200 may have a center of gravity. The body 210 may be structured or oriented so that the secondary aerial vehicle 200 as a whole has a center of gravity positioned at or near a desired location or region of the secondary aerial vehicle 200. For example, body 210 may be shaped to position the center of gravity of near a geometric center or a midline of the vehicle 200. The body 210 may be arranged so that the center of gravity corresponds with an attachment location between the secondary vehicle 200 and the primary vehicle 102, such as the tether mount 330. The body 210 may be shaped for the center of gravity to correspond to a likely center of gravity of a payload 175.

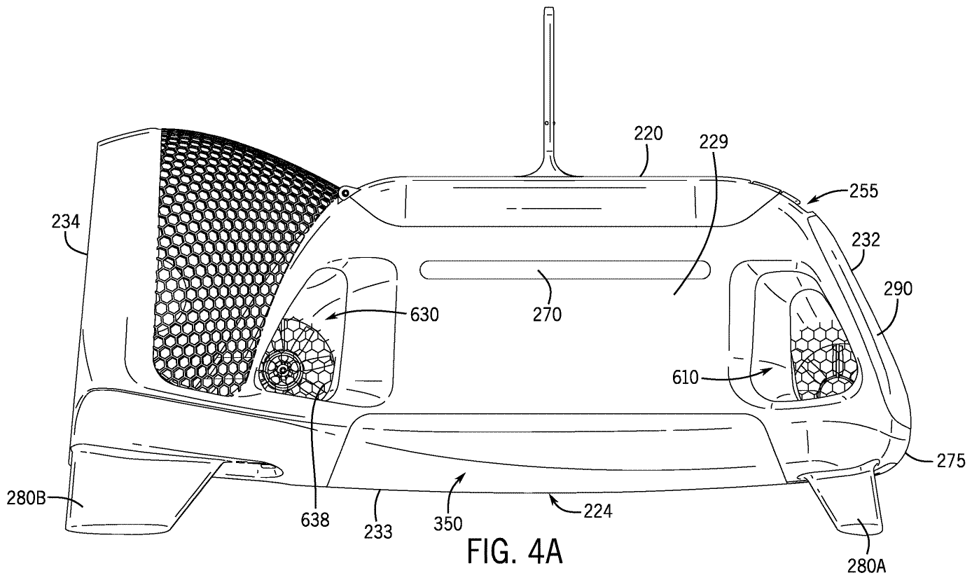

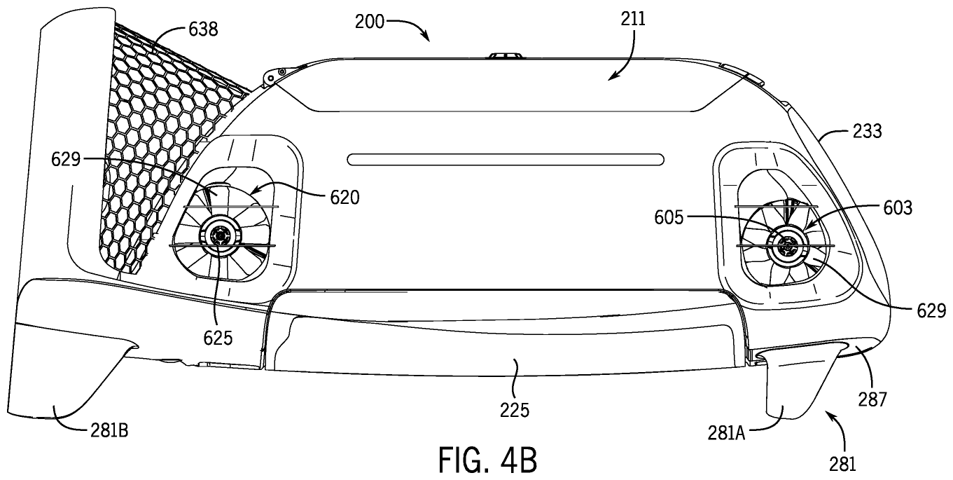

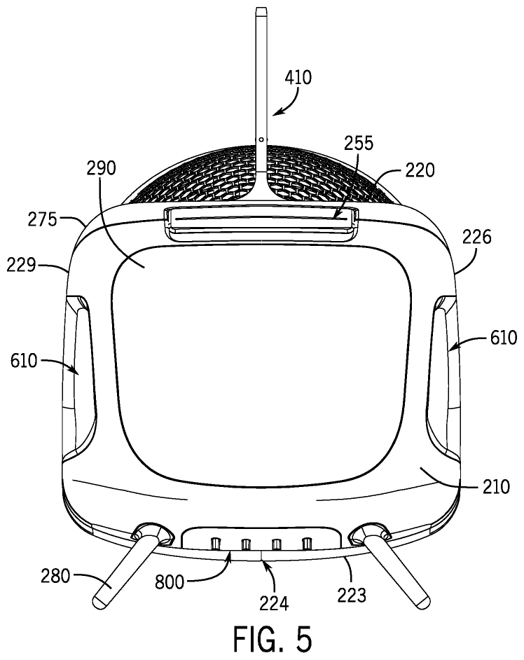

The body 210 of the secondary aerial vehicle 200 may be shaped for aerodynamic performance, such as reducing drag on or increasing the stability of the secondary aerial vehicle 200. One or more sides of the body 210 may have a convex exterior. To define the convex exterior one or more edges 275 of the surface secondary aerial vehicle 200 may have a rounded shape. With reference to FIGS. 4A-4B and 5, the bottom 223 of the secondary aerial vehicle 200 may be convex along the length of the secondary aerial vehicle 200 or the width of the secondary aerial vehicle 200. The convex shape of the bottom 223 of the secondary aerial vehicle 200 may be aligned such that the apex 224 of the bottom 223 may be aligned with or arranged to correspond with the center of gravity of the secondary aerial vehicle 200. The apex 224 may also be aligned with the tether 150. The front 232 of the secondary aerial vehicle 200 may also be convex. The convex front 232 may similarly be shaped to correspond with the center of gravity. For example, the alignment of the convex surfaces relative to the center of gravity of the secondary aerial vehicle 200 and, or the tether 150 may assist in maintaining a stable descent or orientation of the secondary aerial vehicle 200.

In some examples, the secondary aerial vehicle 200 may include an exterior-facing light source 268, e.g., to illuminate and be visible from an exterior of the vehicle 200. The exterior light source 268 may include one or more light emitting elements. For example, the light emitting elements may be light emitting diodes (LEDs) capable of emitting one or more wavelengths of light. The light source 268 may be a row of light emitting elements or other orientations of elements (e.g., geometric or non-geometric shapes). The exterior light source 268 may be positioned along one or more sides of the secondary vehicle 200 or surfaces. In one example, the light source 268 is positioned along one or both of the left side 226 or right side 229. However, in other embodiments, the vehicle 200 may also include exterior lights on the front, rear, bottom, and/or top surfaces. The light emitting elements may generate a variety of wavelengths of light. For example, the light source 268 may emit visible light in a variety of colors. The exterior light source 268 may emit light to assist in illuminating a surrounding environment for determining an orientation of the secondary vehicle 200 or capturing of images by the navigation assembly 900.

In some embodiments, the exterior light source 268 may provide messages or status indications, e.g., be used to generate alerts to users and/or transmit information to other vehicles or systems. Additionally, the exterior light source 268 may provide an aesthetic benefit or customizable portion of a delivery experience.

The secondary aerial vehicle 200 may include one or more aerodynamic or protective covers. The covers 270 may be removable or the covers 270 may be secured or coupled to the body 210, 21, e.g., by overmolding foam over a portion of the cover 270. The covers 270 may include a material or feature different from the body 210. The one or more covers 270 may have or be positioned over features having phosphorescent properties (e.g. “glow-in-the-dark”), transparent or semi-transparent, or illuminative properties to assist a bystander in seeing the secondary aerial vehicle 200 during low light. For example, the cover 270 may be positioned over the exterior light source 268 to allow the passage of light through the cover 270 while protecting the light source 268 from environmental conditions. The one or more covers 270 may assist in heat transfer or provide airflow to assemblies requiring cooling or heating. The one or more covers 270 may also be transparent or otherwise allow the passage of light. For example, a cover 270 may be placed over a portion of the navigation assembly 900 without impeding image capture or the light source 168 onboard the secondary aerial vehicle 200 to illuminate a surrounding environment.

In some examples, the covers 270 may assist in dispersing or diffusing the exterior light source 268. For example, the cover 270 may create the appearance of a unitary exterior light source 268 when multiple light emitting elements are used. In some examples the one or more covers 270 or outer shell 213 may be engraved, colored, or otherwise define a distinctive appearance to help a user or bystander in recognizing the secondary aerial vehicle 200 or brands associated with the secondary aerial vehicle 200.

The secondary aerial vehicle 200 may include a windshield or access cover 290 coupled to or covering a portion of the secondary aerial vehicle 200. For example, the access cover 290 may be a windshield positioned at or adjacent the front 232. In some examples, the access cover 290 may be positioned along another side or portion of the secondary vehicle 200. The access cover 290 may be a plastic, polymer, carbon fiber, or similar material. The access cover 290 may be removable to access one or more assemblies located in the front 232 of the secondary aerial vehicle 200, such as the power source 800. The access cover 290 may have a low frictions surface and/or convex profile to improve the aerodynamics of the secondary aerial vehicle 200 and facilitate passive alignment along a direction of wind. The access cover 290 may also provide an aesthetic benefit, e.g., provide a “face” to the secondary aerial vehicle 200, creating a more friendly appearance. In some examples, the access cover 290 may include an electronic display or other data output (e.g., LEDs or the like) for communication or interaction with a delivery shipper or recipient.

In various examples, the secondary aerial vehicle 200 may be selected from a variety of secondary vehicles 200 having different sizes or geometric configurations. For example, some examples of the secondary aerial vehicle 200 may have a greater width, height, length, or different orientations of surfaces for aerodynamic performance. The selected secondary aerial vehicle 200 may be determined based on an overall volume or size of the vehicle 200, payload bay 242 capacity, aerodynamic features, the types of products carried by the vehicle 200, or other relevant characteristics.

With reference to FIG. 4B, an example of a second body configuration 211 is depicted. The second body configuration 211 may have a bottom side 225 having an increased length in comparison to the body configuration 210. The increased length of the bottom side 225 may provide for a payload bay 242 having an increased volume or storage capacity. In the second body configuration 211, the top side 220 may be the same as or similar to the top side 220 of the first body configuration 210. Accordingly, the front side 233 of the second configuration 211 may be oriented at a smaller angle between the bottom 225 and the top 220. As a result, the front side 233 of the second configuration may provide reduced drag or increased aerodynamic performance.

The body 210 may include one or more feet or fins 280 extending from or coupled to the bottom 223 thereof. The feet 280 may be attached to or integral with the body 210. The feet or fins 280 may provide a stable platform to support the secondary aerial vehicle 200 on a surface (e.g., a delivery location). The feet 280 may raise the bottom 223 of the secondary aerial vehicle 200 above the surface, which may assist in allowing the payload release assembly 350 to open and deliver the payload 175, as described in detail below. The feet 280 may extend from the secondary vehicle 200 at an angle relative to the bottom 223. For example, the feet 280 may extend away outward toward the left or the right of the secondary aerial vehicle 200. The feet 280 may extend at an angle towards the front or the rear of the aerial vehicle 200. The angled orientation may provide additional clearance or tolerance for opening or closing of the payload release assembly 200 and also reduce or eliminate the degree to which the feet 280 impede a view of one or more imaging components, such as in the navigation assembly 900. The feet 280 may be located within or partially within a footprint of the aerial vehicle 200. The footprint may be defined by the perimeter of the aerial vehicle 200 when viewed from a top plan configuration. In some examples, the feet 280 may provide a sacrificial wear surface on the bottom side 223 of the aerial vehicle 200 that can be replaced in the event of damage to keep more valuable components from being damaged when deploying payloads 175 on rough surfaces e.g. asphalt or gravel, e.g., the feet 280 may be easily swappable from the body 210 of the vehicle 200.

With reference to FIGS. 4A-4B, 7, and 8A-8B, in some examples the secondary vehicle 200 may include two pairs of feet 280 attached to the secondary aerial vehicle 200. The first pair may be a front pair 280A and located towards the front 232 of the secondary aerial vehicle 200. The second pair may be a rear pair 280B and may be located towards the rear 234 of the secondary aerial vehicle 200. The front feet 280a may be angled forward or towards the front 232 of the body 210. Angling the feet 280a towards the front 232 may increase a landing footprint to provide increased stability to the secondary vehicle 200 on a surface.

In another example of the feet or fins 281, the front pair of feet 281A may be angled generally vertically or towards the rear side 234 of the vehicle 200 (e.g. inward). In some examples, the rear feet or fins 281B may be angled inwardly (e.g. vertically or towards the front 233 of the vehicle 200). By angling or orienting the front feet 281A rearward or vertically, the secondary vehicle 200 may be able to land on a comparatively smaller area than without such adjustments. Specifically, the landing area can be inset relative to the overall footprint of the vehicle 200, requiring a smaller area for landing. The inward or vertically positioned feet 281 may be used on secondary vehicles 200 having a larger or longer bottom side 225. By using inward or vertically positioned feet 281, the larger secondary vehicle 200 may land on a surface shorter or smaller than the secondary vehicle 200. As a result, the feet 281 enable the secondary vehicle to land or rest on a comparatively larger variety of surfaces. The inward or rearward angled feet 281 may also provide reduced drag or increased aerodynamic performance during flight or navigation, such as during deployment from the primary vehicle 102 or when stowed in the primary vehicle 102, as compared to vertically straight feet which may introduce more drag.

The feet 280, 281 may be spaced from the sensor assembly 900 or the payload release assembly 350 to prevent interference with the operation of the assemblies. When the secondary aerial vehicle 200 is stowed in the primary aerial vehicle 102, the feet or fins 280 may assist in stabilizing the primary aerial vehicle 102 or secondary aerial vehicle 200 during forward flight. Accordingly, a variety of feet or fin 280 configurations are possible.

With reference to FIG. 8C, a bottom of an example feet support bar 218 for the connection of the feet 280, 281 to the body 210, 211 of the secondary vehicle 200 is depicted. The example feet support bar 218 may be a frame element 217 and can be configured as a single component or two or more attached components. In one example, the feet support bar 218 includes at least one carbon fiber sheet and a polymer connected with the carbon fiber sheet. In some examples, the support bar 218 includes a second carbon fiber sheet or portion. The second carbon fiber portion may be connected or bonded with a first carbon fiber portion to position the polymer portion between the sheets. The feet support bar 218 may define one or more connection features 283, such as extensions or protrusions extending therefrom. The connection features 283 may define an aperture 285 extending at least partially through the height of the connection feature 283. The connection feature 283 may have an exterior mating surface 284. The aperture 285 or exterior mating surface 284 of the connection feature 283 may have a non-circular or angled cross section. In some examples, the feet support bar 218 may include one or more pairs of a first connection feature 283A and a second connection feature 283B.

The fins or feet 280, 281 may be connected to the feet support bar 218 by at least one of the connection features 283. Because the feet or fins 280, 281 may be positioned at an angle, the non-circular or angle cross section of the connection feature 283 may limit or prevent rotation or oscillation of the feet 280, 281. In some examples, the pairs of connection features 283A, 283B may further limit rotation or oscillation of the feet 280, 281. In some examples, the feet 280, 281 may be additionally or alternatively connected to the support bar 218 by fasteners. In such an example, the feet or fins 280, 281 may define one or more small apertures to receive the fasteners, in such embodiments, the apertures may be limited in size or positioned to prevent or reduce drag due to the aperture.

In some examples, the feet 280, 281 may include a base portion 287 for contact with the body 210, 211 of the secondary vehicle 200. The base portion 287 may be a flange or shoulder extending about a portion of the feet 280, 281. The base portion 287 may be in contact with the foam or other substrate material of the body 210, 211. The base portion 287 may assist in dispersing the weight supported by the feet 280, 281 over a greater portion of the vehicle 200. The base portion 287 may be formed with a bend or angle such that the base portion 287 is intentionally flexed or stressed when in contact with body 210, 211. The bend or intentional stressing of the base portion 287 may prevent or counter tolerance issues between the feet 280, 281 and the body 210, 211. As a result, the feet 280, 281 may be connected to the secondary vehicle 200 with reduced gaps or reduced chance of movement.

The body 210 of the secondary aerial vehicle 200 may include one or more features for holding or storing a payload 175. The body 210 may include a payload bay 242 defining a volume 240 for the payload 175. The payload bay 242 may be a separate component connected with the body 210 or formed with the body 210. In one example, the body 210 of the secondary aerial vehicle 200 may define the volume 240, or payload bay 242, for placing a payload 175. The payload bay 242 may include two or more portions connected together to define the interior volume 240. The payload bay 242 may include a first or front portion 243 and a second or rear portion 244. The first 243 and second portions 244 may be generally U-shaped. The first 243 and second portions 244 may be formed of a moldable polymer or resin, an impregnated carbon fiber material, or the like. To form the payload bay 242, the first 243 and second portions 244 may be positioned to contact along to form an overlap 245. The first 243 and second portions 244 may then be heat welded, moulded together, or otherwise fastened together to form the payload bay 242. To prevent retention of moisture, the payload bay (e.g. the first 243 or second portions 244) may define one or more small openings for draining or venting.

The payload bay 242 may be covered and selectively accessible, such as by a payload release assembly 350 or a lid assembly 300 as described above and below. The secondary aerial vehicle 200 may be configured to prevent undesired release of the payload 175, as described in greater detail below. The payload bay 242 may be located to correspond with the center of gravity of the secondary vehicle 200. For example, the payload bay 242 may be defined approximately at or around the center of gravity. The payload bay 242 may be located or arranged to position a likely center of gravity of a payload 175 to correspond with a center of gravity of the secondary vehicle 200. By limiting a distance between the payload 175 and the center of gravity of a secondary vehicle 200, a moment may be reduced to improve stability of the vehicle 200 during deployment. For example, limiting the distance between the centers of gravities may reduce or prevent the secondary aerial vehicle 200 from reoriented or rolling relative to the tether 150 or primary vehicle 102 during deployment.

The payload bay 242 may be selectively accessible by two or more apertures. For example, the body 210 or payload bay 242 may define a loading aperture 246 into the payload bay 242 for placing a payload 175. The body 210 may define a release aperture 260 into the payload bay 242 for removing or releasing the payload 175. The separate loading/unloading or exiting apertures or access location 246 and unloading apertures 260 may assist in efficiently loading and unloading a payload 175 in the payload bay 242. For example, top loading a payload 175 into the payload bay 242 may be preferable to a user. Bottom unloading or release of the payload 175 during delivery may utilize gravity to assist in releasing the payload 175. In some examples, the loading aperture 246 and the release aperture 260 may be the same opening.

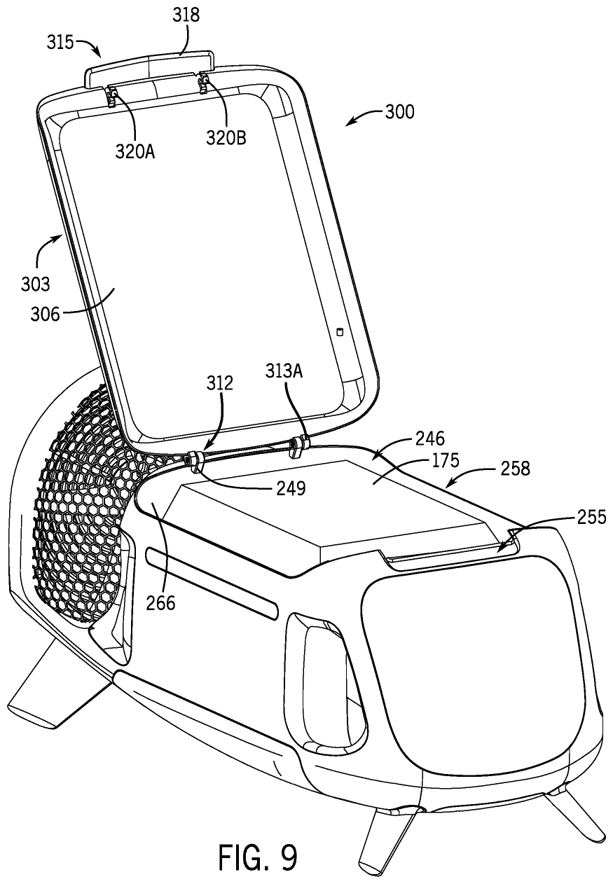

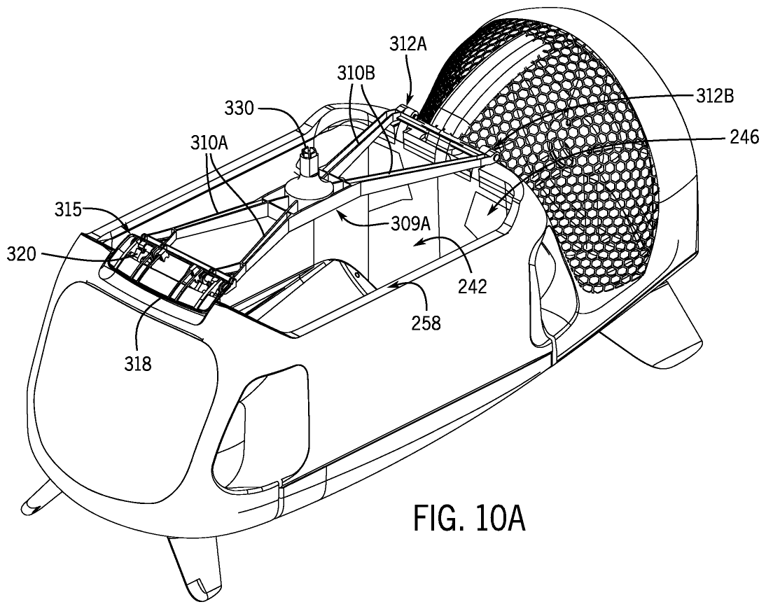

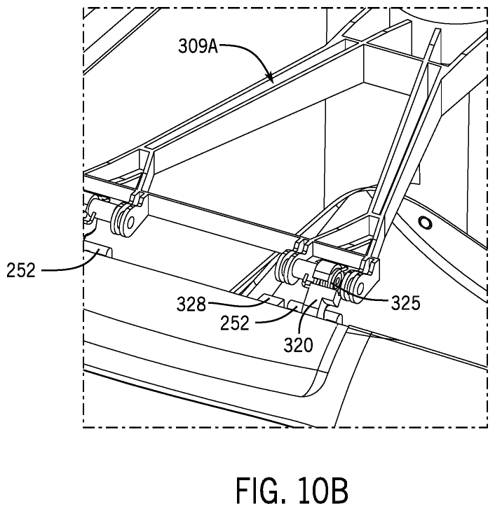

The loading aperture 246 and the release aperture 260 may be located at two separate surfaces or sides. As shown in FIGS. 8A-10B, the loading aperture 246 may be accessible on the top 220 of the secondary aerial vehicle 200. The release aperture 260 may be accessible on the bottom 223 of the secondary aerial vehicle 200. The loading aperture 246 may define a smaller length or width dimension than the release aperture 260 to reduce the chance a payload 175 becomes stuck or trapped on or in the payload bay 242. For example, by providing a loading aperture 246 smaller than the release aperture 260, a payload 175 that fits through the opening aperture 246 should have a greater tolerance to exit from the release aperture 260. By providing a loading aperture 246 on top of the secondary aerial vehicle 200, a payload may be set in payload bay 242 without reorienting the vehicle 200. By providing a release aperture 260 on the bottom 223 of the secondary aerial vehicle 200, a payload 175 may be released with the assistance of gravity without reorienting the vehicle 200.

In additional examples, the secondary aerial vehicle 200 may include alternative features for holding or storing a payload 175. For example, the payload bay 242 may come in a variety of alternative shapes and configurations or be replaced by features such as clamps, hooks, or alternative features to secure a payload within or to the secondary aerial vehicle 200.

The aerodynamic features of the secondary aerial vehicle 200 may assist in orienting the vehicle 200 during deployment, movement, or descent. In some examples, the front 232 of the secondary aerial vehicle 200 may passively orient with or against the direction of travel of the aerial system 100, or the direction of wind, such as facing with or against the direction of airflow. The passive alignment may assist in preventing or limiting the secondary aerial vehicle 200 from uncontrolled rotation relative to the tether 150.

The shape of the bottom 223 may minimize or reduce the occurrence of a “rocking” or “falling leaf” movement of the secondary aerial vehicle 200 during descent and ascent. For example, the shape of bottom 223 may assist in aligning the center of pressure in a stable configuration relative to the center of gravity of the secondary aerial vehicle 200. For example, a moving body traveling through a fluid, such as air, may have a stable configuration when the center of pressure is in a direction away from the direction of movement relative to the center of gravity. Accordingly, during descent the convex profile of the bottom 223 of the secondary aerial vehicle 200 may cause the center of pressure of the secondary aerial vehicle 200 to be above the center of gravity of the secondary aerial vehicle 200. A more stable descent may allow the secondary aerial vehicle 200 to deploy with faster descent speeds. Faster descent speeds may result in increased efficiency for the aerial vehicle system 100 as a whole, such as through reduced power consumption, faster delivery times, or increased delivery capacity before the aerial vehicle system 100 requires maintenance or charging, among other benefits.

In some examples, the convex shape of the front 232 or bottom 223 of the secondary aerial vehicle 200 may also limit airflow separation or detachment. Airflow separation or detachment occurs when a liquid flow separates from the surrounding flow and slows down forming eddies and vortices. The flow separation in turn causes an increase in drag and reduced lift on the body. The increased drag, as well as eddies or vortices, may result in an imbalance of forces on the object and cause unpredictable movement or more energy consumption to stabilize the object. By limiting flow separation, the secondary aerial vehicle 200 may maintain a more stable alignment relative to the primary aerial vehicle 102. Further, as described below, limiting flow separation may result in increased energy efficiency and control of the secondary aerial vehicle 200 via the propulsion assembly 600.

The improved stability of the secondary aerial vehicle 200 during deployment may also provide experiential and functional benefits. For example, a secondary aerial vehicle 200 that appears to be more stable during descent may increase a user's trust in the performance or safety of the aerial vehicle delivery system 100. In contrast, an unstable secondary aerial vehicle may concern a user about the safety or effectiveness of the system. Relatedly, some payloads 175 may be more sensitive to movement, such as a carbonated beverages or fragile items. Increased stability may limit damage to or disruption of an intended recipient's use of the payload 175.

### Lid Assembly

With reference to FIGS. 8A-11C, the secondary aerial vehicle 200 may include a lid assembly 300 to selectively access or cover a loading aperture 246 of the payload bay 242 of the secondary aerial vehicle 200. The lid assembly 300 may include a lid 303 selectively connected with one or more features of the body 210 of the secondary vehicle 200, where the lid 303 is movable or repositionable to enable access to the payload bay 242 of the vehicle 200. While description is given with reference to aerial vehicles, it is appreciated the lid assembly 300, may be utilized or included by a variety of other devices or vehicles including a selectively accessible volume.

The body 210 may include one or more bosses 249 positioned adjacent to the loading aperture 246. The bosses 249 may be defined by or a portion of the frame elements 217. The bosses 249 may engage with the lid assembly 300 to form a hinge 312 or joint. More specifically, the bosses 249 may define apertures to receive a pin or feature of the lid assembly 300 to define a hinge 312. In one example, the bosses 249 are located adjacent to the perimeter 258 on a rear side of the loading aperture 246.

The body 210 may also define one or more receiving members, securement features, or securement points 252 to selectively engage with the lid assembly 300. In some examples, one or more other features may be positioned along or adjacent the loading aperture 246 to facilitate engagement with the lid assembly 300 such as a seal or gasket, magnets, and so on. The securement features 252 may be a second set of bosses, bars, or features to selectively receive one or more securing members 320 of the lid assembly 300. In one example, the securement features 252 are located along or adjacent a front of the perimeter 258 of the loading aperture 246.

A recess 255 may be defined adjacent to the securement features 252. The recess 255 may receive a feature of the lid assembly 300 to effectively reduce, or make more aerodynamic, a profile the lid assembly 300 and/or provide an access area for the user to actuate the latch assembly 315.

The lid 303 may include a lid body 306 and a frame 309. The frame 309 may provide structural support or rigidity to the lid 303 or lid assembly 300. In one example, the lid body 306 is a material overmolded on a skeleton defining the frame 309. In some examples, the tether mount 330 may be integrated with or attached to the lid 303.

The lid body 306 may include one or more materials or one or more parts. The lid body 306 may be made from a foam, such as expanded polypropylene, polystyrene, or the like. In some examples, the lid body 306 may have a similar material construction as that of the body 210 of the secondary aerial vehicle 200. For example, the lid body 306 may have an outer shell and an inner body. The lid body 306 may cover the loading aperture 246. In some examples, the lid body 306 may be designed to extend over the edges or perimeter 258 of the loading aperture 246 to prevent debris or moisture from entering the payload bay 242 when the lid assembly 300 is in a closed configuration. The lid body 306 may also define rounded exterior edges to promote and aerodynamic secondary aerial vehicle 200.

The frame 309 may be single material or part, or the frame 309 may include multiple materials or parts joined together. In some examples, the frame 309 material includes one or more of a plastic, carbon fiber or impregnated carbon fiber, or similar lightweight but durable material. The frame 309 may be shaped to extend across a dimension, such as the length of the lid 303 or loading aperture 246. For example, when the lid 303 is coupled to the secondary vehicle 200, the frame 309 may extend from at or near the securement features 252 to the one or more bosses 249 defining in part the hinge 312. The frame 309 may be formed or constructed similar to or the same as the frame elements 217 of the body 210.

In some examples, the frame 309 may be an integrally formed or moulded frame 309A. The frame 309A may include a front portion 310A configured to engage with the latch assembly 315 and a rear portion 311B. The rear portion 311B may define one or more bosses 313 or features to engage with the bosses 249. The bosses 313A of the frame 309 and the bosses 249 of the secondary vehicle 200 may be coupled to define one or more hinges 312.

The front portion 310A and the rear portion 310B may join near the center of the lid 303 or at a point aligning with the center of gravity of the secondary aerial vehicle 200. The front portion 310A and the rear portion 310B may include arm like features to reduce the weight of the frame 309A while retaining structural integrity. In one example, the front portion 310A and rear portion 310B include two arms extending at an angle from the center of the lid towards the edges of the lid forming an X-shaped configuration. In some examples, the tether assembly 400 may include a tether mount 330 extending from or connected to the frame 309A, and connecting the lid assembly 300 with the tether 150 or tether assembly 400.

A latch assembly 315 may be coupled to or operatively engaged with the lid 303. The latch assembly 315 may include securing members 320 to selectively engage the securement features 252 to secure the lid assembly 300 to the body 210. The securement features 252 may be attached to the lid 303, such as at the frame 309A. For example, the securing members 320 may be hooks, pin and barrel combinations, magnets, or other assemblies configured to secure two or more objects together. The securing members 320 may be rotatable or rotatably connected to the lid 303 for selective engagement with the securement features 252. The securing members 320 may rotate between an open configuration, where the securing member 320 is not engaging a securement feature 252 of the secondary aerial vehicle 200, and a closed configuration where the securing member 320 rotates under and around the securement feature 252. In one example, the securing members 320 are rotatable hook shaped features.

Each of the securing members 320 may be independent of another or second securement member 320. For example, one securement member 320A may be aligned in the open configuration and a second securement member 320B may be in the closed configuration. Including independent securement members 320, the lid assembly 300 may stay attached to the secondary aerial vehicle 200 and the payload 175 secured in the event of failure of one of the securement members 320.

The rotatable connection of the securing members 320 may be oriented such that when the lid assembly 300 is subjected to a lifting force in the closed configuration the securing members 320 stay in or move further into the closed configuration, or away from the open configuration. Further, the rotation of the securement members 320 when the lid assembly 300 experiences a lifting or upward force may assist in keeping the lid assembly 300 attached to the secondary aerial vehicle 200 in examples where the lid assembly 300 includes a connection with the tether 150 and supports the weight of the secondary aerial vehicle 200 from the primary aerial vehicle 102.

The latch assembly 315 may include one or more biasing members 325 to assist in retaining the securing members 320 in a closed position and/or to assist in manipulating the securing members 320 to a closed configuration. The biasing member 325 may be a spring, coil, or similar element. The biasing member 325 may store and release energy to move a securing member 320 towards or into a closed configuration. In one example, the biasing member 325 is a coil operatively engaged with the latch assembly 315 and the securing member 320. The biasing member 325 may be attached or associated with the securing members 320 in a compressed state, whereby the biasing member 325 expands from the compressed state to exert a force on the securing member 320 towards the closed configuration. The biasing member 325 may cause the securing member 325, or hook, to rotate relative to the securement feature 252 and couple with the securement feature 252.

The latch 318 may be a manipulable feature of the latch assembly 315. In one example, the latch 318 is a handle or lever. The latch 318 may be shaped to promote an aerodynamic design and may have a rounded exterior. In one example, the latch 318 may be shaped to fit within and align with the recess 255, allowing the latch 318 to seat flush or partially flush relative to the outer surface of the body 210. The latch 318 may be shaped such that a space is defined between the walls of the recess 255 and an edge of the latch 318. The space may allow a user to grip and manipulate the latch 318. The latch 318 may engage the one or more securing members 320 to provide selective manipulation of the securing members 320 between an open configuration and a closed configuration. The latch 318 may be a single piece that moves two or more securing members 320 simultaneously or may be multiple pieces that move one or more securing members 320 independently.

The latch 318 may rotate relative to the securing members 320. The latch 318 may allow a user to overcome the biasing member 325 to move the securing members 320 to open the lid 303. The rotation of the latch 318 may have a lag portion where the securing members 320 are not manipulated by the latch 318. The latch 318 may include a slider, a slot, groove, or similar feature that allows the latch 318 to couple to the securing members 320 and move relative to the securing members 320 prior to actuating or manipulating a securing member 320. In one example, the lag portion may allow the latch 318 to rotate between 20-30 degrees without disengaging the securing members 320 from the securement features 252. After the lag portion, the latch 318 may cause the securing members 320 to release from the securement features 252. After releasing, the motion of opening the latch 318 may continue to remove the lid 303 from the loading aperture 246. To return the one or more securing members 320 to a closed configuration, the latch 318 may be rotated in the opposite direction of opening. When the securing members 320 are aligned with the securement features 252, the latch 318 may release the biasing member 325 or move the securing members 320 to the closed configuration. To provide indication of a closed or open state, the latch 318 may be unable to rotate to a closed state unless the securing members 320 are engaged with the securement features 252. Additionally, or alternatively, the release or engagement of the securing members 320 from or to the securement features 252 may provide audible feedback. For example, the latch assembly 315 may click when opening or closing the lid assembly 300.

The lid assembly 300 may include one or more sensors 328. The sensors 328 may detect whether the lid assembly 300 is in a closed or not closed configuration. The sensors 328 may utilize a magnet or detect an electromagnetic field. In one example, the sensors 328 include a Hall Effect sensor. The hall effect sensor may detect and generate a signal when an object is near the sensor 328, such as when the securing member 320 is engaged with the securement feature 252 (e.g. a closed configuration) and a second, different, signal indicating the one or more securement members 320 are not properly engaged with the securement feature 252, such as when the securing member 320 is disengaged or in an open configuration. The sensors 328 may also, or alternatively, detect whether the payload 175 is pinched or otherwise caught in the lid assembly 300. In one example, the sensors 328 may be located at the same location where the securing member 320 engages the securement feature 252. The sensors 328 may additionally, or alternatively, be located at or near the hinges 312 or around a perimeter 258 of the loading aperture 246 or the lid 303.

In some examples, the lid assembly 300 may include a tether mount 330. The tether mount 330 may engage or attach to the tether 150 or feature coupled with the tether 150. The tether mount 330 may be attached to or integral with the lid assembly 300. The tether mount may include electrical connections for electric coupling between the primary aerial vehicle 102 and the secondary aerial vehicle 200. The lid assembly 300 may include one or more wires in connection with the electrical connections with the assemblies of the secondary aerial vehicle 200. In one example, the wires are coupled to the frame 309. The wires may extend into or couple with wires from the secondary aerial vehicle at or through the hinges 312. Accordingly, the circuit may be maintained when the lid assembly 300 is in the open configuration.

In another example of the lid assembly 300, the frame 309B may be formed from impregnated carbon fiber. For example, the frame 309B may include a top layer 311A and a base or bottom layer 311B. The top layer 311A and base 311B may have a similar or corresponding shape. In some examples, the top layer 311A and the base layer 311B may define pairs of extensions or features extending to at or adjacent the securement features 252 or bosses 249. The top layer 311A and the base layer 311B may include perimeter portions 340. The perimeter portion 340 may be a flange or extension positioned around the periphery of the top layer 311A and the base layer 311B.

The frame 309B may include one or more inserts or additional components. In some examples, the inserts or additional components may be an attachment portion 322 for connection with or including the connecting features 320. The inserts or additional components may be hinge pieces 327 for interfacing or connection with the frame bosses 249. The inserts or additional components may be a tether mount 331 for connection to or interface with a tether assembly 400, 1400.

The frame 309B may be formed by overmolding the top layer 311A and the base layer 311B over the inserts. In some examples, the top layer 311A or the bottom layer 311B may define one or more apertures 342 for the inserts to pass through or extend from. The attachment portion 322 may be positioned at the ends of the top layer 311A or base layer 311B configured to be towards the front 232, 233 of the vehicle 200. The hinge pieces 327 may be positioned at the ends of the top layer 311A or base layer 311B configured to be towards the rear side 234 or opposite the attachment portions 322. The tether mount 331 may be positioned centrally between the top layer 311A and base layer 311B. A portion of the tether mount 331 may extend through the aperture 342.

After placing the inserts, the top layer 311A and the base layer 311B may be bonded together along the perimeter portions 340. For example, heat and compression may be applied to cause the impregnated material of the impregnated carbon fiber of the top layer 311A and base layer 311B to melt and contact each other. The top layer 311A and base layer 311B may then be cooled to create a bond between the perimeter portions 340. In some examples, heat may be applied over additional portions of the top layer 311A and base layer 311B to form a bond with the inserts. After forming the frame 309B, foam may be molded over the frame 309B to form the lid 303B.

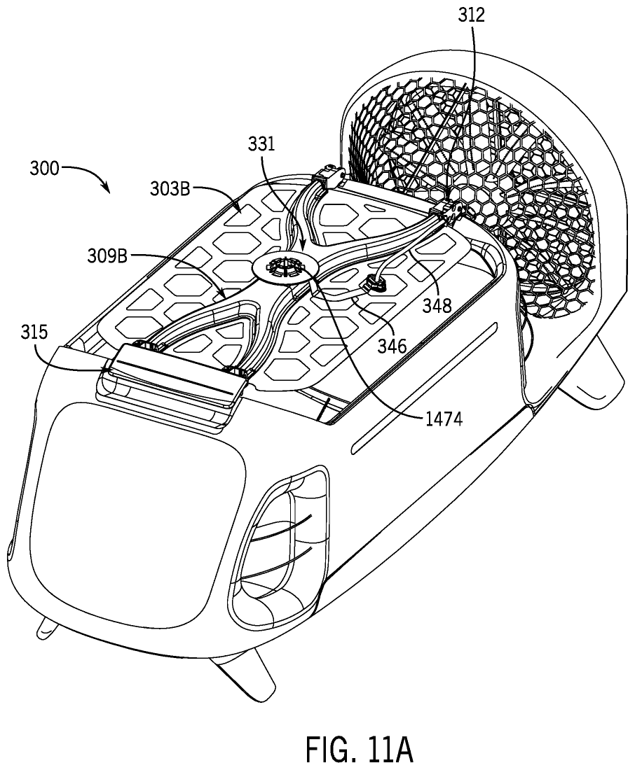

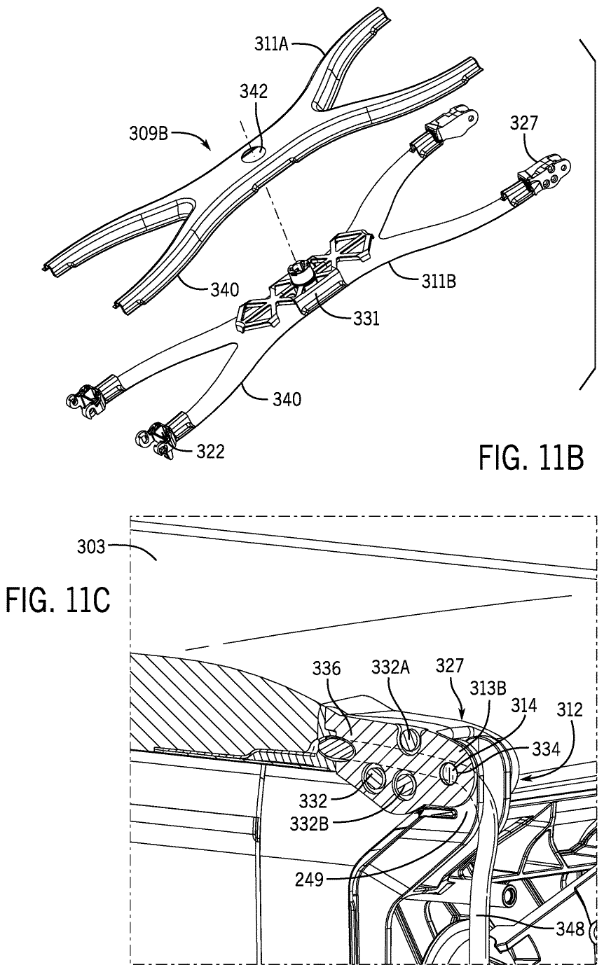

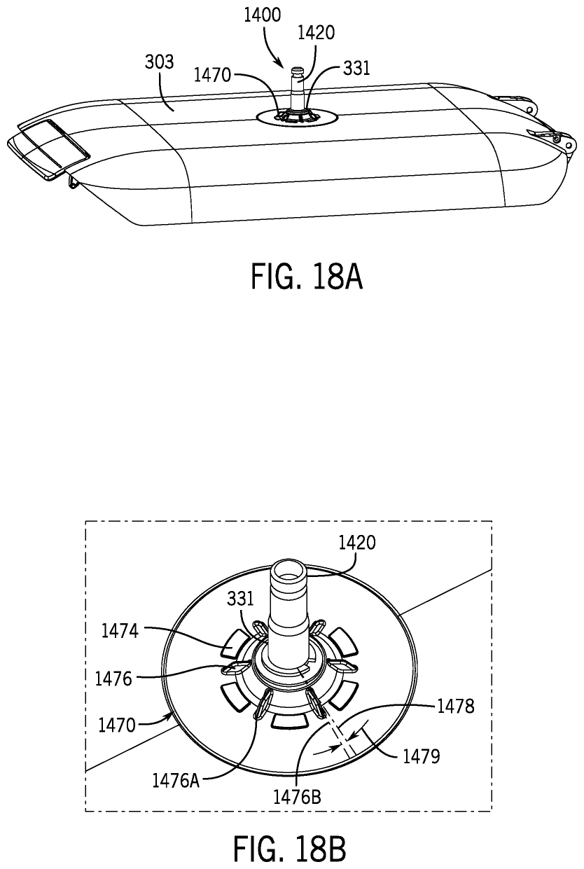

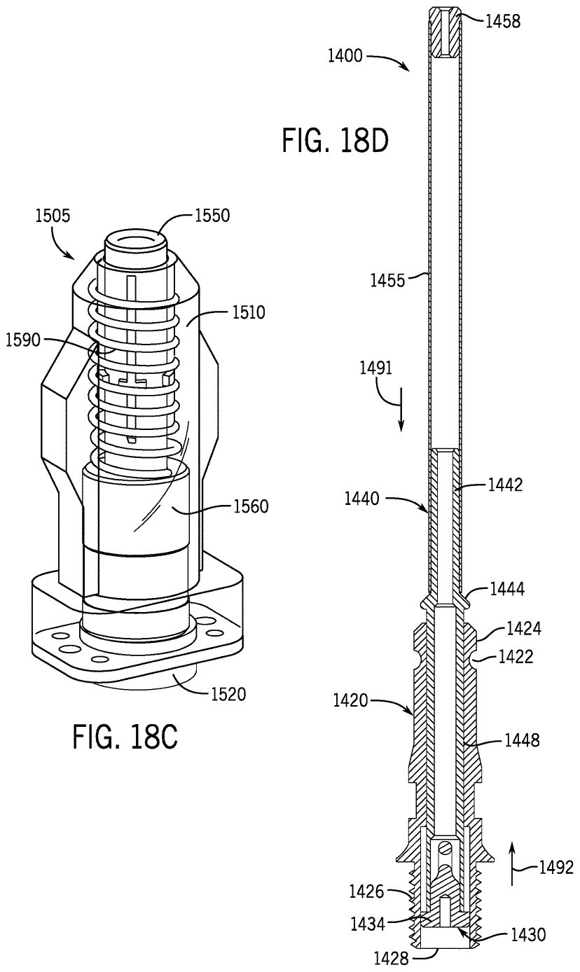

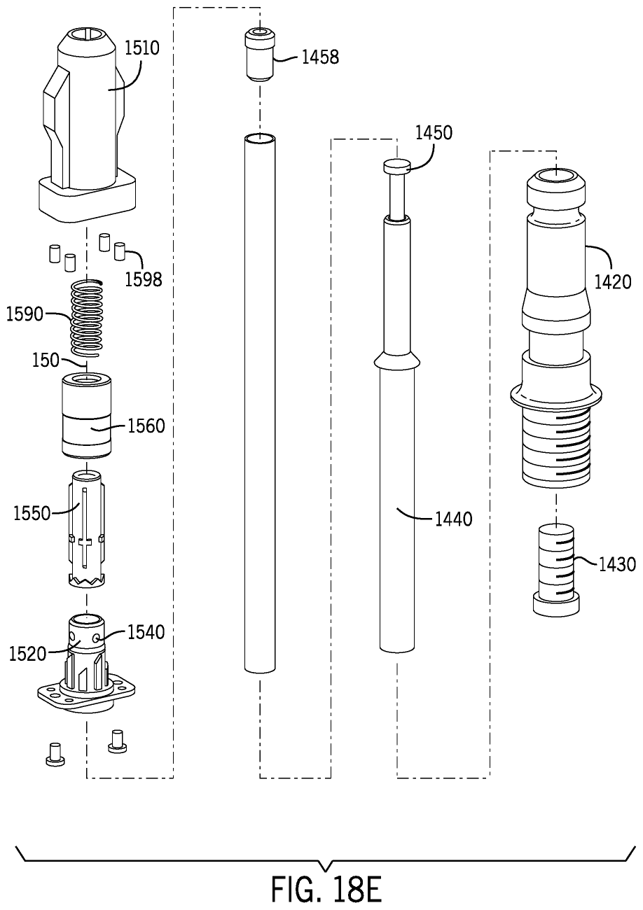

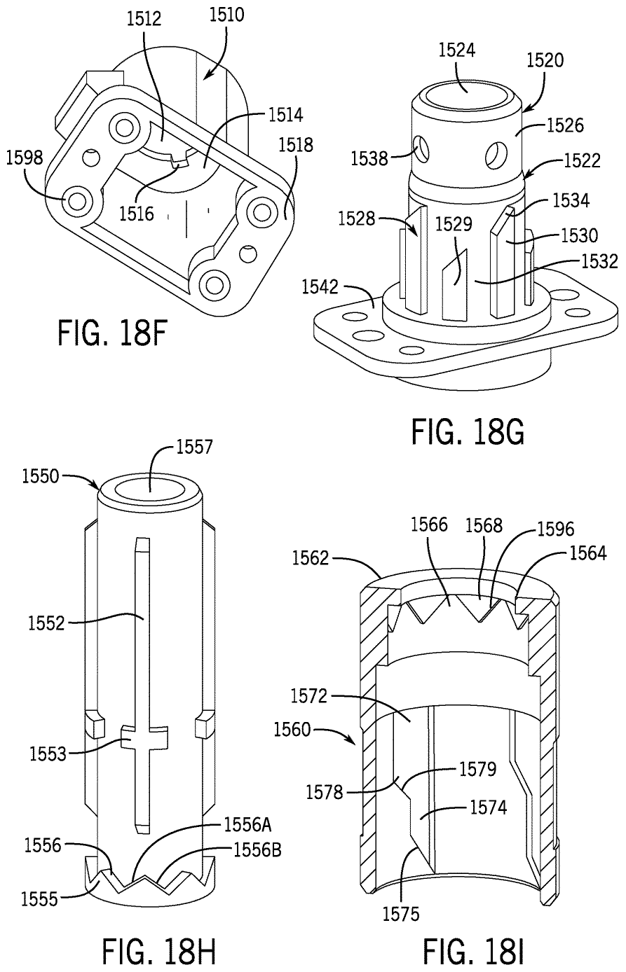

With references to FIGS. 11A and 18B, in some examples the tether mount 331 includes electrical connections or contacts 1474 as discussed herein. The electrical connection 1474 may provide selective electrical communication between the tether assembly 400, 1400, or the primary aerial vehicle 102, and the secondary aerial vehicle 200 components. The electrical contacts 1474 may be electrically connected with a lid flex cable or harness 346 extending from the tether mount 331. The lid flex cable 346 may be electrically connected with a lid cable 348. The lid cable 348 may be connected electrically with the electrical circuits or devices of the secondary aerial vehicle 200.

In some examples, the lid cable 348 may extend along and/or through a portion of the hinge 312, helping to reduce tolerance issues and possible snagging or interference of the cable with portions of the hinge. The hinge 312 may be defined by a rotationally connected hinge piece 327 and the frame boss 249. The hinge piece 327 may include a corresponding boss 313B for rotatably connecting with the frame boss 249. The hinge piece 327 may define an aperture 314 extending through at least a portion of the width or across the hinge boss 313B. The frame boss 249 may be an extension from or a separate frame element 217 to at or adjacent the lid 303. In some examples, the frame boss 249 may be defined by two or more spaced beams or flanges. The hinge piece 327 may be rotationally connected with the hinge boss 249 at the aperture 314 to define one or more pivots 334. For example, the hinge piece 327 may receive a detent or axle of the boss 249 to define the hinge 312 rotatable about the pivot 334.

With reference to FIG. 11C, in some examples the hinge boss 249 and/or hinge piece 327 may define a channel 336. The channel 336 may be an elongated aperture or spacing between features extending transverse to the pivot 327 of the hinge 312. In some examples, the hinge piece 327 defines at least a portion of the channel 336 extending from a side of the hinge piece 327 and through the hinge piece 327 to at or adjacent the pivot 334. In some examples, the frame boss 249 defines at least a portion of the channel 336 as a corresponding aperture or by two or more spaced portions extending transverse to the pivot 334. In some examples, the hinge piece 327 may optionally receive two or more pins 332, such as an upper pin 332a and a lower pin 332b. The pins 332 may be spaced above and below the channel 336. The pins 332 may extend across or transverse to the channel 336.

In one example, the cable 348 extends through at least a portion of the channel 348. For example, the cable 348 may extend through the hinge piece 327 and the frame boss 249. The cable 348 may extend between the pins 332. In some examples, the pins 332 may secure the cable 348 to the hinge piece 327 or within a portion of the channel 348 at the hinge piece 327.

With the cable 348 between the pivots 334, the cable 348 may reduce slop or play in the hinge 312 during rotation about the pivots 334. For example, the cable 348 may provide stability or support to the hinge 312. Positioning the lid cable 348 along the hinge 312 may protect the cable 348 or prevent contact with the cable 348 by a user or object when the lid assembly 300 is open. The pins 332 may assist in stabilizing the cable 348 to prevent binding or pinching of the cable 348 in the hinge 312. In some examples, two lower pins 332b may be used to assist in defining a radius of curvature for the cable 348 during rotation of the lid 303 upward about the hinge 312 to prevent damage to the cable 348. Further, by positioning the lid cable 348 along the hinge 312, the lid cable 348 may be in electrical communication with the components of the secondary aerial vehicle 200 regardless of whether the lid assembly 300 is opened or closed.

### Payload Release Assembly

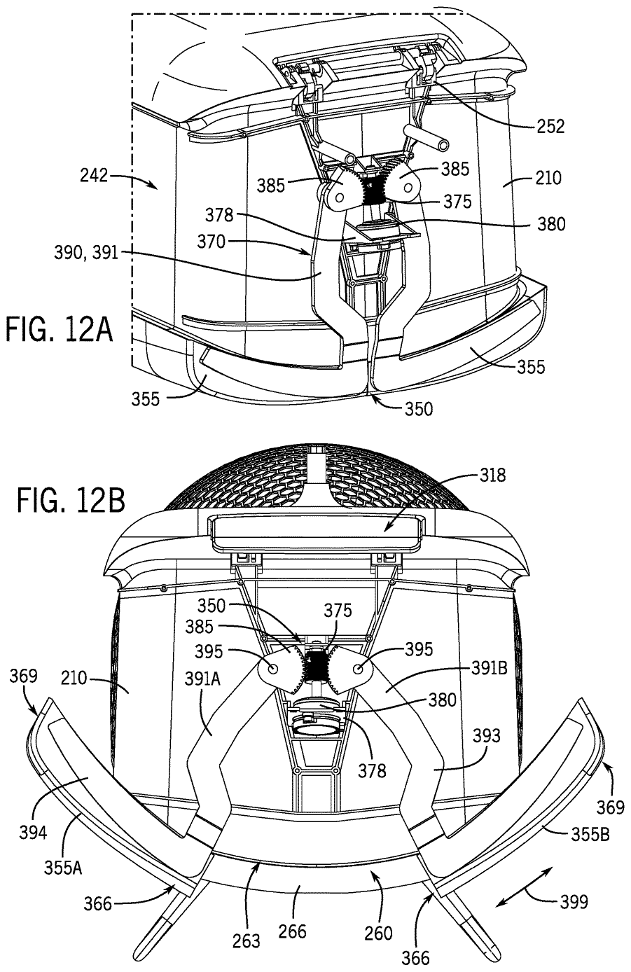

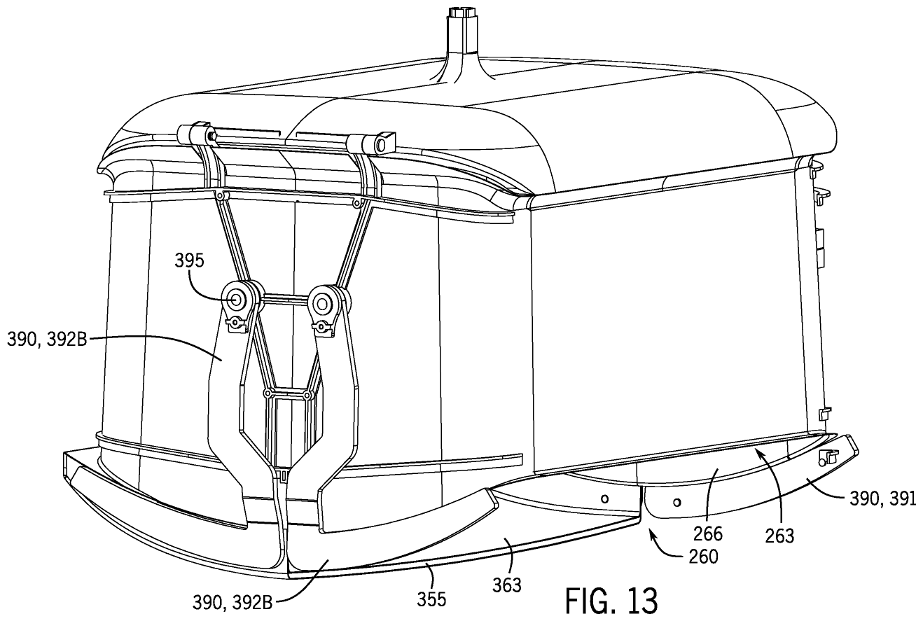

With reference to FIGS. 12A-13, the payload bay 242 release aperture 260 may be selectively accessible by a payload release assembly 350, 351. While description is given with reference to aerial vehicles, it is appreciated the payload release assembly 351 may be utilized by a variety of other devices or vehicles for selectively accessing a volume or deploying an object from the volume. The payload release assembly 350, 351 may include one or more rigid or semi-rigid features, such as a door 355 or other surface, to selectively cover the release aperture 260. By covering the release aperture 260 with a rigid or semi-rigid features, a bottom of a payload 175 may be supported. By supporting the bottom of a payload 175, a variety of payload 175 packaging may be used, and release of a payload 175 after failure of payload packaging may be prevented or inhibited. In one example, the support may be formed as a door 355 or bottom surface 224, 225 of the second aerial vehicle 200, but in other embodiments may be rigid bar or other structural element that may extend across a portion of the aperture 260 to provide a support for the payload 175.

The payload release assembly 350 may include one or more doors 355 to selectively close or open the payload release assembly 350. In one example, two doors 355A, 355B may be used that together cover the release aperture 260. The doors 355 may have an outer region 369 shaped to align with a portion of the perimeter 263 of the release aperture 260. The doors 355 may have an inner region 366 shaped to contact the other door 355 to close the release aperture 260. The interior region 366 of the doors 355 may abut, join, engage, or otherwise align to cover the release aperture 260. For example, the doors 355 may each cover a portion of the release aperture 260. The doors 355 may have a shape corresponding to the shape of the body 210 or the payload bay 242. For example, the doors 355 may have a convex exterior across their width or length and a concave interior 363 across their length or width. The doors 355 may slope downward from the walls 266 of the payload bay 242.

In some examples, the material of the doors 355 may be a foam, carbon fiber material, polymer, or the like. With reference to FIGS. 8A and 8B, the door 355 materials may include a composite skin 358 and a foam inner body 360. In some examples, the doors 355 include an impregnated carbon fiber skin 358 and a foam inner body 360. For example, the carbon fiber skin 358 may define the interior and exterior surfaces of the doors 355. In some examples, the foam inner body 360 may define a shape or arrangement of the door 355, such as the concave interior or convex exterior. For example, the foam inner body 360 may be more easily moulded or otherwise shaped to define the geometry of the doors 355.

The carbon fiber doors 355 may be formed by placing the foam inner body 360 between at least two layers of the impregnated carbon fiber skin 358. The foam portion 360 may not extend to the perimeter of the carbon fiber portion 358. As a result, the perimeter portions of the layers of the carbon fiber portion 358 may be in contact. The perimeter portions may then be bonded together to form the door 355. The carbon fiber skin 358 and foam inner 360 may provide a strong and light door 355.

The doors 355 may be connected to the body 210 of the secondary aerial vehicle 200 via one or more linkages 390. One or more pivots 395 may rotatably couple the one or more linkages 390 to the body 210. The linkages 390 may be shaped to rotate about the pivots 395 to open the one or more doors 355. A first portion 393 of the linkages 390 may extend in a first orientation from the pivots 395 to the doors 355. A second portion 394 of the linkages 390 may extend from the first portion 393 at second orientation transverse to the first orientation. The second orientation may be a direction corresponding to or similar to the path of rotation of the linkage 390 about the pivot 395. The second orientation may correspond to a portion of the shape of the perimeter 263 of the release aperture 260. The linkages 390 may attach to the doors 355 along the second portion 394. The linkages 390 may be a metallic, carbon fiber, plastic, or polymer material, or a combination of materials. The linkages 390 may be coupled to the doors 355 by fasteners, over molding, or by plastic welding.

In one example, the linkages 390 include one or more front linkages 391 and one or more rear linkages 392. The front linkages 391 may be located to the front of the payload bay 242. The rear linkages 392 may be located to the rear of the payload bay 242. Either or both of the front 391 or rear linkages 392 may be operatively associated with the power element 380. In some examples, only one of the sets of the front 391 or rear linkages 392 are associated with the power element 380. The front 391 or rear 392 linkages may include a separate linkage for a first door 355A (e.g., linkage 391A or linkage 392A) and a separate linkage (e.g., linkage 391B or linkage 392B) for a second door 355B.

The linkages 390 and doors 355 may have a geometric configuration to allow the doors 355 to open without contacting the delivery surface or other features of the secondary aerial vehicle 300. For example, as shown in FIG. 12B, the doors 355 may open in a sweeping motion, such as towards a side of the secondary aerial vehicle 200. The linkages 390 may be shaped such that movement of the opening gear 385 in a first direction may allow the doors 355 to move in a second direction, where the second direction may or may not be in the same direction as the first direction. For example, the opening gear 385 may move linearly or translationally and the doors 355 may rotate about the pivot 395. The shape of the linkages 390 may position the doors 355 to open in a direction that follows the shape of the release aperture 260. For example, the shape of the second portion 394 may orient the doors 355 to follow the perimeter 263 of the release aperture 260. The linkages 390 may also allow the doors 355 to open such that gaps between the interior surface 363 of the doors 355 and the sidewalls 266 of the payload bay 242 are reduced. It is appreciated that in some examples, the feet 280 and doors 355 may be oriented such that the doors 355 may open towards any one of the sides of the secondary aerial vehicle 200.

The linkages 390 may be operatively connected to the power element 380 through one or more power transferring elements 370. The power transferring elements 370 may be or include gears, belts, tracks, actuators, rack and pinion, cable and pulleys, or other similar systems. The one or more linkages 390 may include or be connected with one or more opening or guiding features 385. In one example, the guiding feature 385 is an opening gear including one or more teeth. The opening gears 385 may be located adjacent or around the pivots 395. The opening gears 385 may be positioned at or coupled to an end of the linkages 390. The openings gears may be positioned such that a displacement of the opening gears 385 results in a comparatively larger displacement of the second portion 394 of the linkages 390, such as at an opposing end of the linkages 390. In one example, the opening gear 385 is a helix gear. The power element 380, power transferring elements 370, and the like may be positioned towards the front 232, 233 or the rear 234 of the payload bay 242.

The power transferring elements may include a drive mechanism or gear 375. The drive gear 375 may be associated with a power element 380 and provide power to the power transferring elements 370. The drive mechanism 375 may be gear having one or more teeth, a threaded feature, an actuator or actuating feature, or the like. The one or more guiding features or opening gears 385 may engage with the one or more drive gears 375. In one example, the drive gear 375 is a worm gear engaged with the opening gears 385. The worm gear may be oriented at an offset angle relative to the helix gears or linkages 390 to improve engagement between the power transferring elements 370. In some examples, the power transferring elements 370, such as the opening gears 385, associated with each door are engaged with the same drive gear 385. Accordingly, actuation of the drive gear 385 may synchronize opening of two or more doors 355.

The power element 380 may be an electrically powered device capable of moving one or more features of the payload release assembly 350 in response to an electrical input. For example, the power element 380 may be a motor, servo, or actuator. The power element 380 may be coupled to the body 210 of the secondary aerial vehicle 200 by a mount 378. The mount 378 may orient the power element 380 in an offset angular orientation relative to the secondary aerial vehicle 200 or linkages 390. The power element 380 may be coupled with the power transferring elements 370, such as the drive gear 375, to actuate the payload release assembly 350 to selectively provide access the release aperture 242. The angular orientation of the power element 380 may define the drive gear 375 offset angle. The power element 380 may rotate or move in a first direction to cause the payload release assembly 350 to move into or towards an open configuration. The power element 380 may rotate or move in a second direction, different from the first direction, to cause the payload release assembly 350 to close.

The secondary aerial vehicle 200 may carry a payload 175 to a delivery location. At the delivery location, the payload 175 may be released when a potential energy of the payload 175 is safe for delivery, e.g., less than two feet and often less than 1 foot and in many embodiments may be less than 6 inches. In operation, the secondary aerial vehicle 200 may land on a delivery surface, supported by the feet 280 of the secondary aerial vehicle 200. The feet 280 may provide a spacing between the delivery surface and the doors 355. In other examples, the secondary aerial vehicle 200 may be suspended by the tether 150 above the delivery surface during release of the payload 175. For example, the payload 175 may include a parachute or the payload 175 may be released a short distance (e.g. a few inches to a few feet) above the delivery surface. The various methods of releasing a payload 175 may vary depending on a type, volume, or weight of a payload 175.

At the delivery location, the power element 380 may cause power transferring elements 370 to actuate the doors 355 to an open configuration. In one example, the power element 380 causes the drive gear 375 to rotate in a first direction. The drive gear 375 may mesh or be in operative association with the opening gears 385. The movement of the drive gear 375 may move or impart a force on the opening gears 385. The movement of the opening gears 385 may cause the linkages 390 to move towards an open configuration. For example, the opening gears 385 may move relative to the pivot 395 causing the linkages to have a rotation direction 399 about the pivot 395. In one example, the rotation of the worm gear causes helix gears associated with the linkages 390 to move downward.

As the doors 355 open, the concave interior shape of the doors 355 may allow the doors to sweep around the body 210. For example, the concave shape may correspond to a portion of the perimeter 258. The concave shape may also define an angled orientation between the interior surface 363 of the doors 355 and the sidewalls 266 of the payload bay 262. The angle may assist in directing the payload 175 from the payload bay 242 or through the release aperture 260. The concave shape and sweeping motion of the doors 355 may assist in preventing the payload 175 from pinching between the doors 355 and the walls 266. For example, the sidewalls 266 may be oriented or positioned relative to the interior surface 363 of the doors to act as a scraper or brush to assist in delivering a payload 175 from the payload bay 242.

The doors 355 may move a sufficient distance to release the payload 175 from the payload bay 242. In some examples, the doors 355 may move to a fully open configuration to release the payload 175. In the fully open configuration, the interior region 366 of the doors 355 may move to a position at or near an outer edge of the release aperture 260. In other examples, the size and orientation of the payload 175 may be known and the doors 355 may be opened to a distance sufficient to release the payload 175, where the distance may be less than the distance defining the fully open configuration. After release of the payload 175 the doors 355 may close. In some examples, the secondary aerial vehicle 200 may be lifted above the delivery surface or delivery location before closing the doors 355 to prevent the doors 355 from catching on or trapping the payload 175. The secondary aerial vehicle 200 may also be lifted before closing the doors 355 to allow one or more components to determine the payload 175 has been release from the secondary aerial vehicle 200. To reduce delivery times, the doors 355 may be retracted as the secondary aerial vehicle ascends or as the secondary aerial vehicle 200 is attached to or stowed in the primary aerial vehicle 102.

FIG. 13A-13C depict another example of the payload release assembly 351. The payload release assembly 351 depicted in FIG. 13A-13C may include the same or similar doors 355, power elements 380, linkages 390, and the like. The payload release assembly 351 may include a drive mechanism 376 positioned to provide translational movement transverse or orthogonal to the direction of rotation 399 of the doors 355. For example, the payload release assembly 351 may be oriented along a single plane relative to the doors 355 to reduce a volume of the payload release assembly 351. The power element 380 and the drive mechanism 376 of the payload release assembly 351 may be positioned towards the front 232, 233 or the rear 234 of the payload bay 242. During operation, the payload release assembly 351 may open or close the doors 355 by the movement of a single driven element such as the drive mechanism 376. The payload release assembly 351 may be constrained such that the two or more doors 355 rotate open or closed concurrently with a single input or component.

The power element 380 may be a servo motor, actuator, or the like. The power element 380 may be connected or secured to the body 210 or frame elements 217 by a mounting structure 378. In some examples, the mounting structure 378 is attached to or at least partially defined by the aft thrust assembly 620. For example, a shared or same structure may secure the aft motor 625 and the power element 380. In one example, the mounting structure 378 may define a housing or portion of the aft duct 630, 631 and a platform or feature to connect the power element 380. A drive mechanism 376 may be connected or otherwise configured to interface with the power element 380. The drive mechanism 376 may be a threaded feature such as a screw, axle, or gear. In one example, the drive mechanism 376 is a threaded shaft. The drive mechanism 376 may be rotated by the power element 380 to provide power or energy to the system 351. For example, the drive mechanism 376 may function as a drive shaft of the payload release assembly 351. In some examples, the drive mechanism 376 may be moved translationally by the power element 380, e.g., vertically upward or downward. The drive mechanism 376 may be arranged to extend vertically or orthogonally relative to the direction of rotation 399 of the doors 355.

The payload release assembly 351 may include a guide feature 381 configured to move longitudinally relative to the drive mechanism 376. The guide feature 381 may define a threaded aperture 382 that extends through the height of the guide feature 381. The guide feature 381 may include a nose feature 383 extending outward. The nose feature 383 may be a rigid shaft or feature. The nose feature 383 may be integral with the guide feature 381. The nose feature 383 may define a guide channel 384 on a side opposite from the body of the guide feature 381. The guide channel 384 may be a recess or groove extending through the height of the nose feature 383. The guide channel 384 may be approximately aligned or parallel with the orientation of the threaded aperture 382.

The guide feature 381 is connected to or coupled with the drive mechanism 376. For example, the threaded aperture 382 may receive the drive mechanism 376, e.g., the drive mechanism 376 is inserted through and through the threaded aperture 382. The threaded aperture 382 and the drive mechanism 376 may have corresponding threading. The corresponding threading causes the guide feature 281 to move along the length of the drive shaft 376 (e.g., vertically relative to the shaft of the drive mechanism 376) as the drive mechanism 376 rotates.

The frame elements 217 may define a guiding portion or frame guide 219. The frame guide 219 may be a feature of the frame 217 extending adjacent the drive mechanism 376. The frame guide 219 may have a width less than the guide channel 384 of the guide feature 381. When the guide feature 381 is positioned on the drive mechanism 376, the frame guide 219 may be positioned in guide channel 384.

The linkages 390 of the payload release assembly 351 may include a cap portion 396. The cap 396 may be molded, bonded, or defined by the linkages 390 or connected to the linkages 390 at the pivot 395. The cap 396 includes an extension portion 397 extending outward from the linkages 390. The cap 396 may extend generally inward relative to the pivot 395. The extension portion 397 may define a slot 398. The slot 398 may extend along a portion of the length of the extension 397. The slot 398 may be defined to extend further along the extension 397 than across the extension 397.

To operatively connect the linkages 390 with the power element 290 the nose 383 of the guide feature 381 may be positioned in the slot 398 of the cap 396. Accordingly, the slot 398 may have a width or height greater than the nose portion 383. The guide feature 381 may be individually connected to each linkage 390, e.g. extend through each slot 398. Accordingly, each of the doors 355 or links 390 may be constrained by a single feature and connected independently of other doors 355 or linkages 390.

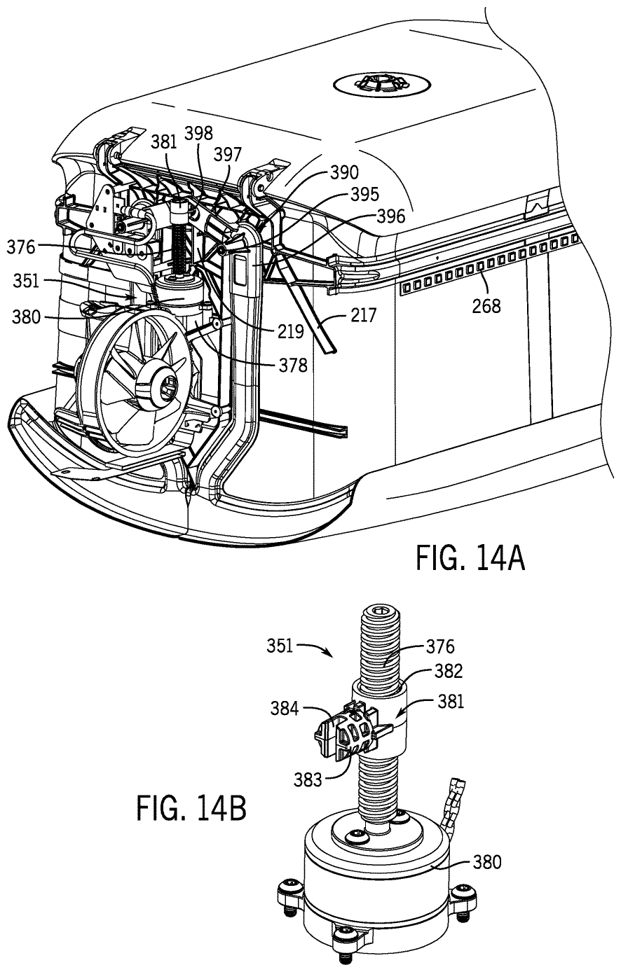

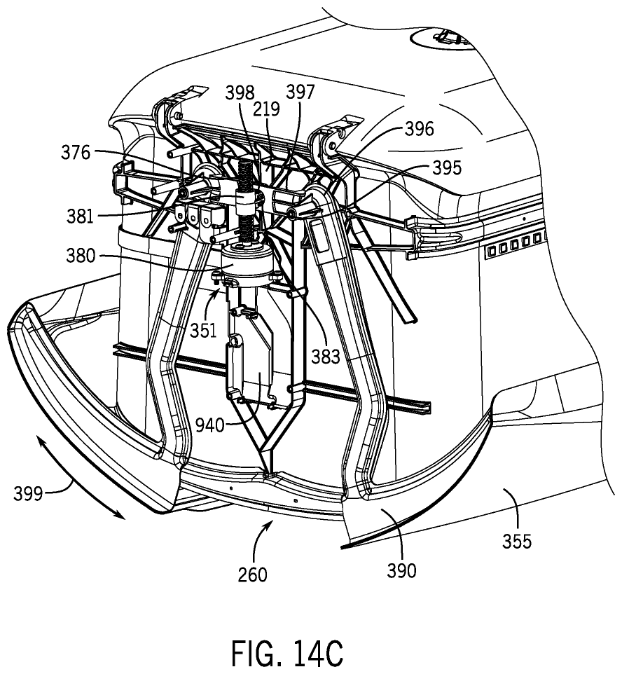

At operation, the power element 380 may rotate or move the drive mechanism 376. The drive mechanism 376 correspondingly moves the guide feature 381. Movement of the guide feature 381 may cause rotation of the linkages 390. The rotation of the linkages 390 causes the doors 355 to rotate about the body 255 to selectively expose or open the payload release aperture 260. During rotation of the drive mechanism 376, the frame guide 219 (see FIG. 14A) may inhibit or limit rotation of the guide feature 381. For example, with the frame guide 219 positioned in the guide channel 384, the guide feature 384 may be rotationally constrained. By limiting rotation, the guide feature 381 may translate vertically during rotation of the drive mechanism 376. For example, because the guide feature 381 may be prevented or limited from rotating, the threaded drive mechanism 376 may rotate relative to the guide feature 381. As the drive mechanism 376 rotates, the drive mechanism 376 threads may engage with the threaded aperture 382 to direct the guide feature 381 along the length of the drive mechanism 376, e.g., upward or downward. As the guide feature 381 translates, the guide feature 381 causes the linkages 390 to rotate. For example, the nose 383 may move within the slot 398 and apply a force to the extensions 397. The movement of the extensions 397 cause the linkages 390 to rotate about the pivot 395. Accordingly, movement of a single guide feature 381 may concurrently rotate or open or close two or more doors 355. In some examples, the slot 398 may be defined with tolerances or dimensions enabling each extension 397 or link 390 to move relative to the nose 383. As a result, while the doors 355 move concurrently, the drive assembly 351 may accommodate a difference in timing or positions of the doors 355 relative to one another.

The extension portion 397 or the slot 398 may be geometrically defined such that the translation of the guide 381 results in the rotational movement of the link 390. For example, the greater length of the slot 398 may allow the guide 381 to move within the slot 398 and prevent binding. The movement of the guide portion 381 relative to the cap 396 or link 390 may decouple or limit tolerance stacking between the parts of the assembly 351. Further, by rotating the links 390 by a mechanism translating orthogonal to the direction of rotation 399, binding, jams, or bending of the components may be reduced or prevented.

To replace the guide feature 381, drive mechanism 376, power element 380, or related features, the components may be removed from the frame elements 217 by simply moving the features in a single direction, such as rearward. A single direction of movement for installation may be preferable or more accessible in contrast to an assembly requiring coordinated installation or installation of parts from multiple directions. A single direction of installation may reduce or limit tolerance stacking between components and reduce the cost of manufacturing or fixing components. As a result, portions of the drive assembly 351 may be quickly, selectively, or easily installed, replaced, or accessed.

In some situations, the secondary aerial vehicle 200 may lose power and the payload release assembly 350, 351 may be arranged such that the assembly 350 does not open when power is lost. For example, without power the power element 380 may be unable to close or open the doors. When no power is provided, the power element 380 may resist movement in at least an opening direction to prevent the payload release assembly 350 from prematurely releasing the payload 175. For example, the power element 380 may prevent the power transfer elements 370 from moving. In one example, the power element 380 prevents undesired rotation of the drive gear 375, which may in turn prevent the linkages 390 and doors 355 from moving.

The shaping of the doors 355 relative to the linkages 390 and pivots 395 may also help keep the doors 355 closed in a loss of power scenario to reduce the risk of accidental deployment of the payload 175. For example, the doors 355 may be connected to the linkages 390 at an orientation transverse to an orientation of the payload 175 weight. The opening orientation of the doors 355 may also be arranged to be transverse to the orientation of the payload weight. Accordingly, the weight of the payload 175 may act in a direction that does not act to open the doors 355. By preventing movement of the doors 355 during a loss of power, the payload 175 may stay contained in the payload bay 242.

Additionally, the configuration of the doors 355 and linkages 390 may allow the primary aerial vehicle 102 to aid in closing the doors 355 if the loss of power occurs while the bay doors 355 are in a position other than the closed configuration. If the secondary aerial vehicle 200 is drawn into the vehicle compartment 124 without power to the payload release assembly 350, the body 114 of the primary aerial vehicle 102 may act to move the doors 355 towards a closed configuration or maintain the doors 355 in a closed configuration. The sweeping motion range of the doors 355 may facilitate the closing motion.

For example, if the secondary vehicle 200 is retracted with the doors 355 in an open configuration the outer regions 369 of the doors 355 may contact the bottom 116 of the primary aerial vehicle 102. The primary aerial vehicle 102 may continue to draw the secondary aerial vehicle 200 into the bay 124 by the tether 150 with sufficient force that the bottom 114 of the primary aerial vehicle 102 forces the doors 355 to the closed configuration, such as along the sweeping path. Accordingly, the power element 380 may allow the payload release assembly 350 to move towards the closed configuration but resist movement towards the open configuration. In other examples, the retraction assembly 500 may pull the secondary aerial vehicle 200 into the bay 124 with sufficient force to overcome resistance from the power element 380.

If the doors 355 are already in a closed configuration, the arrangement of the secondary vehicle 200 in the vehicle compartment 124 of the primary vehicle 102 may assist in preventing the doors 355 from opening. When the secondary vehicle 200 is in the compartment 124, the walls 127 may contact a portion of the exterior of the doors 355. The walls 127 may block or limit movement of the doors 355. For example, by utilizing a sweeping opening geometry the doors 355 may be unable to open if an object, such as the walls 127, limit or constrain upward or lateral movement of the doors 355.

In some examples, to facilitate release of the payload 175, the payload 175 may include an outer housing or container designed to promote delivery from the payload bay 242. For example, the payload housing may include wheels, bearings, smooth surfaces, or other features to facilitate release from the payload bay 242. The payload 175 may also include a parachute or similar mechanism to control the release of the payload 175 at the delivery location above the delivery surface.

In some examples, the payload release assembly 350 may include a biasing element configured to allow quick opening of the payload release assembly 350, such as a spring or elastic system. The biasing element may be triggered by a motor or actuator, or via mechanical impulse provided to the system as the system touches down on the delivery site. The biasing element may then be retracted with the doors 355 during ascent or storing of the secondary aerial vehicle 200. For example, the biasing element may have a quick release and a slow arm or reload cycle to facilitate using a smaller overall actuator or motor that can function over a longer period of time.

### Tether Assembly and Retraction Assembly

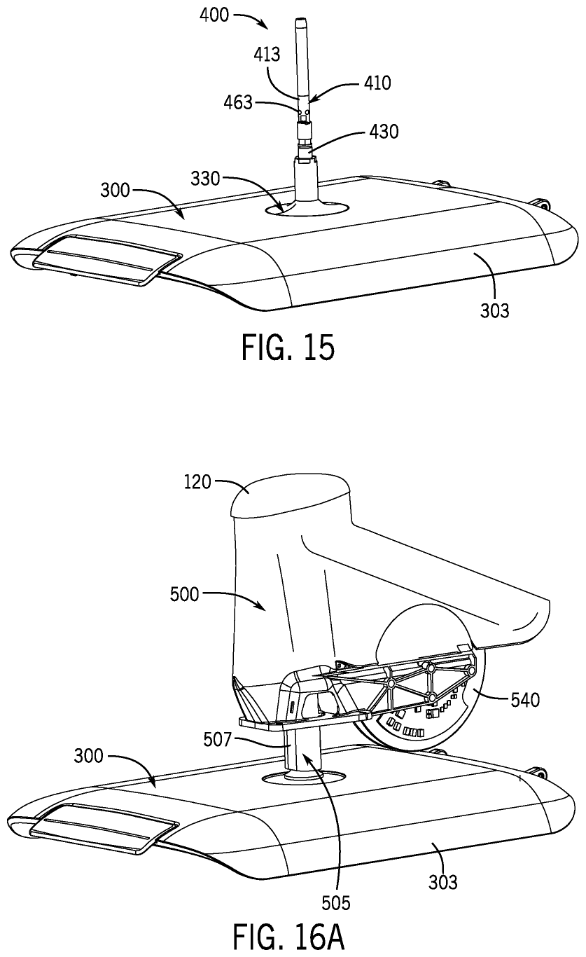

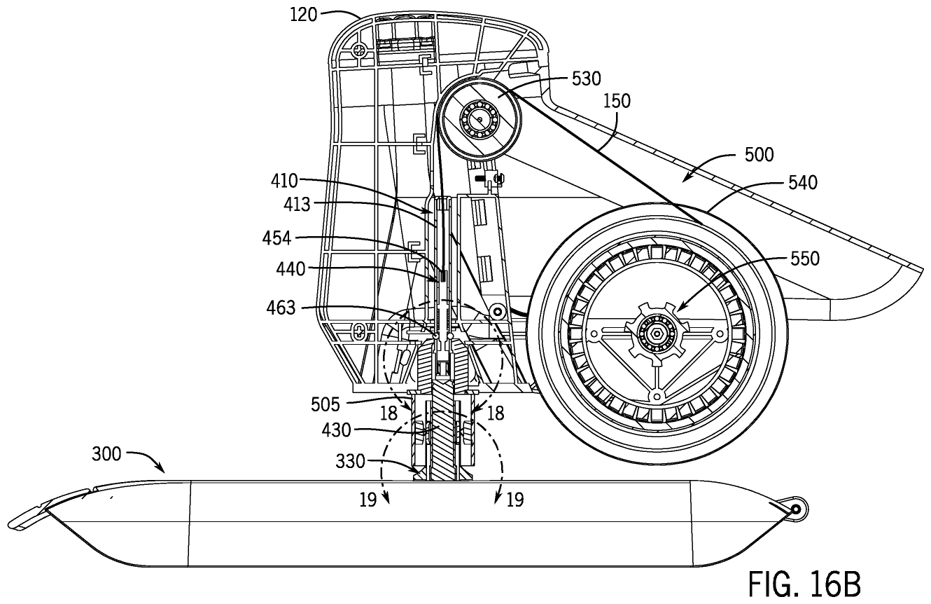

With reference to FIGS. 15-17E and 18A to 191, the aerial vehicle system 100 may include a retraction assembly 500 to deploy or retract the secondary aerial vehicle 200 relative to the primary aerial vehicle 102. For example, the tether 150 may extend between and connect the secondary aerial vehicle 200 and the primary aerial vehicle 102 and act to mechanically and optionally electrically couple the two vehicles 102, 200 together. The retraction assembly 500 may be coupled to the primary aerial vehicle 102. In one example, the retraction assembly 500 may be located above the vehicle compartment 124, such as in the fin 120 of the primary aerial vehicle 102. While description is given with reference to aerial vehicles, it is appreciated the tether assembly 400, 1400 and the receiver 500, 1505, or retraction assembly 500 may be utilized by a variety of other devices including a first device and a secondary or dependent component selectively connected or separable from the first device. In some examples, the tether 150 may be made from a non-conductive material or may include non-conductive shielding (e.g., insulation) to limit or inhibit conduction of electrical energy along the tether 150. For example, a non-conductive tether 150 may reduce the risk of conduction between or resulting from power or transmission wires, electrical strikes, or various conductive objects.

As discussed herein, the tether assembly 400, 1400 and the receiving assembly 500, 1505 may be selectively coupled or uncoupled by applying a tension to the tether 150. The selective movement or tension on the tether 150 may cause movement of an actuating feature 463, 1540 to selectively connect the tether assembly 400, 1400 and the receiving assembly 500, 1505.

The receiver 505 may be a component configured to receive and assist in securing the secondary aerial vehicle 200 to the primary aerial vehicle 102. The receiver 505 may be a separate component attached to or integral with the fin 120. The receiver 505 may be positioned at or near the center of gravity of the primary aerial vehicle 102 or secondary aerial vehicle 200. The receiver 505 may define an aperture 512 extending through an outer body 507. The aperture 512 may have a constant width dimension or vary in width over the length of the aperture 512. In one example, the receiver 505 defines a tapered aperture 512. For example, the aperture 512 may be wider at a bottom side 514 and narrower at a top side 515. The aperture 512 may correspond to or match the shape of the tether assembly 400. For example, the aperture 512 and a feature of the tether assembly 400 may have corresponding tapered shapes. The outer body 507 of the receiver 505 may define a shoulder 518 adjacent or about an end of the aperture 512, such as the top side 515 of the aperture 512. In some examples, the shoulder 518 may be shaped or include a feature to receive, support, support or orient a locking feature of the tether assembly 400.

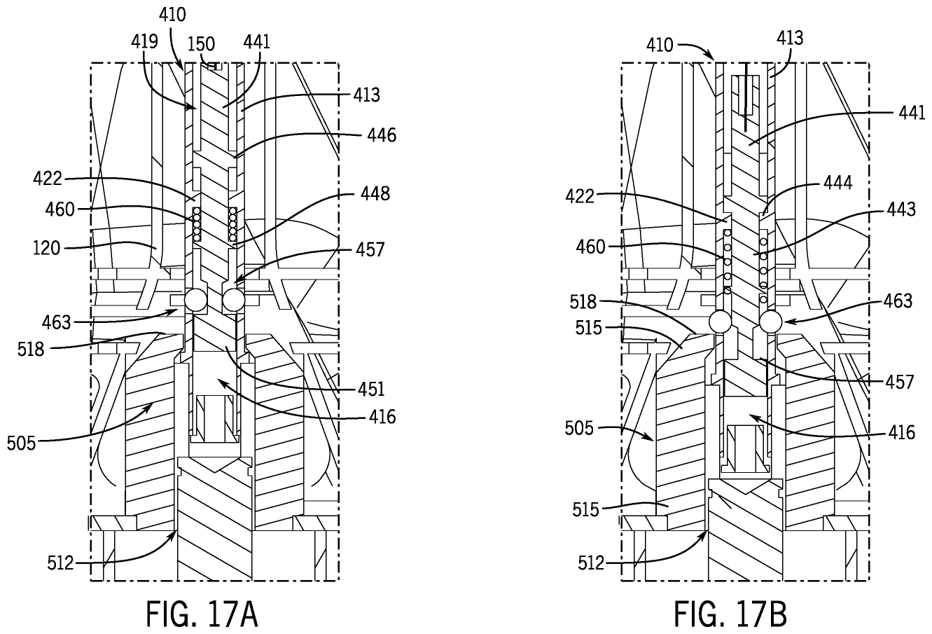

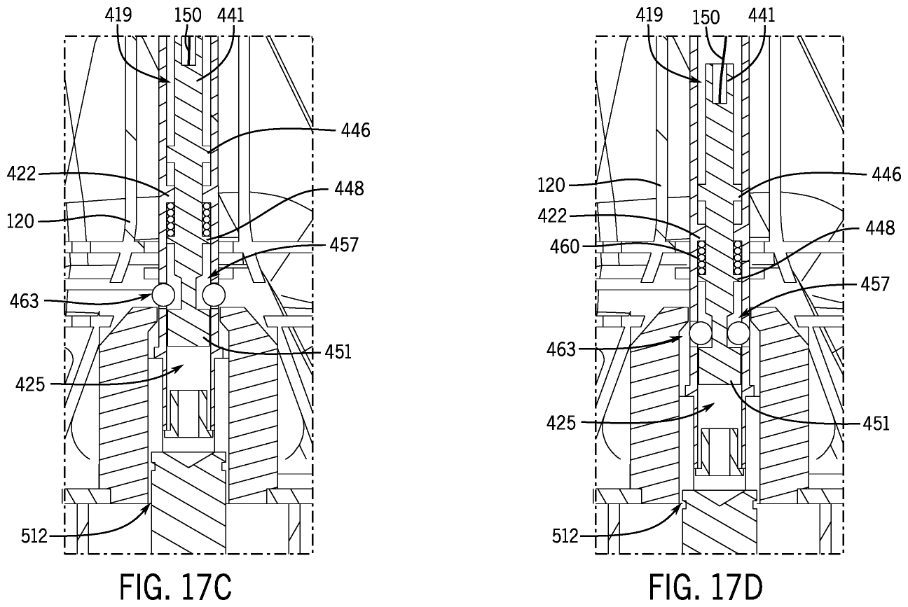

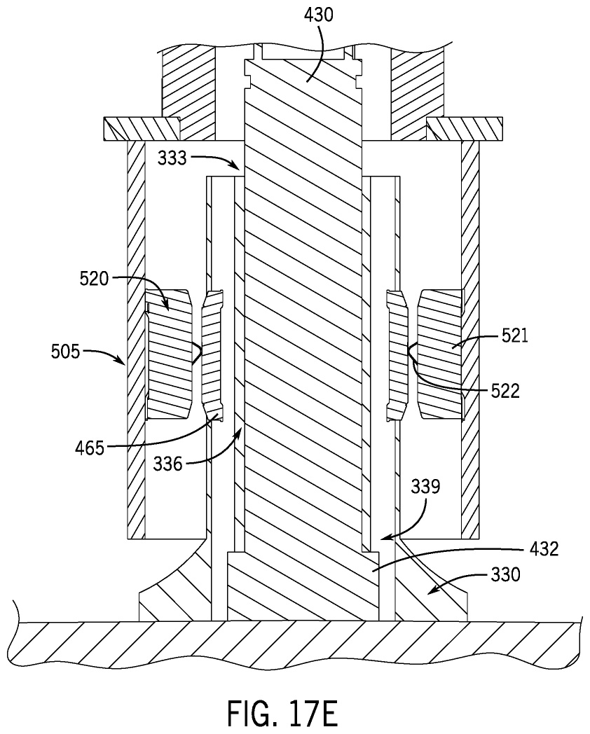

As may be shown in FIG. 17E, the receiver 505 may also include one or more electrical contacts 520 to interface with an electrical connection 465 of the secondary aerial vehicle 200. The electrical contact 520 may include a pad 521 and a compressible element 522. The compressible element 522 may extend from the pad 521 and be configured to conduct electrical energy. The electrical contact 520 may allow for a tolerance in connecting with a second electrical element. For example, when the electrical contact 520 comes into contact with a second electrical element, such as connection 465, the compressible element 522 may compress or reorient towards the pad 521 to accommodate the second element. Accordingly, varying sizes and alignments of the electrical connection 465 may connect with compressible element 522 and electrical contact 520. The compressible element 522 may assist with maintaining proper electrical contact during the vibrations and loads associated with flight.

The spool 540 may be a rotatable component configured to store excess tether 150. The spool 540 may be rotatably coupled to or associated with a winch 550. The winch 550 may provide power to extend or retract the tether 150. The winch 550 may rotate the spool 540 to retract or extend the tether 150. The winch 550 may provide variable speed or power to control the length of tether 150 released and to provide quick deployment or retraction of the tether 150, or for changing between extension and retraction of the tether 150. The winch 550 may allow for rapid deployment or retraction of the tether 150 and the secondary vehicle 200, e.g. not rely purely on passive motions, such as gravity, for deployment. The winch 550 may also be arranged to provide fine adjustments to the length of tether 150 or rates of deployment or retraction.

A pulley 530, or similar rotatable feature, may be located in spaced relationship with the receiver 505 and the spool 540. The pulley 530 may be positioned relative to the receiver 505 such that the tether 150 extends off the pulley 530 into or through the aperture 512 of the receiver 505. The pulley 530 may have a diameter less than the spool 540. The pulley 530 may be spaced from the spool 540 such that the tether 150 extends outward and downward from the pulley 530 to the spool 540. The pulley 530 may assist to provide or maintain a sufficient tension on the tether 150 to assist in storing or retracting the tether 150 from the spool 540. The movement of the tether 150 caused by the winch 550 or spool 540 may cause the pulley 530 to rotate. The pulley 530, spool 540, or winch 550 may be coupled to the fin 120 or structural features of the primary aerial vehicle 102.

The winch 550 may include one or more sensors to detect a tension in the tether 150 or on the spool 540 during extension or retraction of the tether 150. The tension may correspond to a weight of the secondary aerial vehicle 200, or the weight of the vehicle 200 and one or more of wind, a payload weight, or when the tether 150 is caught on an object. In some examples, the sensors may detect a force on the spool 540 or pulley 530 associated with the tether 150. The sensors may also determine a tension on the tether 150 by determining a retraction or deployment rate of the tether 150 for a known input of power to the winch 550. For example, a known torque and a measured rotation speed may be used to determine the tension on the tether 150. Sensors on board the primary aerial vehicle 102 or secondary aerial vehicle 200 may detect a wind speed and a processor can account for the effect of wind on the tether 150 to determine a tension caused by the secondary aerial vehicle 200 as compared to the secondary aerial vehicle 200 and wind.

The retraction assembly 500 may be positioned in a location near or corresponding with the center of gravities of the primary 102 or secondary vehicle 200. For example, the retraction assembly 500 or components of the retraction assembly 500, such as the pulley 530 or winch 550 and spool 540, may be connected to the primary vehicle 102 at a location corresponding to the center of gravities. When the retraction assembly 500 induces tension on the tether 150, a moment relative to a center of gravity on the primary vehicle 102 may be induced. By limiting or eliminating the moment, the primary vehicle 102 may be stabilized during deployment or retraction of the secondary vehicle 200.

The retraction assembly 500 or the winch 550 may assist in providing controlled deployment of the secondary vehicle 200. The rate of descent or ascent may assist in stabilizing the position of the secondary vehicle 200 relative to the primary vehicle 102. For example, a faster descent compared to a slower descent may reduce swinging or movement of the secondary vehicle 200 relative to the primary vehicle 102. Faster descents may also reduce flight times or the time the system 100 is deployed in a region, thereby reducing power consumption, noise, or disruptions at the delivery location. A more stable descent may improve customer confidence or belief in the delivery system 100.

The tether assembly 400 may couple the tether 150 or primary aerial vehicle 102 with the secondary aerial vehicle 200 or the secondary aerial vehicle 200 to the primary aerial vehicle 102. The tether assembly 400 may be configured to be actuated via the retraction assembly 500. For example, the retraction assembly 500 may be actuated by a motor or actuator to move from the unlocked position to the locked position, or the locked position to the locked position. The actuator may be the same actuator that controls the descent and ascent of the secondary aerial vehicle 200, such as a winch 550.

A tether mount or tower 330 of the tether assembly 400 may receive or secure the cable lock 410 or tether 150 to the secondary aerial vehicle. The tether mount 330 may be integrated or coupled to the secondary aerial vehicle 200, e.g., the tether mount 330 may be integral with or coupled to the frame 309 of the lid assembly 300. In one example, the tether mount 330 is a vertically extending tubular structure that extends from the lid (e.g., frame 309) of the secondary aerial vehicle 200.

In some examples, tether mount 330 may define a portion of a turn to lock mechanism. In one example, the tether mount 330 may define a receiving portion of a bayonet mount. The tether mount 330 may define an aperture 333. The tether mount may 330 include interior walls defining the aperture. The interior walls of the tether mount 330 may define connection features to receive or attach to the cable lock 410. For example, the tether mount 330 may include one or more slots or grooves 336 in the interior walls of the tether mount 330 around the aperture 333. The tether mount 330 may include one or more lips defining one or more recesses 339 extending from the slots or grooves 336. The one or more lips may extend transversely relative to the slots or grooves 336. In one example, the recesses 339 extend perpendicular to the grooves 336 and around a portion of the interior perimeter of the aperture 312. Accordingly, a feature, such as a coupling feature 430 may be received in the aperture 333 and then turned to fit in the recesses 339 to prevent removal of the feature.

The tether mount 330 may include one or more electrical connections 465 to interface with an electrical connection or contact 520 of the receiver 505 or the cable lock 410, or both. In some examples, one or more electrical connections 465, such as a pad, may be coupled to one or more sides of the tether mount 330. The one or more electrical connections 465 may be designed to couple with a second electrical element to form a circuit, such as contacts 520, or contact with a surface of the electrical connection 465 may be sufficient to form a circuit.

As shown in FIG. 17E, the cable lock 410 may have a first end coupled to the tether mount 330. The cable lock 410 may have a second end connected to the tether 150. The cable lock 410 may include a housing 413 defining the exterior surface of the cable lock 410. The cable lock 410 may further include a lock mechanism 440 to couple with the receiver 505 or primary aerial vehicle 102.

A coupling feature 430 may be configured to engage the tether mount 330 to selectively couple the cable lock 410 to the secondary aerial vehicle 200. The coupling feature 430 may be cylindrical and fit within the tether mount aperture 333. The coupling feature 430 may include one or more flanges 432 extending outward. The extensions or flanges 432 may be located at or along an end of the coupling feature 430.

The coupling feature 430 may be inserted into the aperture 333 with the flanges 432 positioned in the grooves 336 of the tether mount 330. The coupling feature 430 may be inserted to a point where the flanges 432 are positioned adjacent the recesses 339. The coupling feature 430 may be rotated so that the flanges 432 fit in the recesses 339 and the lips prevent a removal of the coupling feature 430 from the aperture 333. In one example, the coupling feature 430 is rotated in a clockwise direction to position the flanges 432 in the recesses 339. By allowing the cable lock 410 to removably attach to the secondary aerial vehicle 200 the primary aerial vehicle 102 can be easily and quickly swapped out (e.g., the secondary aerial vehicle 200 may be coupled to different primary aerial vehicles 102) or a secondary aerial vehicle 200 may be swapped (e.g. the primary aerial vehicle 102 may be coupled to different secondary aerial vehicles 200). The cable lock 410 may also be removed without adjusting a tension in the tether 150 to prevent the tether 150 from disengaging with or tangling in the retraction assembly 500.

The housing 413 of the cable lock 410 may interface with the receiver 505 of the retraction assembly 500. The housing 413 may have a variety of shapes or configurations to assist in guiding the cable lock 410 into the receiver 505. For example, the housing 413 may have a shape that progressively increases or decreases in width along a portion of its length. In one example, the housing 413 is plunger shaped with a width at or near a base that is greater than a width at or near a top of the housing 413. The housing 413 may further include an internal volume 416 defining one or more internal regions. For example, the internal volume 416 may have an upper region 419 and a lower region 425. The upper region 419 and the lower region 425 may be separated by one or more shoulders 422 extending inward from the housing separating or partitioning the internal volume 416. The housing 413 may further define one or more apertures 428 extending through the housing 413 from the interior volume 416 to the exterior. In one example, the apertures 428 extend between the exterior and the lower region 425. In some examples, the housing 413 may define internal threading or additional features to couple with one or more of the lock mechanism 440 or coupling feature 430.

The lock mechanism 440 may be configured to couple the cable lock 410 to the tether 150 and selectively couple the cable lock 410 with the receiver 505, or the secondary aerial vehicle 200 with the primary aerial vehicle 102. The lock mechanism may include an actuating feature 463. The actuating feature 463 may be an active or passive mechanism such as a pin, axle, movable detent, clip or the like. The actuating feature 463 may selectively engage or disengage the cable lock 410 with a feature of the primary aerial vehicle 102.

The lock mechanism 440 may include a slider 441 to actuate or move in response to a tension on the tether 150 between a locked or unlocked configuration. The slider 441 may include a central shaft 443 and one or more flanges 444 or regions extending outward from the central shaft 443. In one example, the slider 441 may include a top flange 446, a middle flange 448, and a bottom flange 451. The slider 441 may be a single piece or two or more pieces joined together. For example, the slider 441 may include two pieces threadably joined together. The slider 441 may include a feature to attach to the tether 150 at one end. For example, the slider may include a tether catch 454 to couple with the tether 150.

The slider 441 may be positioned within the internal volume 416 of the housing 413. One flange 444 may be positioned on one side of a shoulder 422 and a second flange 444 on a second side of the shoulder. In one example, the top flange 446 is positioned in the upper region 419 of the housing 413 and the middle flange 448 is positioned in the lower region 425 of the housing 413, a shoulder 422 between the top flange 446 and middle flange 448. Between one and more of the extensions or flanges 444, an unlocking volume 457 may be defined by the slider 441 and the housing 413 for receiving one or more movable detents 463. In one example, the unlocking volume 457 is defined between the middle flange 448, bottom flange 451, central shaft 443, and housing 413.

The one or more movable detents 463 may be features configured to extend outward from the one or more apertures 428 of the housing 413 in the locked configuration and retracted or withdrawn from the apertures 428 when in the unlocked configuration. The movable detents 463 may be a pin, ball, lever, or similar feature. The movable detents 463 may be shaped to extend partially through an aperture, such as aperture 428, without exiting the housing 413. For example, the movable detent 463 may be a ball having a diameter less than a diameter of the aperture 428. The movable detents 463 may be shaped or positioned to move into or out of the aperture 428 in response to a force on the detent 463. For example, an internal force may move the detent 463 towards or into the aperture 428, while an external force may move the detent 463 away from the aperture 463 or into the housing 413.

The lock mechanism 440 may include a biasing element 460 to facilitate positioning of one or more of the components in the locked or unlocked configurations in response to a tension on the tether 150. The biasing element 460 may be a spring, coil, elastic member, or another material that may deform under a force and expand or release energy when the force is reduced or removed. The biasing element 460 may be selected or tuned to compress or expand between the locked or unlocked configurations for a given tension or a range of tension. The biasing element 460 may be tuned such that the inertia of a component of the lock mechanism 440 is unable to overcome the biasing element 460 during flight or operation of the aerial vehicle system 100, such as from turbulence. The biasing element 460 may also be tuned to change between the locked and unlocked configurations at different speeds. For example, a biasing member 460 that expands rapidly may facilitate quick locking or unlocking of the secondary aerial vehicle 200 to the primary aerial vehicle. The biasing element 460 may be positioned between a feature of the slider 441 and the housing 413 to direct the slider 441 to a position relative the housing 413.

In the locked configuration, one of the flanges or extensions 444, such as the middle flange 448, may be positioned adjacent, or inward relative to the movable detent 463, forcing the movable detent 463 outward. The flange 444 configured to move the movable detent may be angled or define a profile to facilitate a transition of the movable detent 463 to one or both of the locked or unlocked configuration. In some examples, a feature of the receiver 505 may move the movable detent 463 inward to unlock and release the cable lock 410. For example, the shoulder 518 of the receiver 505 may direct the movable detents 463 into the unlocking volume 457.

The biasing element 460 may be positioned between one of the extensions or flanges 444 and a shoulder 422 to facilitate positioning the slider 441 in the locked or unlocked configuration. In one example, the biasing member 460 is positioned between the middle flange 448 and a shoulder 422 of the housing 413, the shoulder between the middle flange 448 and the top flange 446.

FIGS. 17A-17D may show example configurations of the tether assembly 400 and the retraction assembly 500. In operation, the cable lock 410 may be inserted into the receiver 505 in the unlocked configuration. The cable lock 410 may be drawn above or past the receiver 505 by the winch 550 to the unlocked but ready to lock configuration. To prepare to secure the cable lock 410 to the retraction assembly 500, the cable lock apertures 428 may be positioned above the receiver shoulder 518 prior to decreasing or removing tension. To position the cable lock 410 in the locked configuration, tension in the tether 150 may be reduced or removed such that the biasing element 460 moves the slider 441 to the locked position.

For a given tension on the tether 150, or range of tension, the slider 441 may compress the biasing element 460. For a second tension, or range of tension, less than the first tension the biasing element 460 may resist compression or move the slider 441. For example, when tension is applied to the tether 150, the biasing member 460 may be compressed and the slider 441 may move upward relative to the housing 413. When the tension on the tether 150 is removed or reduced, the biasing member 460 may expand with a greater force than the tension on the tether 150, thereby moving the slider 441 downward relative to the housing 413. The weight of the secondary aerial vehicle 200 or movement of the secondary aerial vehicle 200 may produce the tension on the tether 150. Accordingly, tension may be increased by raising the aerial vehicle 200, such as by retracting the tether 150, or decreased by releasing or rapidly extending the tether 150 to allow for the aerial vehicle 200 to move downward. Accordingly, the winch 550 may rapidly raise and release the tether 150 tension such that tension is reduced or removed to allow the biasing element 460 to overcome the tension in the tether 150 to move the slider 441 downward and the movable detents 463 to the locked configuration. In the locked configuration, the detents 463 extend through the apertures 428 to rest on or connect to the shoulder 518 of the receiver 505. The receiver 505 and detents 463 prevent the cable lock 410 from exiting the receiver 505. An example locked configuration may be shown by FIG. 17B.

Because the cable lock 410 may retain the secondary aerial vehicle 200 in the primary aerial vehicle 102, the winch 550 does not need to maintain torque or tension to keep the secondary vehicle 200 in connection with the primary vehicle 102. In contrast, without the cable lock 410, an electrical current would be required to allow the winch 450 to maintain the secondary aerial vehicle 200 in the stowed or locked configuration, e.g., the winch 450 would need to be powered to keep the line taut. Accordingly, the cable lock 410 may reduce wear on the winch 550 and reduce power consumption. The biasing element 460 may also provide faster locking and unlocking than other assemblies allowing faster delivery times and reduced power consumption. In the event of a loss of power to one or more components of the system 100, the cable lock 410 may continue to couple the secondary vehicle 200 and the primary vehicle 102.

As shown in FIG. 17E, when the tether assembly 400 is in the locked configuration, the electrical connections 465 of the tether assembly 400 may engage with the electrical connections 520 of the receiver 505 or primary aerial vehicle 102. The electrical contacts 465 may contact and compress the pins 522. The compression of the pins 522 may maintain contact if the tether assembly 400 sways or otherwise moves within the receiver 505 during flight. When the electrical contacts 465 are in contact with pins 522 an electrical circuit may be defined between the primary aerial vehicle 102 and the secondary aerial vehicle 200. The completion of the electrical circuit may generate a signal or provide an indication to the secondary aerial vehicle 200 or primary aerial vehicle 102 that the secondary aerial vehicle 200 is stowed in the primary aerial vehicle 102.

With continued reference to FIGS. 17A-17D, to deploy the secondary aerial vehicle 200, or to put the cable lock 410 in the unlocked configuration, the retraction assembly 500 may apply tension to the tether 150. For example, the winch 550 may cause the spool 540 to rotate to exerting a lifting force on the tether 150 to generate or increase tension on the tether 150. When tension is applied, the slider 441 may overcome or compress the biasing element 460 and move upward relative to the housing 413. As the slider member 441 moves upward the unlocking volume 457 may be positioned behind the one or more movable detents 463, defining an unlocked configuration as may be shown in FIG. 17C.

To release the secondary aerial vehicle 200, or the cable lock 410, the aerial vehicle 200 may be lowered when in the unlocked configuration. The receiver 505 or the shoulder 518 of the receiver may contact or direct the movable detents 463 into the unlocking volume 463 to position the lock mechanism 440 in a released position. The movable detents 463 may move inwardly to the unlocking volume 457 and the cable lock 410 may descend. In some examples, the shape of the shoulder 518, such as an angle, may assist in moving the detent 463 into the unlocking volume 463. An example unlocked and released configuration may be shown in FIG. 17D.

The retraction assembly 500 or tether assembly 400 may include a line cutter. The line cutter may be positioned adjacent the tether 150. The line cutter may cut or release the tether 150 to free the secondary aerial vehicle 200 from the primary aerial vehicle 102 in the event of failure of either the primary aerial vehicle 102 or the secondary aerial vehicle 200. For example, the line cutter may be activated when the primary aerial vehicle 102 or secondary aerial vehicle 200 determines the retraction assembly 500 is unable to retract the secondary aerial vehicle 200.

The tether assembly 400 may also assist in stabilizing the secondary aerial vehicle 200 during deployment. The tether assembly 400 defines a rigid or semi-rigid structure. The tether assembly 400 may extend a distance above the secondary aerial vehicle 200 before attaching to the flexible tether 150. For example, the tether mount 330 or the cable lock 410 may be rigid and maintain a position relative to the body 210 when a force is exerted on the features. The rigid structure and distance above the secondary aerial vehicle may define a moment arm relative to the center of gravity of the secondary aerial vehicle 200. For example, when a payload 175 in the payload bay 242 is misaligned with the center of gravity of the secondary aerial vehicle 200, the payload 175 may cause the secondary aerial vehicle to rotate to position the new center of gravity in alignment with the tether 150. By defining a moment arm, the tether assembly 400 may resist rotation of the secondary aerial vehicle 200. By resisting rotation of the secondary aerial vehicle 200, the secondary aerial vehicle 200 may maintain a bottom down configuration or align with the vehicle bay 124 for coupling with the primary aerial vehicle 102. Additionally, keeping the secondary aerial vehicle 200 aligned relative to the center of gravity or the tether 150 may have improve a recipient's confidence or experience in the system over a rotated or angled secondary aerial vehicle 200 during descent.

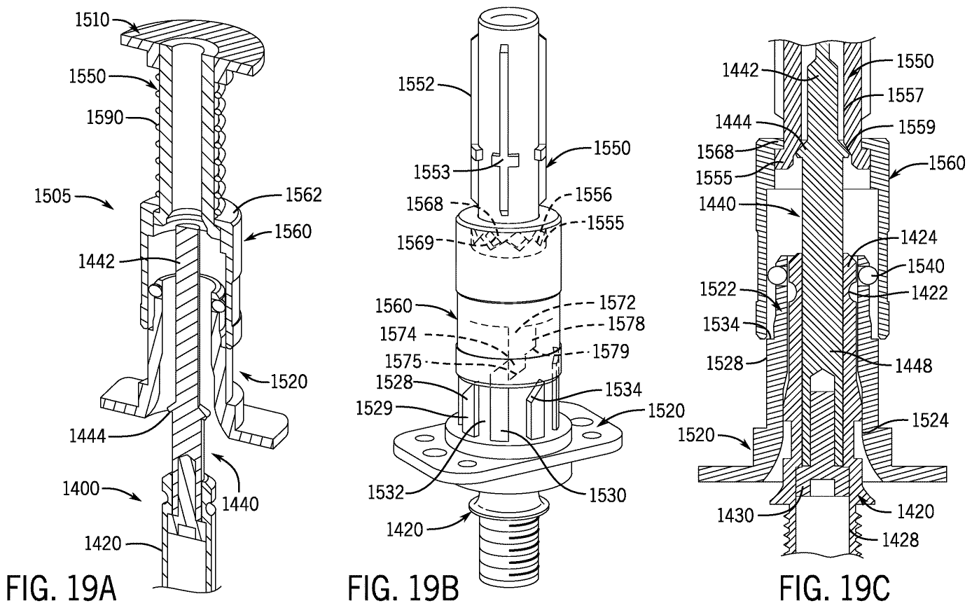

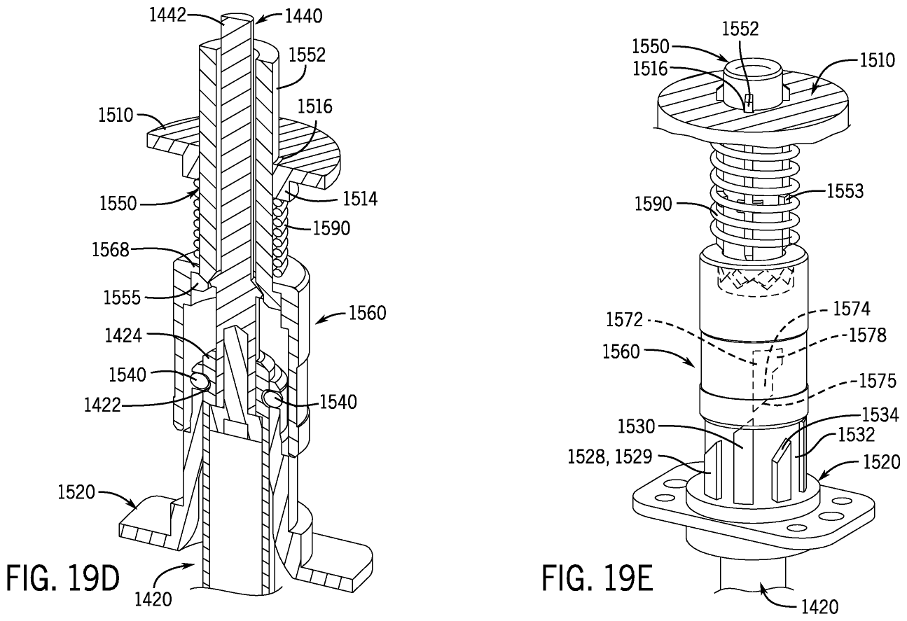

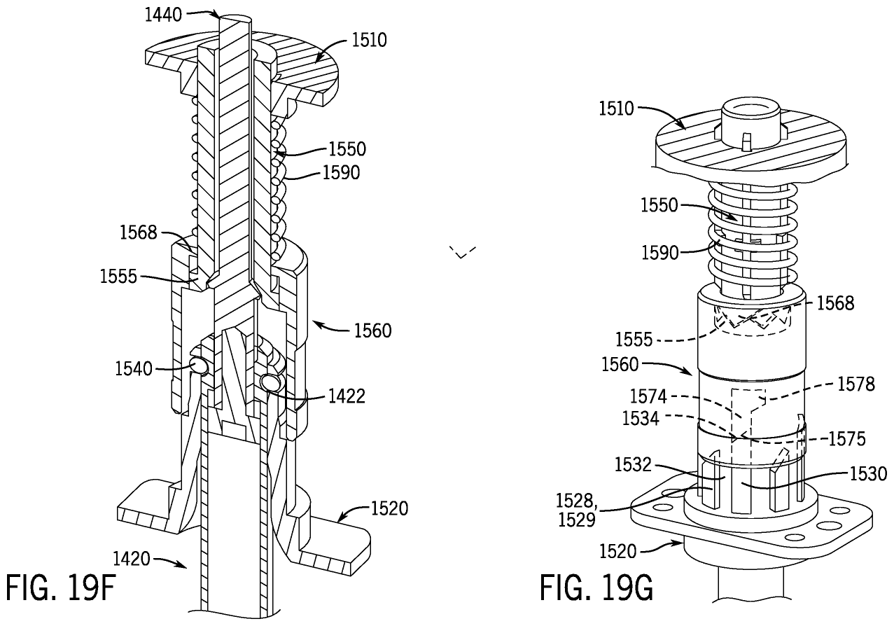

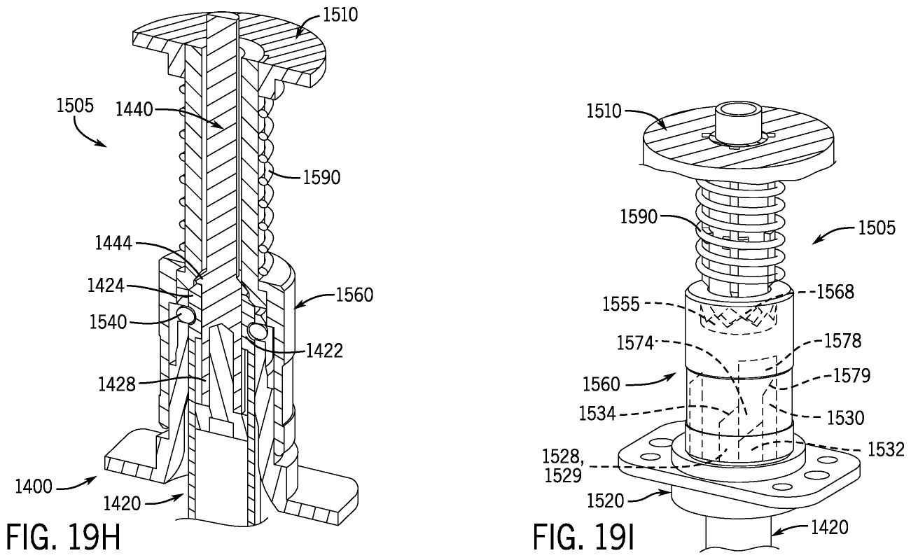

FIGS. 18A-19I depict another example of the tether assembly 1400 and retraction assembly 500 including a receiver 1505. The tether assembly 1400 may include one or more of the similar or same features of the tether assembly 400. The receiver 1505 may include one or more of the similar or same features of the retraction assembly 500 or receiver 505. The tether assembly 1400 and the receiver 1505 may similarly provide selective locking and unlocking of the secondary vehicle 200 with the primary vehicle 102. The locking or attachment of the tether assembly 1400 and the receiver 1505, or retraction assembly 500, may limit or prevent vertical movement of the secondary aerial vehicle 200 relative to the primary vehicle 102. The locking or attachment of the tether assembly 1400 and the receiver 1505, or retraction assembly 500, may also limit the amount or length of tether 150 deployed from the primary vehicle 102. For example, the tether assembly 1400 and receiver 1505 may lock the secondary vehicle 200 on the tether 150 (e.g., along a length of the tether 150), such as to limit movement (e.g., vertical) of the secondary vehicle 200 relative to the primary vehicle 102, such as for storage of the secondary vehicle 200 within the primary vehicle 102. As a result, the locking connection may secure the secondary vehicle 200 during movement of the primary vehicle 102, such as for forward flight.

An example tether assembly 1400 is shown in FIGS. 18A-18B and 18D-18E. In the example shown, the tether assembly 1400 includes a tether mount 331. The tether mount 331 may be coupled to or defined at least in part by the lid assembly 300 (e.g., the lid 303). The tether mount 331 may define an aperture or receptacle 1331. The aperture 1331 may define threading, a bayonet mount, or the like.

In examples, the tether assembly 1400 includes a tether portion 1410. The tether portion 1410 includes a tether mount or tower 1420. The tower 1420 may be a shaft or rod coupled with the lid 303. The tower 1420 may be a rigid member of the tether assembly. The tower 1420 may be hollow or define an aperture 1428 extending through the height of the tower 1420. The tower 1420 may define a locking volume 1422, such as a channel, aperture, recess, or the like in the exterior of the tower 1420, such as adjacent an end of the aperture 1428. A shoulder 1424 may be defined between the channel 1422 and the aperture 1428. The shoulder 1424 may be an exterior rim, flange, or region of the tower 1420 around or adjacent the aperture 1428. The channel 1422 may be a depression, aperture, recess, groove, or region having a smaller width dimension or diameter relative to the shoulder 1424. In some examples, the channel 1422 defines an unlocking volume. Opposite the shoulder 1424 end of the tower 1420, the tower 1420 may define external connection features 1426 such as a corresponding threading, bayonet mount, or the like for connection with the tether mount 331 of the lid 303.

In some examples, the tether assembly 1400 includes a plunger portion 1440. The plunger portion 1440 (see FIG. 18D) may be an elongated feature or cylinder shaped feature. The plunger portion 1440 includes an upper shaft portion 1442 having a featureless or limited feature exterior. The plunger portion 1440 may be hollow to allow the passage of the tether 150. Optionally, the upper shaft portion 1442 may define a tether tie or tether holding feature 1450 to connect with the tether 150. The plunger portion 1440 may define one or more flanges 1444. The flanges 1444 may extend outward from the bottom of upper portion 1442. The plunger portion 1440 may define a lower portion 1448 below the flanges 1444. The width or thickness of the lower portion 1448 may correspond to a width of the tower aperture 1428.

With reference to FIG. 18D, the plunger portion 1440 may be inserted into the tower 1420. For example, the lower portion 1448 may be inserted into the tower aperture 1428. The plunger portion 1440 and the tower 1420 may be slidably connected. The flanges 1444 may contact the shoulders 1424 to limit a first direction 1491 of travel of the plunger portion 1440 relative to the tower 1420. As a result, in some examples, the flanges 1444 define a seated configuration of the plunger portion 1440 within the tower 1420. Relatedly, the shoulder 1424 contact with flanges 1444 may prevent or limit removal or downward movement 1491 of the plunger portion 1420 through the tower 1420, such as when the tether portion 1400 is coupled with the receiver 1505. The tether assembly 1400 may include a stopper 1430. The stopper 1430 may be coupled to a bottom of the plunger portion 1440. The stopper 1430 may inhibit or limit a second direction 1492 of travel of the plunger portion 1440 or the tower 1420 relative to the other. The second direction 1492 may be opposite the first direction 1491. Accordingly, the stopper 1430 may slidably secure the plunger portion 1440 within the tower 1420 and constrain a range of movement of the plunger portion 1440 relative to the tower 1420. For example, the stopper 1430 may prevent or limit removal of the plunger 1440 upward (e.g. in direction 1492).

In some examples, the tether assembly 1400 may optionally include a stabilizing cover 1455. The stabilizing cover 1455 may be an elongated feature including an aperture or tunnel, such as a tube. The stabilizing cover 1455 may be positioned above or on the plunger portion 1440 (e.g., on the upper shaft portion 1442) with the tether 150 extending through the cover 1455. The stabilizing cover 1455 may limit the degree to which the tether assembly 1400 may tilt or rotate relative to the tether 150, such as by creating a contact point further above the secondary vehicle 200. As a result, the tether assembly 1400 may be positioned generally more vertical during retraction.

As shown in FIG. 18A-18B, in some examples the tether assembly 1400 or the lid assembly 300 may define a tether base 1470. The tether base 1470 may include one or more electrical contacts 1474, such as pins, pads, or the like. The tether base 1470 may define an aperture 1472 through which the tower 1420 or tether mount 331 extends. The tether base 1470 may include a plurality of fins 1476 spaced about the aperture 1472 or tower 1420. The plurality of fins 1476 may be offset relative to the others by an angle. For example, a first fin 1476a may extend radially outward. A second fin 1476b may extend at an angle 1479 relative to a radial extension 1478 extending along a radial direction from the center of the tether base 1470, such that the second fin 1476b is angled offset from the radial extension 1478. The angle 1479 may be relatively small, such as between 1 and 4 degrees. The clocked or angled fin 1476b in combination with the first fin 1476a may create a friction fit with a corresponding feature of the receiving assembly 1505 to limit rotation when coupled. For example, the differing orientations of the fins 1476a, 1476b may intentionally wedge the fins 1476 with a corresponding feature of the receiving assembly 1505.

The retraction assembly 500 may include a receiver assembly 1505. The receiver assembly 1505 may receive and selectively secure or connect with the tether assembly 1400. The receiver assembly 1505 may include a main body or casing 1510. The casing 1510 may be a generally elongated feature. The casing 1510 may define an aperture 1512 extending through the length. The casing aperture 1512 may have a first diameter at the top of the casing 1510 and extend to a wider dimension to define an interior shoulder 1514. The casing 1510 may define one or more interior channels 1516 extending from the casing aperture 1512. The interior channels 1516 may be slots or grooves extending parallel or generally parallel to the length of the casing 1510. The casing 1510 may also define a base flange 1518 extending from a bottom of the casing 1510.

The receiver assembly 1505 may include a base portion 1520. The base portion 1520 may include a cylindrical or tube portion 1522. The cylindrical or tube portion 1522 may define an inner aperture 1524 extending through the height of the base portion 1520.

The base portion 1520 may define two or more transition guides 1528. The transition guides 1528 may be extensions from the exterior 1526 of the base portion 1520. The transition guides 1528 may extend along the tube portion 1522, such as along a length or height of the tube portion 1522. The transition guides 1528 may be spaced by one or more gaps 1532. The transition guides 1528 may vary in height. For example, a first set 1529 of transition guides 1528 may be shorter than a second set 1530 of transition guides 1528. The first set 1529 and the second set 1530 may alternate about the tube portion 1522. For example, a first transition guide 1529 may be positioned or defined between two second transition guides 1530. Each of the transition guides 1528 may be parallel with adjacent transition guides 1528. The transition guides 1528 may include an angled end 1534 at the top of the transition guides 1528. The angled ends 1528 may slope from downward across a width of the guides 1528. Each of the angled ends 1534 may be oriented in the same direction. In one example, the angled ends 1534 may slope downward in a clockwise direction.

The base portion 1520 may define one or more detent apertures 1538, such as positioned above the transition guides 1528. The detent apertures 1528 may extend through the tube portion 1522 to the inner aperture 1524. The base portion 1520 may include one or more actuating or movable features 1540, such as detents, bearings, pins, balls, or the like. The actuating features or movable detents 1540 may be positioned at least partially in the receiving or detent apertures 1538. In some examples, the base portion 1520 includes a connection flange 1542. The connection flange 1542 may extend outward from the bottom of the base portion 1520.

The receiver assembly 1505 may include a thruster feature 1550 or actuator. The thruster feature 1550 may be a cylindrical or tubular feature. For example, the thruster feature 1550 may be an actuator, shaft, plunger, lift, or the like. The thruster feature 1550 may include one or more sliding features or rails 1552 extending outward along an exterior of the thruster feature 1550. The rails 1552 may extend along a length of height of the thruster feature 1550. The rails 1552 may extend relatively or approximately straight. The rails 1552 may be relatively thin in comparison to their length. In some examples, the rails 1552 may include a stop feature 1553. The stop feature 1553 may be a portion of the rail 1552 having a greater width than the rails 1152. The stop features 1553 may extend further outward relative to the rest of the rail 1552, such as towards one another between adjacent rails 1552. For example, the stop feature 1553 may be an outward extending flange, buttress, projection, or the like. In one example, the rails 1552 are “t” shaped.

The thruster 1550 may include one or more teeth 1555 positioned around at least a portion of the bottom of the thruster 1550. The teeth 1555 may be or otherwise define sloping or angled features. For example, the teeth 1555 may be ridges, flanges, notches, detents, or the like. The teeth 1555 may be discretely spaced features or portions of a single feature. Each cam engagement feature 1555 may define sloped surfaces 1556 extending in at least two different directions. For example, a first sloped surface 1556A sloping in a first direction and a second sloped surface 1556B extending in a second sloped direction transverse or away from the first direction. The two sloped surfaces 1556A, 1556B may have similar or different lengths or orientations.

A thruster aperture 1557 may be defined through the height of the thruster 1550. The thruster aperture 1557 may be generally smooth. In some examples, the aperture 1557 may be wider at a bottom portion and define inner shoulders or a shelf 1559.

The receiver assembly 1505 may include a lock cam 1560. The lock cam 1560 may be a cylindrical or barrel shaped feature. The lock cam 1560 may have a top or upper rim 1562 extending about a cam aperture 1564. The cam aperture 1564 may extend through the height of the lock cam 1560. An interior surface 1566 of the lock cam 1560 may define the cam aperture 1564. The lock cam 1560 may define one or more cam tabs 1568 extending inward from the interior surface 1566. The cam tabs 1568 may include sloped, rounded, or angled features. For example, the cam tabs 1568 may define angled or sloped portions 1569 a bottom side. The cam tabs 1568 or the sloped or angled surface 1569 may correspond to the sloped surface 1556 of the thruster 1550. The cam tabs 1568 may be positioned adjacent the upper rim 1562. In some examples, the tops of the cam tabs 1568 may be a portion of or define the upper rim 1562. The cam tabs 1568 may be spaced about the cam aperture 1564.

One or more guide flanges 1572 may extend inward from the interior surface 1566 of the lock cam 1560. The guide flanges 1572 may extend along a portion of the height of the interior surface 1566. The guide flanges 1572 may be discrete features spaced about the cam aperture 1564 or extensions of a single feature. The guide flanges 1572 may include a lower portion 1574. The lower portion 1574 may extend along a greater length or to a greater depth 1574 of the aperture 1564 (e.g., from the upper rim 1562). The lower portion 1574 may terminate in a lower angled feature 1575. The lower angle feature 1575 may be a sloped or angled end of the lower portion 1574. The guide flanges 1572 may optionally include an upper portion 1574. The upper portion 1574 may be adjacent or spaced to a side of the lower portion 1574. The upper portion 1574 may define an upper angled feature 1579. The upper angled feature 1579 or the upper portion 1574 may be spaced upward of the lower portion 1564. The upper angled feature 1579 may extend to a side of the lower portion 1574. The upper angled feature 1579 and the lower angled feature 1575 may slope in a similar or same direction. For example, the angled features 1575, 1579 may extend downward and counter-clockwise.

In an assembled configuration of the receiver assembly 1505, the base portion 1520, thruster feature 1550, and the lock cam 1560 may be slidably positioned within the aperture 1512 of the casing 1510. The thruster 1550 may additionally be at least partially positioned within the lock cam 1560. A portion of the base portion 1520 may be at least partially positioned within the lock cam 1560.

With reference to the base portion 1520 and the casing 1510, the base portion 1520 and the casing 1510 may be fixedly connected. For example, the base flange 1518 of the casing 1510 may be positioned in contact with the connection flange 1542 of the base portion 1520. The base flange 1518 and the connection flange 1542 may be connected or coupled by one or more fasteners, adhesives, or the like. The casing 1510 and the base portion 1520 may be further connected to the retraction assembly 500, such as in the fin 120, or otherwise to the primary aerial vehicle 102. When connected, the inner aperture 1512 of the casing 1510 and the aperture 1524 of the base portion 1520 may be aligned so as to define a single volume. In some examples, one or more electrical connectors or nodes 1598 may be positioned at or extending from the bottom of the base portion 1520.

With reference to the thruster feature 1550 and the casing 1510, the thruster feature 1550 may be slidably positioned within the casing aperture 1512. The rails 1552 may be positioned in the interior channels 1516. The interior channels 1516 may constrain the rails 1552 such that the thruster feature 1550 moves linearly within the casing aperture 1512. The stop feature 1553 may be wider or oriented transverse to a portion of the interior channel 1516. As the thruster 1550 moves within the casing 1510, the stop feature 1553 may provide a limit or cap a range of motion of the thruster 1550 in at least one direction. For example, the interior shoulder 1514 may contact the stop feature 1553 to limit an upward movement of the thruster 1550.

With reference to the thruster feature 1550 and the lock cam 1560, the thruster feature 1550 may extend through the cam aperture 1564. In some configurations, the teeth 1555 of the thruster 1550 may be in contact with the cam tabs 1568 of the lock cam 1560.

With reference to the lock cam 1560 and the base portion 1520, the lock cam 1560 may receive the base portion 1520 in the lock cam aperture 1564. For example, at least the tube portion 1522 may be received in the lock cam aperture 1564. The lock cam 1560 may be slidably or rotationally engaged with the base portion 1520. The connection flange 1542 may limit a lower distance of travel by the lock cam 1560. In some examples, a portion of the guide flange 1572 may be in contact or engaged with the transition guides 1528. For example, in an initial or unretracted configuration, as may be depicted in FIG. 19A, the lower portion 1574 of the guide flange 1572 may be positioned in a gap 1532 between the shorter first guide 1529 and a taller second guide 1530. In such a configuration, the upper portion 1578 may be positioned above or in contact with the angled end 1534 of the first guide 1529.

The retraction assembly 1505 may include a biasing element 1590. The biasing element 1590 may be a spring or similar feature. The biasing element 1590 may contact the upper rim 1562 of the lock cam 1560 and the casing 1510. For example, the biasing element 1590 may be in contact with the interior shoulder 1514 of the casing 1510. The biasing element 1590 may apply a force or bias the lock cam 1560 towards or against the base portion 1520. As a result, the biasing element 1590 may promote contact between the guide flanges 1572 and the transition guides 1572. The biasing element 1590 may promote contact between the cam tabs 1568 or lock cam 1560 and the teeth 1555 or the thruster 1550.

When assembled, only the lock cam 1560 of the retraction assembly 1560 may be allowed to rotate. Each of the other components of the retraction assembly 1505 may not move rotationally relative to the other components, or may be limited to translational movement.

With reference to FIGS. 19A-191 , the tether assembly 1400 may be selectively and slidably received by the retraction assembly 1505 to selectively lock or couple the secondary vehicle 200 with the primary vehicle 102. For example, the tether 150 may extend through the retraction assembly 1505 to the winch 550.

FIG. 19A depicts a cross section of an example unlocked and returning configuration of the tether assembly 1400 and the receiver assembly 1505. In this configuration, the winch 500 may be retracting the tether 150. The plunger 1440 may at least partially slidably extend into the apertures of the retraction assembly 1505 components. For example, the upper or shaft portion 1442 may extend through the base aperture 1524 to within the thruster aperture 1550. The tether 150, not shown, may be operatively connected to or extend from the plunger 1440. Changes in tension on the tether 150 may be imparted to or move the plunger 1440 upward or downward.

FIGS. 19B and 19C depict an example semi-locking phase of the interaction between the tether assembly 1400 and the receiver assembly 1505. As the winch 500 retracts the tether 150, the plunger 1440 may continue to move upward. For example, the plunger 1440 continues to contact the thruster 1550 to direct the thruster 1550 upwards. At contact, the flanges 1444 may contact the shelf 1559. As the thruster 1550 moves upward, the thruster 1550 may lift the lock cam 1560 upward. For example, the teeth 1555 and the cam tabs 1568 may be in contact. The casing 1510 may constrain the position of the thruster 1550 and the base portion 1520 may constrain the position of the lock cam 1560 such that the cam tabs 1568 and the teeth 1555 are at least slightly offset. For example, the contact may be between only a portion of the angled surfaces 1556 of the thruster 1550 and a portion of the angled surface 1569 of the cam tabs 1568. The movement of the lock cam 1560 may also compress the biasing element 1590. The lock cam 1560 may only move translationally. The engagement of the guide flanges 1572 and the transition guides 1528 may prevent initial rotation of the lock cam 1560. For example, the lower portion 1574 of the guide flanges 1572 may translate along the transition guides 1528, such as the second guide 1530.

As the plunger 1440 moves upward, the tower 1420 may be received in the base portion 1520. For example, the shoulders 1424 may move through the base aperture 1524 to contact the movable detent 1540. The shoulders 1424 may force the movable detent 1540 outward to contact the lock cam 1560. The dimensions of the components may be such that the movable detent 1540 further prevents or resists rotation of the lock cam 1560.

FIGS. 19D and 19E depict an example of another step of the semi-locking phase. The movement of the plunger 1440 may continue to move the thruster 1540 and lock cam 1560 upward. As the lock cam 1560 moves upward, the guide flanges 1572 may translate along the transition guides 1528. For example, the guide flanges 1572 may translate until the lower angled feature 1575 is above or in contact with the angled end 1534 of a second guide 1530. In this configuration, the bottom of the lock cam 1560 may also clear the movable detent 1540. By clearing the movable detent 1540, the detent 1540 may extend outward a sufficient distance for the shoulders 1424, or tower 1430, to clear the detent 1540. After the shoulders 1424 clear the detent 1540, the tower 1430 may be positioned such that the channel 1422 is positioned adjacent or inward of the movable detents 1540. The movable detents 1540 may bias or be moved inward to be received in the channel 1422.

FIGS. 19F and 19G depict an example of another step of the semi-locking phase. After the detent 1540 is received in the channel 1422, or the guide flanges 1572 clear the transition guides 1528, tension on the tether 150 may be reduced or released and the biasing element 1590 or gravity may direct the lock cam 1560 downward. The movable detent 1540 may secure the tower 1430 within the base portion 1520. For example, the tower 1430 may remain stationary.

As tension is released in the tether 150, the plunger 1440 may move downward within the tower 1420. As the plunger 1440 moves downward, the thruster 1550 and lock cam 1560 may also move downward.

After the guide flanges 1572 clear the transition guides, the lock cam 1560 may be rotatable. The lock cam 1560 may begin to twist or rotate to a lock configuration as the lock cam 1560 moves downward. The offset contact of the teeth 1555 and the cam tabs 1568 may bias the lock cam 1560 to rotate. For example, the cam tab 1568 teeth 1569 may travel along the sloped surfaces 1556 to rotate the lock cam 1560. The initially offset position of the teeth 1569 relative to the sloped surfaces 1556 may impart an initial bias to rotate the lock cam 1560. In some examples, the corresponding sloped surfaces of the guide flanges 1572 and the transition guides 1528 may bias the lock cam 1560 to rotate. For example, the lower angled feature 1578 of the lower portion 1574 may move along the angled end 1534 of the taller second guide 1530. As the lock cam 1560 moves downward, the lock cam 1560 may move over the movable detent 1540. With the lock cam 1560 over the movable detent 1540, the movable detent 1540 may be constrained to the channel 1422 thereby locking the tether assembly 1400 with the receiver assembly 1505. In some examples, a portion of the guide flange 1572, such as the upper portion 1578 may cover the movable detent 1540 to further limit movement of the detent 1540.

FIGS. 19H and 19I depict an example of the receiver assembly 1505 and the tether assembly 1400 in a locked configuration. To reach the locked configuration, the lock cam 1560 may continue to rotate such that the guide flanges 1572 are positioned above or in a gap 1532 between the transition guides 1528. In some examples, the lower portion 1574 of the guide flange 1572 may be positioned in a gap 1538 and the upper portion 1578 may be in contact with the second taller transition guide 1530. As a result, the lock cam 1560 may be unable to rotate or move further downward. The biasing element 1590 may prevent the lock cam 1560 from moving upward without tension being applied to the tether 150. Accordingly, tension may be removed from the tether 150 and the tether assembly 1400 may remain captured or connected to the receiver assembly 1505.

To unlock the tether assembly 1400 and the receiver assembly 1505 the steps may be repeated. In repeating the steps, the lower portion 1574 of the guide flange 1572 may instead contact the first shorter transition guide 1529. The guide flange 1572 and the transition guides 1529 may provide a spacing for the movable detent 1540 to move outward and past the shoulders 1424 for the tether assembly 1400 to exit the receiver assembly 1505.

In some examples, when the tether assembly 1400 is in the locked configuration the tether base 1470 may be in contact with a portion of the receiver assembly 1505. For example, the electrical contacts 1474 may be in contact with the electrical elements or nodes 1598 to form a circuit between the primary 102 and the secondary vehicle 200. The fins 1476 may be in contact with a corresponding receiving feature, such as an indent or recess, to prevent or limit rotation of the secondary vehicle 200 or tether assembly 1400 while locked.

### Propulsion Assembly and Duct Configuration

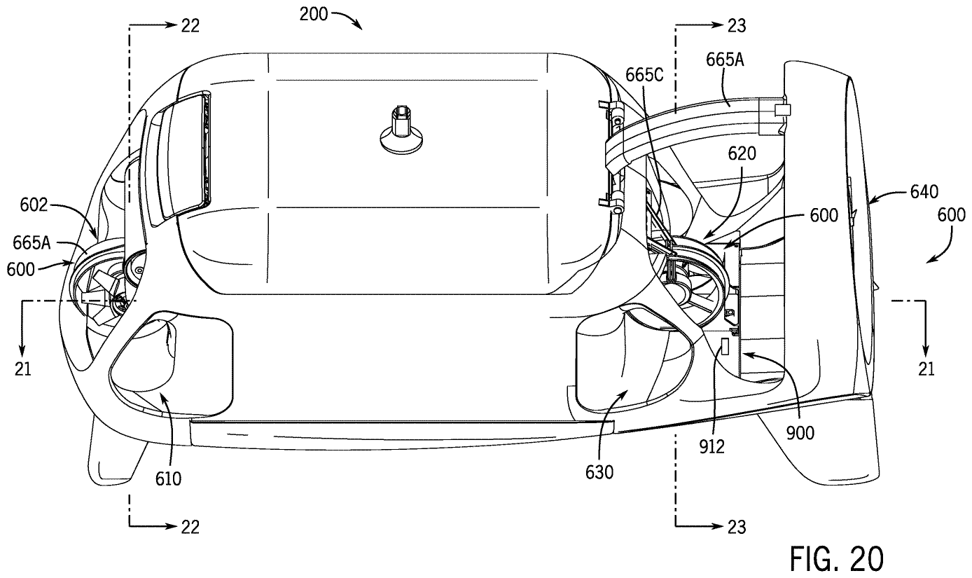

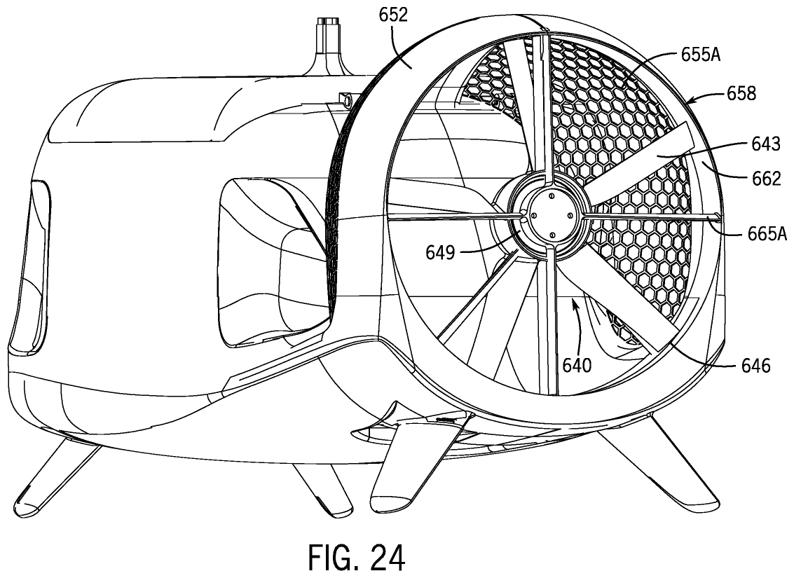

With reference to FIGS. 20-25, the secondary aerial vehicle 200 may include a propulsion assembly 600 to provide control or movement of the secondary aerial vehicle 200 relative to the primary aerial vehicle 102 during deployment. The assemblies generate thrust allow the secondary aerial vehicle 200 to move in two or more directions. For example, the propulsion assemblies 600 may include one or more propulsion units or thrusters. The propulsion units may be positioned in ducts or openings extending between surfaces of the aerial vehicle 200. The propulsion assembly 600 may optionally be arranged or operated to reduce the noise, or intrusiveness of noise, generated by the secondary aerial vehicle 200. The assemblies may generate thrust in more than one direction simultaneously. In one example, one or more of the assemblies are bidirectional thrusters. While description is given with reference to aerial vehicles, it is appreciated the features or devices of the payload release assembly 600 may be utilized by a variety of other devices or vehicles for selectively generating thrust, such as aquatic vehicles. It should be noted that the propulsion assembly 600 may be configured to generate movement in any direction, this allows the secondary aerial vehicle 200 to reposition itself or correct against wind forces without having to rotate around the tether 150 or spin. For example, the secondary aerial vehicle 200 can be configured to move laterally, e.g., side to side, and front to back, without having to rotate along an axis. This helps to stabilize the vehicle 200 in all conditions and help protect the payload 175 from unnecessary centrifugal forces during delivery.

The secondary aerial vehicle 200 may include a rear propulsion assembly 640. The rear propulsion assembly 640 may provide forward or rearward thrust relative to the secondary aerial vehicle 200. In some examples, the rear propulsion assembly 640 may be preferentially configured to generate a particular force vector, such as a forward thrust vector, a rearward thrust vector, or an angled thrust vector. The rear propulsion assembly 640 may be located to one side of the secondary vehicle 200 relative to the center of gravity. For example, the rear propulsion assembly 640 may be located at or towards the rear 234 of the secondary vehicle 200 or rearward relative to the center of gravity.

A housing 652 may extend from or be positioned at the rear 234 of the secondary aerial vehicle 200. To promote aerodynamics, the housing 652 may have a rounded or convex exterior. A debris guard 655 may be a portion of the housing 652 that allows air into the rear duct 658 but prevents objects above a certain size from entering the rear duct 658. The debris guard 655 may be a screen, bar, mesh, honeycomb, or similar structure to block or limit the passage of debris or foreign objects from contacting the propellers 643. The debris screen 655 may be a single feature or two or more portions coupled together. For example, the debris screen 655 may include a right portion and a left portion coupled along an attachment section 657. The attachment section 657 may be a flange, beam, or other feature either defined by one of the portions or coupled to the right and left portions. In one example of the debris screen 655A, the debris screen 655a may have a rounded or curved cross section from the top of the duct 658 to the body 210, 211. In another example, the debris screen 655B, the debris screen 655B may have a linear or relatively straight cross section from the top of the duct 658 to the body 210, 211. The debris screen 655 may be a rigid or structural material such as a polymer, carbon fiber, or foam. The debris screen 655 may be attached to or overmolded with the body 210, 211.

The rear duct 658 may be formed in or by the housing 652 and define an aperture or passage to receive or expel air. The rear duct 658 may be generally circular or hoop shaped. The rear duct 658 may be connected to the debris screen 655. In some examples, the debris screen 655 provides support or assists in maintaining the shape of the rear duct 658. The support of the debris screen 658 may allow for a thinner or smaller duct 658. In one example, the interior 662 of the rear duct 658 may taper from a wider diameter at a location forward relative to the motor 649 or propellers 643 to a narrower diameter at a location at or to the rear of the motor 649 or propellers 643. The taper may promote compressing intake air or increasing a velocity of the exhaust air relative to air surrounding the secondary aerial vehicle 200 and/or to reduce noise generated by the rear thruster 640. In some examples, the rear duct 658 may be at least partially covered by a portion of the debris screen 655. The debris screen 655 may assist in preventing contact by people or objects with the propellers 643. In some examples of the debris screen 655, the debris screen 655 may define an exit vent or larger spacing between features of the debris screen 655. In one example, the exit vent may be defined at or adjacent the bottom of the rear duct 658. The exit vent may allow for debris that enters through the debris screen 655 to exit the housing 652.

A motor 649 may be coupled to the housing 652 or duct 658 by one or more structural elements 665A. In some examples, electrical cables or features may extend along the structural elements 665A to the motor 649. In one example, the motor 649 is positioned at or near the center of the duct 658. The motor 649 may have a rounded exterior surface to reduce drag or to promote airflow around or over the motor 652.

One or more propellers 643, or blades or airfoils, may attach to or extend from the motor 649. The one or more propellers 643 may define a helical curvature along a portion of their length. In some examples, the propellers 643 may be configured for slower airflow conditions. For example, the debris screen 655 may limit airflow to the propellers 643. The propellers 643 may include a tip 646 at an end of the propeller 643 spaced from the motor 649. In some examples, the tips 646 may be shaped to match the interior 662 of the duct 658. For example, the forward side of a tip 646 may extend further from the motor 649 relative to the rearward side of the tip 646. In some examples, the propellers 643 may include turbulent features 647 to reduce noise or generate less disruptive noise. The turbulent features 647 may be raised features, recesses, chevrons, or gaps in the leading or trailing edges of the propellers 643. The turbulent features 647 may disrupt or generate turbulent airflow to reduce noise or generate dispersed noise that may be less disruptive. In some examples, the propellers 643 may be equally spaced or variably spaced. For example, the propellers 643 may be spaced about the motor 649 by at least two different distances. Variable spaced propellers 643 may assist in reducing noise or generating less disruptive or cyclical noise.

In operation, the rear propulsion assembly 640 may provide rearward or forward thrust for the secondary aerial vehicle 200. The motor 649 may rotate the propellers 643 in a first direction to generate forward thrust and a second direction, different from the first direction, to generate rearward thrust. The shape of the housing 652 or propellers 643 may be shaped to promote the generation of thrust. For example, the housing 652 or propellers 643 may be shaped to intake air from the front and expel air rearward with reduced drag as compared to the generation of thrust for rearward movement. The shape may result in improved efficiency of the propulsion assembly 640. The motor 649 or rear propulsion assembly 640 may be oriented at an angle relative to the orientation of the secondary aerial vehicle 200, tether 150, or primary aerial vehicle 102. For example, the motor 649 may be oriented downward relative to the secondary aerial vehicle 200. The downward orientation of the motor 649 may assist in orienting the convex bottom 223 of the secondary aerial vehicle 200 with the front 232 upward to a planing orientation. The planing orientation may reduce drag or increase control of the secondary aerial vehicle 200. In one example, the rear propulsion assembly 640 is oriented parallel with the bottom 223 of the secondary aerial vehicle 200 adjacent the propulsion assembly 640. The rear propulsion assembly 640 may include associated actuators to change the angle of the thrust vector to provide additional options for controlling the secondary aerial vehicle 200.

The size of the rear propulsion assembly 640 relative to the size of the secondary aerial vehicle 200 may promote efficient generation of thrust or a reduced or more tolerable sound at operation. For example, the diameter of the rear propulsion assembly 640 may be comparatively large relative to the size of the secondary aerial vehicle 200 or for the thrust required. The increased size may require fewer rotations of the propellers 643 or motor 649 for a comparable amount of thrust as may be generated by a smaller motor. The reduced rotations may require less energy for the same generation of thrust. The reduced rotations may also result in a noise output at a lower frequency or amplitude relative to a smaller or faster rotating motor. A lower frequency or amplitude of sound is less disruptive to human ears.

The propulsion assemblies 600 may include horizontal or side thruster assemblies 602, 620. The horizontal thruster assemblies 602, 620 may be a fore thruster assembly 602 or an aft thruster assembly 620 located to the fore or aft, respectfully, of the payload bay 242. For example, the fore thruster assembly 602 may be located towards the front or the fore of the secondary vehicle 200 relative the center of gravity. The aft thruster assembly 640 may be located towards the aft or rear of the secondary vehicle 200 relative the center of gravity. The fore 602 or aft 620 thruster assemblies may be oriented to generate rightward or leftward thrust relative to the secondary aerial vehicle 200. In some examples, the fore 602 or aft 620 thruster assemblies may be oriented to additionally, or alternatively, provide rearward or forward thrust.

In some examples, the fore thruster assembly 602 may be spaced towards a second side relative to the center of gravity, which may be opposite or generally away from the aft thruster assembly 640. For example, a portion of the fore thruster assembly 602 may be oriented or positioned towards the right side 229 of the secondary vehicle 200. A portion of the aft thrust assembly 620 may be correspondingly oriented or positioned towards the left side 226 of the secondary vehicle 200. The positioning of the fore 602 or aft 620 thrust assemblies may to assist in balancing the secondary aerial vehicle 200 or positioning of the center of gravity at or near the geometric center of the secondary aerial vehicle 200.

The fore thrust assembly 602 may be located in or in fluid communication with a fore duct 610. The fore thrust assembly 602 may include or be attached to the secondary aerial vehicle 200 by one or more structural elements 665B. The fore thrust assembly 602 may include a motor 605 and one or more rotors 608. The one or more rotors 608 may attach to or extend from the motor 605. The rotors 608 may be shaped for bidirectional generation of thrust (e.g. generate thrust regardless of rotation direction about the motor 605). The rotors 608 may have a foil shape or profile. In some examples, the rotors 608 have a helical shape to promote the generation of thrust. In some examples, all or a portion of the fore thrust assembly 602 may be oriented towards a side of the secondary aerial vehicle 200 within the fore duct 610. For example, the motor 605 may be oriented towards a side of the fore duct 610 and the rotors 608 may be at or near the middle 615 of fore duct 610. In one example, the fore motor 605 is positioned rightward relative to the center of the fore duct 610 and the rotors 608 are positioned at or near the middle of the fore duct 610.

The aft thrust assembly 620 may be located in or in fluid communication with an aft duct 630. The aft thrust assembly 620 may include or be attached to the secondary aerial vehicle 200 by one or more structural elements 665C. The aft thrust assembly 620 may include a motor 625 and one or more rotors 628. The one or more rotors 628 may be attached to or extend from the motor 625. The rotors 628 may be shaped for bidirectional generation of thrust (e.g. generate thrust regardless of rotation direction about the motor 625). The rotors 628 may have a foil shape or profile. In some examples, the rotors 628 have a helical shape to promote the generation of thrust. In some examples, the aft thrust assembly 620 may have a similar orientation or construction to the fore thrust assembly 602. The aft thrust assembly 620 may be oriented to a second or different side from the fore thrust assembly 602. In one example, the aft motor is positioned leftward relative to the center of the aft duct 630 and the rotors 628 are positioned at or near the middle of the aft duct 630.

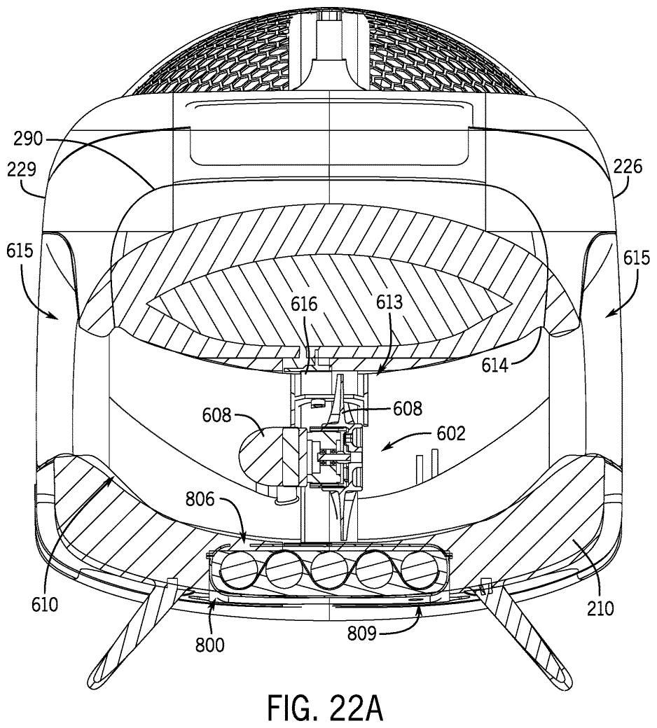

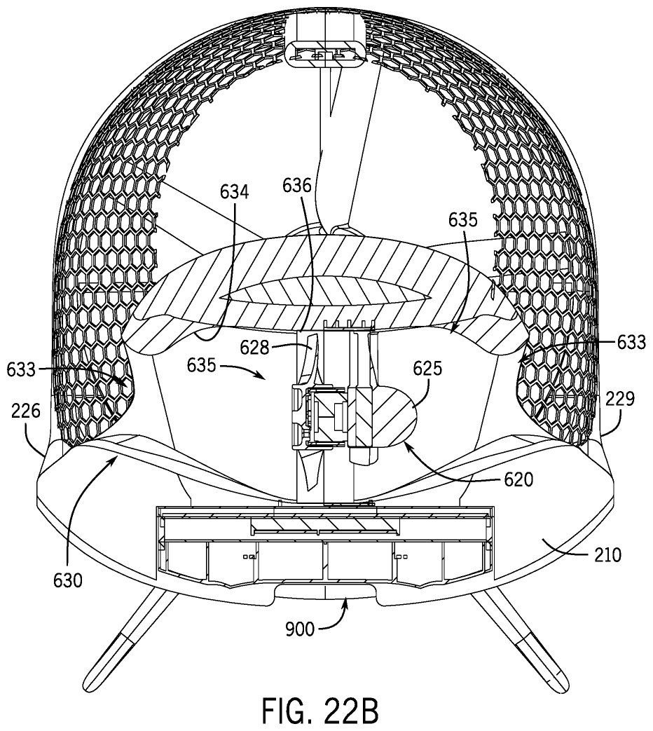

The fore duct 610 or aft duct 630 may be defined by apertures extending through the body 210 of the secondary aerial vehicle 200. In one example, the fore 610 and aft ducts 630 extend between right side 229 of the secondary aerial vehicle 200 and the left side 226 of the secondary aerial vehicle 200. The fore duct 610 or aft duct 620 may define one or more entrance and exhaust, opening, or outer areas or regions 613, 633 and a central, center, or inner areas or regions 615, 635. In some examples the fore duct 610 or aft duct 620 may include a debris guard or duct cover 638 to prevent debris or objects from entering the ducts 610, 620. The debris guard 638 may be a screen, bar, mesh, honeycomb, or similar structure to block or limit the passage of debris or prevent other foreign objects from contacting the propellers 643. The fore duct 610 or aft duct 620 may be symmetrical relative to a center line 670 extending from the front 232 of the secondary aerial vehicle 200 to the rear 234 of the secondary aerial vehicle 200. As may be shown in FIGS. 22A and 22B, the entrance regions 613, 633 may have a first cross sectional width or height dimension and the inner regions 615, 635 may have a second, different, cross sectional width or height dimension. The entrance or exhaust regions 613, 633 may have the same dimensions. The dimension of the inner regions 615, 635 may be greater than the dimension of the entrance region 613, 633. The change in height across the width of the secondary aerial vehicle 200 may facilitate the intake of air or the propulsion of air from the fore duct 610 or aft duct 630. A symmetrical shape of the fore 610 or aft duct 630 may facilitate the bidirectional generation of thrust by the fore thruster assembly 602 or the aft thruster assembly 620. In some examples, the fore duct 610 and the aft duct 630 may have the same dimensions or one of the fore duct 610 or aft duct 630 may have a larger or smaller dimension.

In some examples, the fore duct 610 may define an entrance concavity 614. The entrance concavity 614 may be a recess or depression in a wall of the duct 610. The entrance concavity 614 may be located in one or both of the entrance or outer regions 613 of the fore duct 610. The entrance concavity 614 may act to reduce or absorb sound generated by the fore thruster 602 during operation. The fore duct 610 may include a rotor recess 616. The rotor recess 616 may be a recess or depression in a wall of the fore duct 610 around the rotors 608. Accordingly, the diameter of the duct 602 may be larger at the rotor recess 616. The rotor recess 616 may reduce an amount of noise generated by the fore thruster 602 or transmitted out of the duct 610 during operation. The rotor recess 616 may also allow for the use of larger propellers or rotors 628 (e.g. longer or wider) to increase the amount of thrust generated. The aft duct 630 may also include an entrance concavity 634 or a rotor recess 636, redundant explanation of which is omitted.

The fore thruster assembly 602 may be located in the central or inner region 615 of the fore duct 610. The fore thruster assembly 602 may be positioned to one side of the inner region 615, such as towards an opening 613 or side of the aerial vehicle 200. The aft thruster assembly 620 may be located in the central or inner region 635 of the fore duct 630. The fore thruster assembly 620 may be positioned to one side of the inner region 635, such as towards an opening 633 or a side of the aerial vehicle 200.

In some examples, the fore thruster assembly 602 is arranged for low wind or low thrust generation and the aft thruster assembly 620 is arranged for high wind or high thrust generation. In other examples, the reverse may be true. In low wind conditions, a lesser amount of thrust may be needed to stabilize or move the secondary aerial vehicle 200 to the delivery location. For such uses, a thruster that produces less thrust and less noise may be better equipped for operation. For example, during low wind conditions a noise generated by a thruster may be more noticeable to a bystander. During high wind, more thrust may be necessary to control or stabilize the secondary aerial vehicle 200. Additionally, during high wind, other environmental noises or the wind itself may hide or reduce the perceptibility of noise generated by a thruster. In this manner, the thruster that generates more thrust but more noise may be utilized during higher wind conditions to provide reliable control of the secondary aerial vehicle 200 without a perceptible increase in noise.

The shape of the body 210 of the secondary aerial vehicle 200 and the shape or position of the fore 610 or aft ducts 630 may correspond to reduce flow separation to promote air intake or exhaust from the fore 602 or aft thrust assemblies 620. During forward or rearward motion of the secondary aerial vehicle 200, the body 210 of the secondary aerial vehicle 200 may be shaped such that air flows around the body 210 of the secondary aerial vehicle 200. In some examples, the shape of the fore 601 or aft ducts 631 may extend approximately linearly or with reduced curves to promote the flow of air or fluid through the ducts 601, 631. For example, a horizontal or linear shaped duct 601, 631 may reduce pressure or drag forces resulting from air movement through the ducts 601, 631.

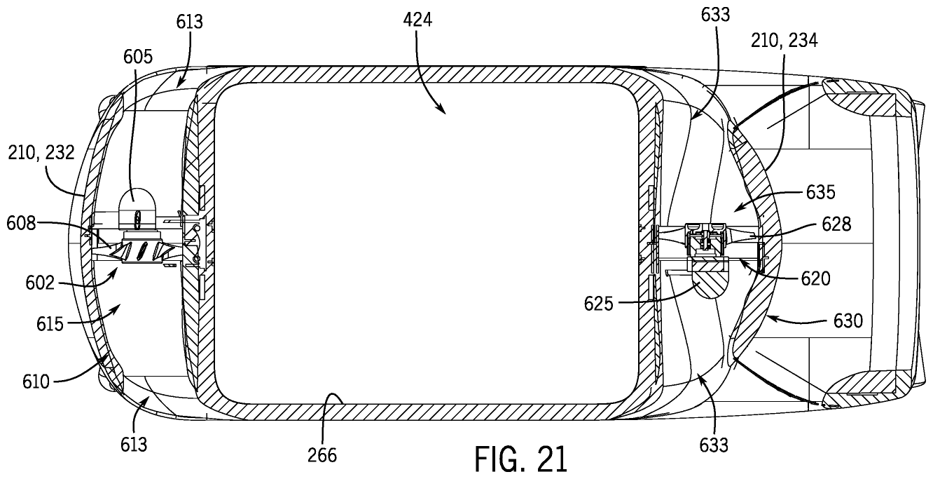

With reference to a curved duct, as exemplified in FIG. 21, the entrance region 613, 633 of the fore 602 or aft duct 630 may be shaped to correspond with the exterior surface of the body 210. For example, the fore duct 610 may curve or define an angled orientation relative to the rest of the duct 610 along a portion of the entrance region 613. The angled orientation may correspond with the exterior of the front 232 of the body 210. The aft duct 630 may curve or define an angled orientation relative to the rest of the aft duct 630 along a portion of the entrance region 633. The angled orientation may correspond with the exterior of the rear 234 of the body 210. The corresponding shape of the body 210 and the entrance regions 613, 633 of the fore 610 or aft ducts 630 may assist in reducing flow separation during intake or ejection of air from the fore duct 610 or aft duct 630. By limiting flow separation, the fore thruster assembly 602 or rear thruster assembly 620 may generate thrust more efficiently for a given amount of power or more consistently in a variety of wind conditions. Limiting flow separation may assist in instantaneous thrust generation or control of the secondary aerial vehicle 200. In contrast, in the event of flow separation (e.g. turbulent air), the amount of air that may be pulled in or expelled from the fore thruster assembly or aft thruster assembly may vary to a greater degree and the thrust or movement of the secondary aerial vehicle 200 may be less consistent for a given input by the fore motor 605 or aft motor 625.

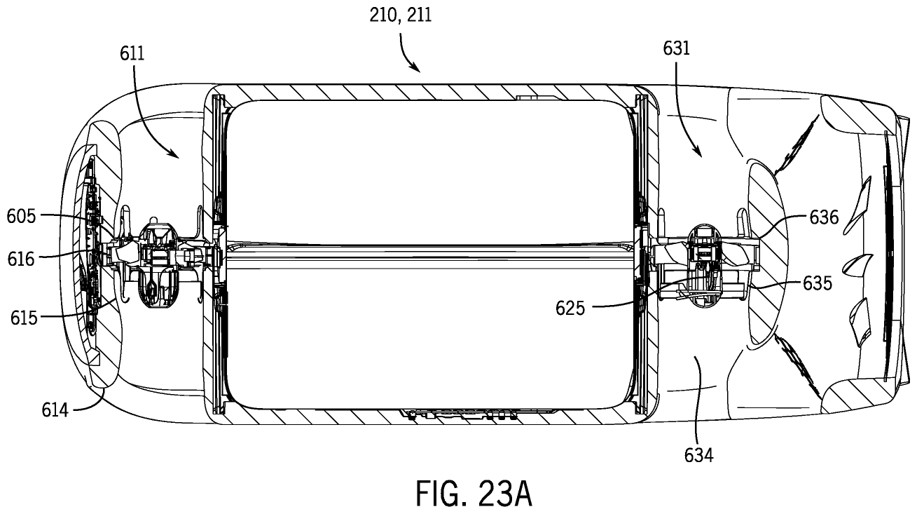

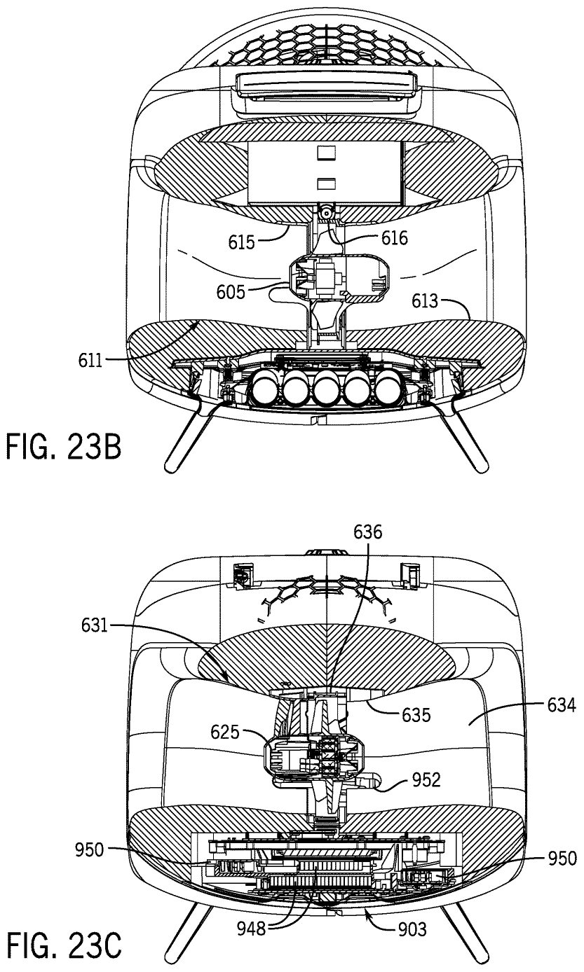

In another example, as may be depicted in FIGS. 23A-23C, the body 210, 211 may define a second configuration of the fore duct 611 or aft duct 631. The fore duct 611 or aft duct 631 may be configured to have wide or flared intakes or outlets. The fore duct 611 or the aft duct 631 may be configured to extend generally horizontally through the width of the body 210, 211. The wider or flared entrances 614, 634 may assist in the intake or expelling larger volumes of air for thrust generated by the fore or after motors 605, 625. The generally horizontal or linear arranged fore duct 611 or aft duct 631 may similarly assist in the intake or expelling larger volumes of air for thrust, or reduce a resistance to the flow of air. For example, a more linearly oriented duct 611, 631, as compared to a curved duct, may result in less resistance during airflow because of, at least in part, one or more of lower friction, reduced pressure, and reduced centrifugal forces that would otherwise result from curvature of the duct.

The fore duct 611 may include an entrance region 614 and an inner or motor region 615. A fore motor 605 may be positioned in the interior region 615. In some examples, the fore duct 611 defines a step, indent, or channel 616 at the interior region having a wider diameter than the surrounding interior region 615. The step 616 defines space for larger propellers or rotors to increase the amount of thrust that may be generated by the motor 605. In some examples, the fore duct entrance region 614 may define flared openings (e.g. inlets or outlets). The flared openings may be defined by portions of the entrance region 614 extending outward (e.g. forward, rearward, upward, or downward) relative to the duct 611. The flared opening may provide an increased cross sectional volume of fore duct 611 at the exterior of the body 210, 211. The larger volume of the fore duct 611 at the entrance region 614 may assist in drawing larger volumes of air to generate an increase in thrust.

Similarly, the aft duct 631 may have an entrance region 634. The aft duct 631 may be taller at the entrance region 634 than the inner region 635. The aft duct 631 may have a largest height dimension at the entrance regions 634 resulting in an increased volume. The larger volume of the aft duct 631 may assist in drawing larger volumes of air to improve or assist in the generation of thrust. An aft motor 625 may be positioned in the interior region 635. In some examples, the aft duct 631 defines a step, indent, or channel 636 at the interior region having a wider diameter than the surrounding interior region 635. The step 636 defines space for larger propellers or rotors to increase the amount of thrust that may be generated by the motor 625.

Similarly, the aft duct 631 may include a flared opening (e.g. inlets or outlets). The flared openings may be defined by portions of the entrance region 634 extending outward (e.g. forward, rearward, upward, or downward) relative to the duct 631. The flared opening may provide an increased cross sectional volume for drawing larger volumes of air to generate an increase in thrust.

The fore motor 605 or aft motor 625 may include variably spaced rotors or propellers 609, 629 as illustrated in FIG. 4B. Variable spacing may be an uneven spacing of at least some of the rotors 609, 629 about the motors 605, 625. For example, the rotors 609, 629 may include a first and second adjacent rotors 609, 629 spaced at a first distance and a third rotor 609, 629 positioned adjacent the first or second rotors 609, 629 and spaced by a second distance different from the first distance. The uneven spacing of the rotors 609, 629 may result in a noise that is less disruptive to a bystander. For example, the uneven spacing may prevent or limit the noise of the rotors 609, 629 from being additive or the generation of cyclical noise, where each may be more noticeable or intrusive.

In operation, the propulsion assembly 600 may enable the secondary aerial vehicle 200 to generate holonomic thrust. For example, the secondary aerial vehicle 200 may generate thrust to move forward, rearward, left, or right relative to the primary aerial vehicle 102. The propulsion assembly 600 may enable the rotation of the secondary aerial vehicle 200 about the tether 150. Thrust may be generated in two or more of the directions simultaneously. By arranging the propulsion assembly 600 to provide thrust in more than one direction simultaneously, the secondary vehicle 200 may move in multiple directions irrespective of an orientation, enabling changes in velocity or direction without first reorienting the vehicle 200. In contrast, a single thruster system or a system requiring separate activation of two or more thrusters would require a secondary vehicle to reorient prior to actuating a desired movement. Time delays caused by reorienting or determining positions necessary for movement may extend delivery time, resulting in both spilled or destroyed payloads and poor delivery experience for the recipient.

To move the secondary aerial vehicle 200 right or left, either or both of the fore thruster assembly 602 or aft thruster assembly 620 may be activated. In one example, both the fore 602 and aft thruster 620 assemblies may generate thrust in a direction away from an intended lateral movement direction (e.g. crabwalk). The amount of thrust generated by either of the fore 602 or aft thruster assemblies 620 may be varied relative to the other to effectuate a rotation of the vehicle 200. Additionally, or alternatively, one of the fore 602 or aft thrust assemblies 620 may generate thrust in a different direction from the other of the fore 602 or aft thrust assemblies 620 to effectuate a rotation of the secondary aerial vehicle 200 about the tether. In some examples, the fore 602 or aft thrust assemblies 620 may generate thrust in bursts or discrete outputs. The discrete generation of thrust may reduce the amount of noise generated by the propulsion assemblies 600 during operation, or the duration of noise created at a location. Forward or rearward thrust may be provided by the rear propulsion assembly 640. The rear propulsion assembly 640 may be reversed to propel the secondary aerial vehicle 200 rearward, or the fore thruster assembly 602 or aft thruster assemblies 620 may be activated to rotate the secondary aerial vehicle 200 such that the delivery location is forward relative to the secondary aerial vehicle 200.

The propulsion assembly 600 may enable precise delivery of a payload 175 to the delivery location even in the event that one of the motors or assemblies is not operational. For example, in the event the rear propulsion assembly 640 becomes nonoperational, the fore 602 or aft thruster assemblies 620 may rotate the secondary aerial vehicle 200 such that the delivery location is located to a side of the secondary aerial vehicle 200. In this orientation, the fore 602 or aft thruster assemblies 620 may laterally translate the secondary aerial vehicle 200 to the delivery location. In the event that one of the fore thruster assemblies 602 or aft thruster assemblies 620 is nonoperational, the other thruster assembly may be bidirectional and may rotate the secondary aerial vehicle 200 such that the rear propulsion assembly may laterally move the secondary aerial vehicle 200 to the delivery location or the secondary aerial vehicle 200 may move in an arcing shape in combination with the assemblies working in unison.

The control provided by the propulsion assembly 600 may create a more stable appearance or allow for stabilization of the secondary vehicle 200. By stabilizing or controlling the secondary vehicle 200, a payload 175 may be protected or kept in a certain orientation for delivery. A more stable or controlled secondary vehicle 200 may also improve a customer delivery experience.

In addition, or alternative to, reducing a sound amplitude or configuring the propulsion assembly 600 to generate a reduced sound frequency, the design of the propellers, motors, or overall ducts of the secondary aerial vehicle 200 may be arranged to produce more pleasant acoustic profiles such as by providing a more consistent sound or minimizing sound distortions, buzzing, or beat frequencies. The motors may be controlled in a manner to reduce unpleasant sounds.

Additionally, the propulsion assembly 600 may optionally cool one or more electrical components of the secondary aerial vehicle 200. For example, the propulsion assemblies 600 may direct airflow from or to the power source 800 or sensor assembly 900 to cool the components. As described below, one or more ducts may extend from the electrical components to the fore duct 610, aft duct 620, or adjacent the rear propulsion assembly 640 such that the operation of the assemblies assists in cooling the electrical components.

### Recovery Assembly

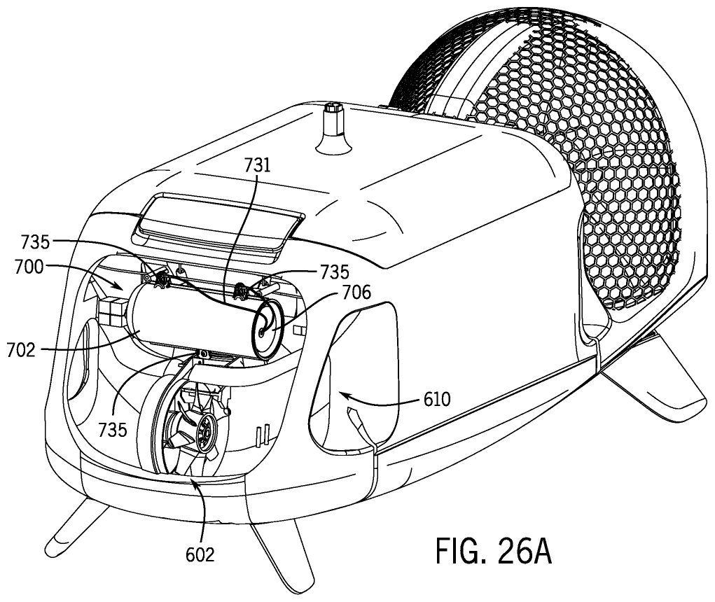

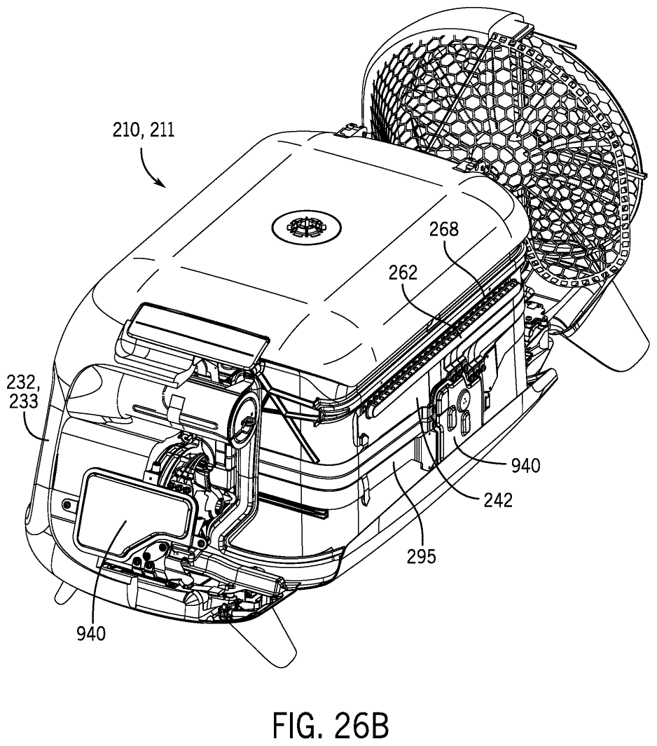

With reference to FIGS. 26A-28, the secondary aerial vehicle 200 may include a recovery assembly 700 to a terminal velocity of the secondary aerial vehicle 200 (e.g., due to a failure of one of the vehicles or mission).

A canister 702 may house components of the recovery assembly 700. The canister 702 may be shaped to assist in ejecting the parachute 725 in a desired direction. For example, the canister 702 may have a cylindrical shape with an aperture 705 at one end extending into the canister 702. The aperture 705 may be covered by a cap 706 to retain the parachute 725 in the canister 702. The side 713 opposite the aperture 705 may be rounded or bell shaped. The canister 702 may define attachment points 735 to connect with the secondary aerial vehicle body 210. The canister 702 may be a rigid material and may provide structural support or integrity to the secondary aerial vehicle 200 as a whole. The canister 702 may be made from a variety of materials including plastic, aluminum, stainless steel, or other materials. In one example, the canister 702 is an injected molded plastic. In some examples, one or more rotatable links 738 may be coupled with the connections 735 to the secondary aerial vehicle 200 with the canister 702. The links 738 may define a spaced attachment point relative to the connection 735.

A parachute 725 may be stored within the canister 702. The parachute may include one or more cables or cords 731 to connect the parachute 725 to the secondary aerial vehicle 200. The parachute cables 731 may be connected to the secondary aerial vehicle 200 at the same or similar locations as the canister 702, such as at connections 735. The parachute cables 731 may be attached to the links 738. The links 738 may space the attachments with the parachute cables 731 from the canister 702 or the connection points 735. The links 738 may allow the cables 731 to attach at the same connection points 735 as the canister 702. By utilizing the same connections 735, the installation of the canister 702 may verify the connection of the parachute 725. The links 738 may also prevent the parachute cables 731 from catching or snagging on the canister 702 and tangling the parachute 725, or to assist in aligning the secondary aerial vehicle 200 under the parachute 725 after deployment of the parachute 725.

The parachute 725 may be wrapped in a sheath or packaging 728 when loaded into the canister 702. The sheath 728 may wrap around all or a portion of the parachute 725. For example, the sheath 728 may extend over a portion of the length of the parachute 725 but not cover either end. In another example, the sheath 728 may cover one or both ends of the parachute 725. The sheath 728 may provide a smoother exit of the parachute 725 from the canister 702 during deployment or prevent damage to the parachute 725 during deployment. After or during deployment, the parachute 725 may shed the sheath 728.

The ejection system 716 may include an actuator, such as a spring-loaded launcher, or an explosive charge 720 and a piston 718. The ejection system 716 may explosively actuate the recovery assembly 700 to eject or deploy the parachute 725. The explosive charge 720 and, or piston 718 may be housed in the canister 702. In one example, the explosive charge 720 and piston 718 are housed between the closed end of the canister 713 and the parachute 725. The piston 702 may be located between the explosive charge 720 and the parachute 725. The piston 718 may be a structure designed to assist in forcing out the parachute 725 during deployment. For example, the piston 718 may contact or push on the parachute 725 during deployment. The piston 718 may also act to promote a uniform ejection of the parachute 725. During deployment, the piston 718 may be ejected with the parachute 725. Accordingly, the piston 718 may be light weight or shaped to have a low terminal velocity. In alternative examples, the piston 718 may be attached to the parachute or secondary aerial vehicle, such as via a tether or the one or more parachute cords 731.

The explosive charge 720 may assist in the rapid deployment of the parachute 725. In one example, the explosive may eject the parachute at up to 30 m/s. Rapid deployment may be necessary to decrease the minimum height above an object that the recovery assembly 700 may slow or control the secondary aerial vehicle 200 during a fall. Additionally, because the canister 702 may be within the body 210 of the secondary aerial vehicle 200, the deployment of the parachute 725 may require a sufficient amount of force to create an opening through or remove a portion of the secondary aerial vehicle body 210 for the parachute 725 to deploy. The explosive charge 720 and, or piston 718 may be selectively activated to trigger deployment of the parachute 725. The bell shaped side 713 of the canister 702 may assist in directing the explosion from the explosive charge 720 towards the cap 706.

To trigger deployment of the parachute 725 a variety of activations are contemplated. Sensors or communication systems on the secondary aerial vehicle 200 or primary aerial vehicle 102 may indicate the recovery system 700 should be activated trigger deployment. For example, a sensor may determine the secondary aerial vehicle 200 is disconnected from the primary aerial vehicle 102 and the recovery assembly 700 needs to be activated. The sensors may also detect a certain acceleration limit was reached indicating a disconnection from the primary aerial vehicle 102 or a collision of an object with the secondary aerial vehicle 200 or the primary aerial vehicle 102. The recovery assembly 700 may be activated remotely in some examples.

### Power Source and Electrical Connections

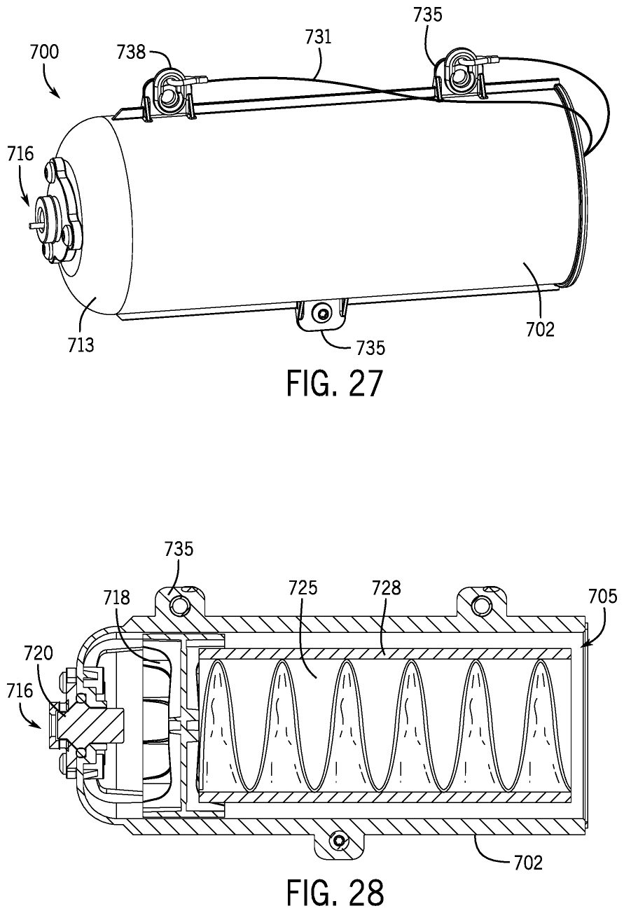

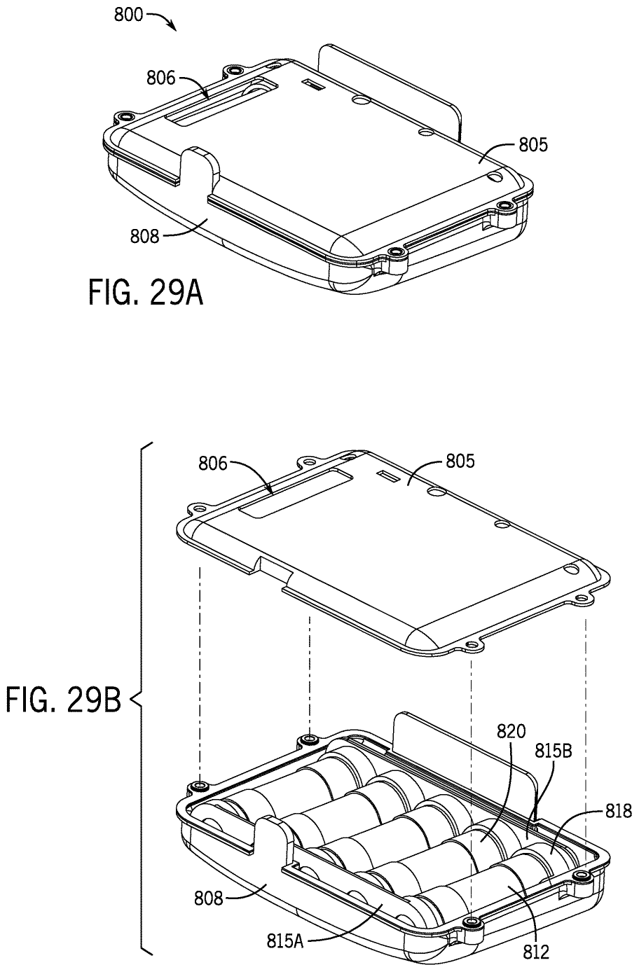

With reference to FIGS. 27-29, the secondary aerial vehicle 200 may include a power source 800 to provide power to the assemblies of the secondary aerial vehicle 200. While description is given with reference to aerial vehicles, it is appreciated the features or components of the power source 800 or flex connectors 950 may be utilized by a variety of other devices or vehicles for providing or transmitting electrical energy.

The power source 800 may be a battery. Electrical cables or connections may extend from the power source 800 to the assemblies of the secondary aerial vehicle. The power source 800 may be removable or exchangeable from the secondary aerial vehicle 200. The power source 800 may also be used to charge or power the primary aerial vehicle 102 in scenarios where the primary aerial vehicle's 102 power source requires additional power capacity and the secondary aerial vehicle 200 is electrically connected with the primary vehicle 102. That is, the secondary aerial vehicle 200 can charge the primary vehicle 102 and vice versa, helping to enable longer missions and reduce overall battery size.

In an example of the power source 800, power housing 802 may include a top cover 805 and a bottom cover 806. The top cover 805 may abut, align with, or define a portion of a bottom of one of the propulsion ducts. The bottom cover 808 may define a portion of the bottom surface 223 of the secondary aerial vehicle 200. Each of the top cover 805 and the bottom cover 808 may include one or more apertures 806, 809.

Apertures 806, 809 may be positioned at opposite ends or sides of the housing 802 to promote airflow over the cells 812. During descent, the downward movement of the secondary aerial vehicle 200 may facilitate directing airflow into the housing 802 to cool the cells 812. Additionally, or alternatively, the fore thruster 602 may direct airflow over or through the top aperture 806 to facilitate cooling.

The housing 802 may include one or more battery holders 815, such as a top holder 815A and a bottom holder 815B. The battery holders 815 may define a plurality of cups 818 to receive or secure the battery cells 812 in the housing 802. The battery holders 815 may space the cells 812 to promote airflow for cooling or to prevent the heat from one battery cell 812 damaging a second cell 812. The battery holder 815 may include a nonconductive material or coating to prevent undesired flow of energy between the batteries. The battery holders may be thermally non-conductive to isolate heat from any one cell 812 from another cell 812 or thermally conductive to facilitate heat transfer from the battery cells 812. In one example, the battery holders 815 are powder coated aluminum. The aluminum may assist in heat transfer while the powder coat prevents the aluminum from conducting electricity.

The battery cells 812 may include one or more burst rings 820 around an exterior of the cells 812. The burst rings 820 may be located toward an end of the cells 812. The burst rings 820 may be a rigid material closely attached around the battery cells 812. In one example, the burst rings 820 are stainless steel. Commonly, battery cells have a can like construction, with a cylinder housing and a cap sealing the active material, such as lithium, within the housing. Accordingly, in the event of a burst or thermal runaway event, battery cells most commonly fail where the cap and cylinder join, which is commonly at the ends of the cells. If a cell bursts, the heat and corrosive materials may cause the cylinder to tear along the sides resulting in more damage. To limit the damage that may result from a cell bursting, the burst rings 820 may assist the canister of the battery cells 812 in retaining their structure during a cell burst and therefore prevent tearing and decreasing damage.

The power source 800 may be charged, indirectly or directly, by the primary aerial vehicle 102. The power source 800 may be electrically connected to the primary aerial vehicle 102 through the tether 150, where the tether includes an electrically conductive feature, or through electrical connections 465. For example, electrical connections 465 and 520 may form a circuit between the primary aerial vehicle 102 and the secondary aerial vehicle 200 enabling charging of the power source 900.

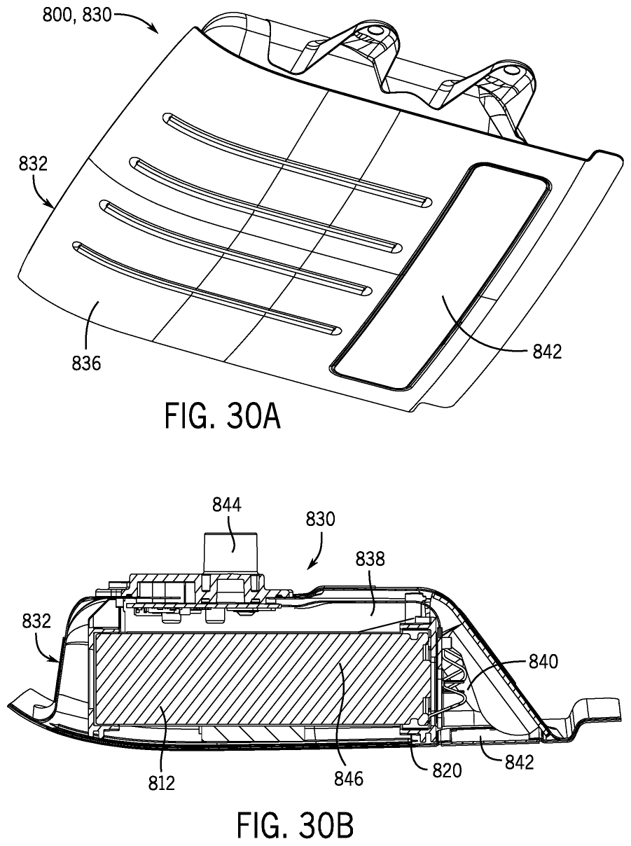

Another example of the battery assembly or power source 830 is depicted in FIGS. 30A-30B. The battery assembly 830 may include one or more of the same or similar features of the power source 800 such as battery cells 812 and burst rings 820. The battery assembly 830 may include a housing 832. The housing 832 may including a top surface or portion 834 and a bottom surface or portion (removed in FIG. 30A). A battery volume 838 for housing the battery cells 812 may be define therebetween.

The battery assembly 830 may include a vent volume 840 and a burst plate 842. The burst plate 842 may be a feature of the bottom portion 836 configured to separate or vent from the bottom portion 836. The burst plate 842 may be a fiber glass, silica, mica, carbon fiber, or metallic component. The battery assembly 830 may include sheets or portions of mica 846 on the interior of the housing 832 or on the battery cells 812. The mica 846 may provide electric or thermal insulation between the battery cells 812 and the housing 832. In some examples, the battery assembly 830 may include one or more power terminals 844. The terminals 844 may connect electrical cables to the battery assembly 830.

During a thermal or failure event of a battery cell 812, gas or heat may be released from the battery volume 838 to the vent volume 840 to limit damage or propagation of the thermal event to other cells 812. In some examples, the heat or gas released may generate pressure in the battery volume 838 or vent volume 840. In such an event the burst plate 842 may eject or partially separate from the bottom portion 836 to release pressure, gas, or heat. By placing the burst plate on the bottom portion 836, the burst plate 842 may be used to release pressure, gas, or heat when the secondary vehicle 200 is deployed or stored in the primary aerial vehicle 102.

In some examples, the secondary aerial vehicle 200 may include one or more flex connectors 950 for providing electrical energy to the various components of the vehicle 200. A portion of an example flex connector 950 is depicted in FIG. 26B, showing the vehicle with a portion of the foam body 210, 211 removed. The flex connectors 950 may be a flexible conductive material. The flexibility of the material may allow for the flex connector 950 to extend along or around the various components. In some examples, flex connectors 950 may be arranged with a variety of arms or branches to cover or reach the various components of the vehicle 200. In some examples, the flex connectors 950 may be folded or overlapped.

### Navigation Assembly and Compute Resources

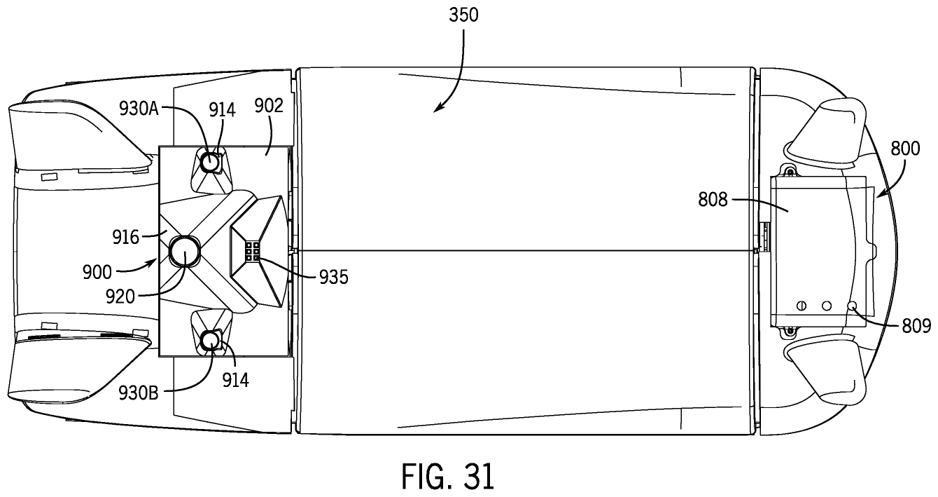

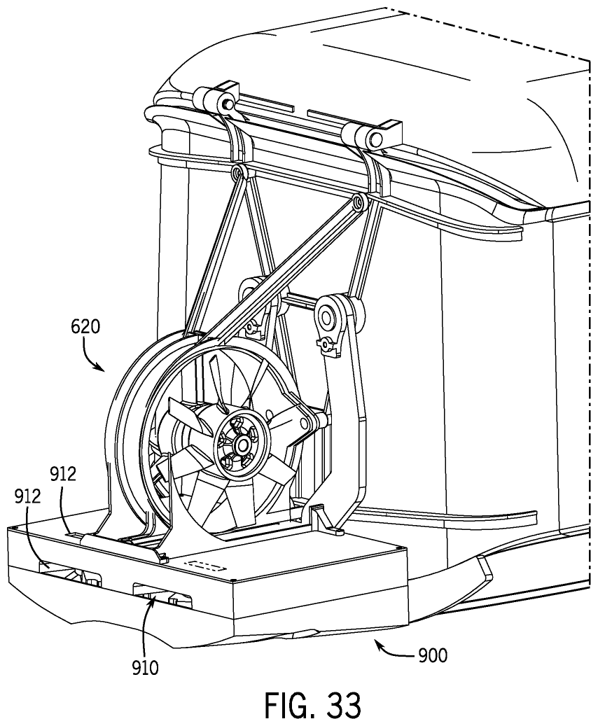

With reference to FIGS. 31-34, the secondary aerial vehicle 200 may include a navigation assembly 900 including sensors and one or more compute resources or processing elements 940. The navigation assembly 900 may detect or determine one or more characteristics of the environment of the secondary aerial vehicle 200. For example, the navigation assembly 900 may detect characteristics such as object distances, altitude, temperature, wind speed or direction, location of the secondary aerial vehicle 200, orientation of the secondary aerial vehicle, or humidity among other characteristics. The navigation assembly 900 may also include communication elements to operatively communicate between the first aerial vehicle 102 and the second aerial vehicle 200 or with a delivery recipient or shipper. The navigation assembly 900 and processing assembly 940 may also include or be in operative communication with a global navigation satellite system (GNSS) 1060 or an inertial measurement unit (IMU) 1080. While description is given with reference to aerial vehicles, it is the features or components of the navigation assembly 900, compute resources 940, or related devices and configurations may be utilized by a variety of other devices or vehicles for navigating or determining a locational or positional information.

The navigation assembly 900 may include a housing 902 to retain or cover one or more of the components. The navigation assembly 900 and processing components 940 may be located on the bottom 223 of the secondary aerial vehicle 200. Locating the sensor assemblies 900 or processing components 940 on the bottom of the secondary aerial vehicle 200 may enable operation of or access to the components when the secondary aerial vehicle 200 is stowed in the primary aerial vehicle 102.

The sensors may include one or more of a variety of devices to capture or determine information about a surrounding environment. The sensors may include imaging systems to detect visible or light related characteristics of the environment including one or more cameras. The sensors may include depth sensors including one or more of a camera, texture projector, lidar, radar, sonar, monocular camera depth estimator. The sensors may include microphones or other audio detection devices. In short, the sensors are configured to determine environmental information, e.g., depth of different objects in the delivery location, to assist the system 100 in navigating the payload 175 to a desired location while avoiding collision with objects.

The navigation assembly 900 may include a pair of stereo cameras 930. The stereo cameras 930 may be arranged facing downwards relative to the secondary aerial vehicle 200. The stereo cameras 930 may be spaced by a known distance and orientation relative to the secondary aerial vehicle 200. The stereo cameras 930 may each capture two dimensional images of the surrounding environment. The data of the each image may be combined, based on the known spacing between and the orientation of the stereo cameras 930, to determine three dimensional characteristics of the surrounding environment. For example, the stereo cameras 930 may be used to determine a distance to an object or a distance to a delivery location. The three dimensional information may be used to determine a navigation to the delivery location or a speed of deployment of the tether 150 or secondary aerial vehicle 200 from the primary aerial vehicle 102.

The navigation assembly 900 may include a monocular camera 920. The monocular camera 920 may be positioned to face downwards relative to the secondary aerial vehicle 200. The monocular camera 920 may be a wide angle camera. The monocular camera 920 may also be used to capture images and determine characteristics of the surrounding environment. The monocular camera 920 may be associated with one or more processing elements or systems 940 to determine the presence or location of objects in or near the path of the secondary aerial vehicle 200. The monocular camera 920 may, in some examples, include a wide-angle lens to increase a field of view of the navigation assembly 900. For example, the lens 920 may provide a view of the delivery location or area surrounding the feet 280 of the secondary aerial vehicle 200 when on the landing surface to determine a presence of any objects.

The stereo cameras 930 or the monocular lens 920 may also be used for delivery verification or a location verification. For example, after a payload 175 is released from the secondary aerial vehicle 200 the stereo cameras 930 or the monocular lens 920 may capture an image or otherwise detect the presence of the payload 175 outside the secondary aerial vehicle 200 at the delivery location. In operation, the secondary aerial vehicle may be raise above the delivery location and an image captured to verify a payload delivery. After verification of delivery, the secondary aerial vehicle 200 may be retracted to the primary aerial vehicle 102.

The navigation assembly 900 may include one or more light generating element or light source 935. The light source 935 may be located adjacent the one or more cameras. The light source 935 may provide illumination to enable or improve the capturing of images by the cameras. The light source 935 may include one or more LEDs to generate electromagnetic radiation. The light source 935 may generate a variety of wavelengths of electromagnetic radiation. For example, LEDs of the light source 935 may include LEDs producing light in the visible and/or infrared (IR) wavelength ranges. In one example, the light source 935 may generate light in the infrared (IR) spectrum (e.g., around 815 nm wavelength). IR light is not visible to humans and may provide a less distracting or intrusive source of illumination for the navigation assembly 900. In some examples, the cameras may be provided with a filter (e.g., a dual bandpass filter places over a lens of the camera) to allow for image capture when illumination is provided in the IR spectrum. For example, filters on the cameras may allow the navigation assembly 900 to utilize light in the IR spectrum at night, such that lights from the light source 935 are less obtrusive or disturbing to the environment. In contrast, during the day, the cameras may be able to capture visible light, with or without the aid of the additional light source 935. When visible light is emitted from the light source 935, the light may be a warm hue or color. The warmer hue or color may be perceived as less intrusive or disruptive to bystanders.

In some examples, the light source 935 may generate structured light and be situated a known distance from the one or more cameras. The structured light and known distance from the one or more cameras may assist the secondary aerial vehicle 200 in determining the distance or presence of objects.

The compute resources and additional sensor components 940 may be located adjacent the one or more cameras or within the housing 902. In some examples, the secondary vehicle 200 may include compute resources 940 in two or more locations. For example, the compute resources 940 may be positioned adjacent corresponding components. For example, the compute resources 940 may be positioned adjacent the battery assembly 800, 830, features of the propulsion assembly 600, or features of the payload release assembly 350. The compute resources 940 may include one or more processors for analyzing information or providing commands to the navigation assembly 900 or other components of the aerial vehicle 200. In one example, the computer resources 940 may be located between the one or more cameras.

During deployment, the secondary aerial vehicle 200 may descend from the primary aerial vehicle 102 faster than falling precipitation, such as rain or snow. To prevent precipitation or debris from interfering with the components of the navigation assembly 900, the navigation assembly 900 may include one or more features to facilitate passive or active clearing of debris or moisture from the navigation assembly 900. In some examples, a panel 270 may cover all or a portion of the navigation assembly and include one or more of the clearing features.

Regarding passive clearing, the housing 902 may have an exterior surface shaped to direct moisture or debris away from the sensor elements. In one example, one or more channels 916 may extend outward from the location of a sensor element, such as the monocular lens 920, to facilitate movement of moisture or debris away from the sensor element. In some example, the sensor element, such as the monocular lens 920, may be convex to facilitate clearing of moisture or debris to the passive features of the housing 902.

Regarding active clearing, the housing 902 may define one or more sensor ducts 910 to direct airflow over a sensor element, such as one or both of the stereo cameras 930. The sensor ducts 910 may include one or more intakes 912 and one or more outlets 914. Air may be directed from the intakes 912 to the outlets 914. The sensor duct 910 may extend from the aft propulsion assembly 620 to one or more of the navigation assembly 900 components. For example, the one or more sensor ducts 910 may extend into the aft duct 630 with the intake 912 positioned at a location adjacent the aft motor 625, whereby the operation of the aft thruster assembly 620 directs air through the one or more sensor ducts 910. In other examples, the intake 912 may be located at or near the rear propulsion assembly 640. The one or more outlets 914 for the sensor ducts 910 may be positioned over, at, or adjacent one of navigation assembly 900 components. In one example, an outlet 914 is located adjacent or over each of the stereo cameras 930. The airflow through the duct 910 may act to clear water or debris from the stereo cameras 930. In some examples, a separate blower element may be located within the housing 902 to direct airflow over one or more components of the navigation assembly.

The ducts 910 may extend over one or more of the components of the navigation assembly to facilitate heat exchange or cooling of the components. For example, the compute resources 940 or the light element 935 may generate heat during operation and require cooling. The ducts 910 may direct air over the components or over a heat exchanger associated with the components. The components may in turn heat the air flowing through the ducts 910. In some examples, the heat added to the air may allow for deicing, defogging, or otherwise reduce occlusion of the stereo cameras 930.

Another example of the housing assembly 903 for the navigation assembly 900 is depicted in FIGS. 23C and 34A-34B. The housing assembly 903 may include the same or similar features as the housing assembly 902. For example, the housing assembly 903 may include a stereo pair of cameras 930 and a single or wide range camera 920. The housing assembly 903 may include light sources 935 for illuminating a region for the cameras.

The housing assembly 903 may include one or more cooling or heat transfer elements. The housing assembly 903 may include one or more heat exchangers 948. The housing assembly 948 may include one or more blowers 950 to move air through the housing assembly 903. The heat transfer elements may assist to transfer or disperse heat from the various components. For example, the heat exchangers 948 or blowers 950 may transfer or disperse heat from the navigation assembly 900, the aft thrust assembly 620, or compute modules 940. In some examples, heat transferring features, such as heat pipes, may extend from additional components to the housing assembly 903.

The housing assembly 903 may include one or more ducts through at least a portion of the housing 903. The housing assembly 903 may define a duct extending from the blowers 950 to one or more outlets 954. The outlet 954 may be at or adjacent one or more cameras 920, 930. As a result, excess heat or the airflow may assist in clearing or preventing moisture build up at the cameras 920, 930. The duct may also provide an avenue for heat to transfer to an external environment of the secondary vehicle 200. In some examples, the housing assembly 903 may be connected to the body 210, 211 at least in part by spin bosses connectors 286.

In some examples, the housing assembly 903 may be fluidly connected with an aft duct inlet 952. The aft duct inlet 952, as may be illustrated in FIG. 23C, may be defined in the aft duct 631. The aft duct inlet 952 may allow airflow from the aft thrust assembly 620 to additionally or alternatively assist in transferring heat or clearing the cameras 920, 930.

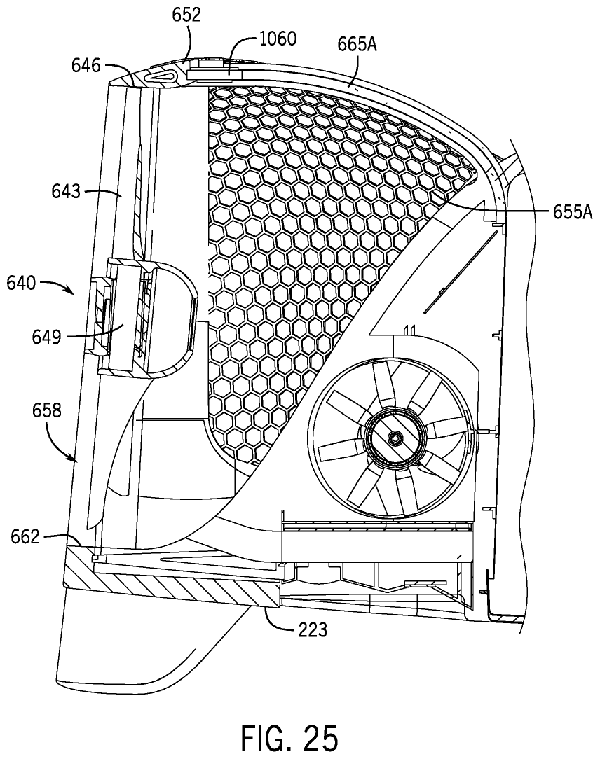

In some examples, the secondary aerial vehicle 200 includes a global navigation satellite system (GNSS) or GPS receiver 1060. As may be shown in FIGS. 8A-8B and 25A, the GPS receiver 1060 may be positioned in or on the rear thruster housing 652. For example, the GPS receiver 1060 may be position at the top of the rear duct 658. During use, GPS receivers may receive signals from global positioning satellites to determine a relative position. However, when a GPS receiver has lost signal, it may take a duration of time before a new signal is received from a satellite to determine a new position. As a result, if signal is lost there may be a time delay before navigation by the GPS or related system is possible. By placing the GPS receivers 1060 at the top of the rear duct 658, the GPS receiver 1060 may continue to receive satellite signals while stowed in the primary vehicle 102. Accordingly, the secondary vehicle 200 may be deployed and navigate using GPS information without an initial delay.

### Operation of the Aerial Vehicle System

At operation, the aerial vehicle system 100 may transport a payload 175 from a first location to a second location. The aerial vehicle system 100 may include a primary aerial vehicle 102 and an operatively connected secondary aerial vehicle 200. The aerial vehicle 102 may transport the secondary aerial vehicle 200 to the first location, which may be a pickup location for the payload 175.

The secondary aerial 200 may include a tether assembly 400 to operatively connect the second aerial vehicle 200 to the primary aerial vehicle 102. A retraction assembly 500 may, in combination with the tether assembly 400, selectively couple or release the second aerial vehicle 200. The secondary aerial vehicle 200 may define an internal compartment, such as a payload bay 242 to receive or secure a payload 175 for transport. The payload bay 242 may include one or more selectively accessible apertures. The payload bay 242 may be selectively accessible from a first surface or side by a lid assembly 300. The lid assembly may include a latch assembly 315 to selectively lock or unlock the lid assembly 300 to expose the payload bay 242. The payload bay 242 may be selectively accessible from a second surface or side by a payload release assembly 350. A propulsion assembly 600 may allow for control or movement of the secondary vehicle 200 during deployment. One or more navigation assemblies 900 may provide information regarding the environment to one or more processing elements 940. A power source 800 may provide energy to the one or more assemblies of the secondary aerial vehicle 200.

At a first location, the secondary aerial vehicle 200 may be presented to receive a payload 175. The lid assembly 300 may be selectively actuated to provide access to the payload bay 242. A payload 175 may be placed in the payload bay 242 and the lid assembly 300 actuated to a closed and locked configuration.

After loading the secondary aerial vehicle 200, the secondary aerial vehicle 200 may be retracted to the primary aerial vehicle 102. The loading location may be within or adjacent a structure and the primary aerial vehicle 102 may be located outside the structure. Accordingly, the retraction assembly 500 may return the secondary aerial vehicle 200 to the primary aerial vehicle 102 through a portal, door, window, specialized chute, tube, or similar feature.

The body 210 of the secondary aerial vehicle 200 may be tapered to fit within a vehicle compartment 124 of the primary aerial vehicle 102. For example, the difference in width or length between the entrance of the compartment 124 and the aerial vehicle 200 may provide a tolerance to allow for passive alignment of the aerial vehicle 200 in the primary aerial vehicle 102. As the secondary aerial vehicle 200 is pulled further into the primary aerial vehicle 102, the shape of the vehicle compartment 124 and the shape the secondary aerial vehicle 200 may assist in positioning the secondary aerial vehicle 200 within the bay 124.

As the secondary aerial vehicle 200 is inserted into the primary aerial vehicle 102, the top side 220 of the secondary aerial vehicle 200 may be the first portion to enter the vehicle compartment 124. The top 220 may have a dimension less than a width or length dimension of the bay 124 at the entrance, defining a tolerance. When the vehicle 200 is further pulled into the bay 124, the walls 166 may taper such that the width or length dimension for a location of the bay 124 increasingly corresponds with a the dimension of the top 220. As the vehicle 200 is inserted into the bay 124, the taper of the walls 166 may decrease the tolerance relative to the vehicle 200 and the vehicle 200 may be guided into position in the bay 124.

The tolerance may accommodate movement of the secondary aerial vehicle 200 relative to the primary aerial vehicle 102, for example due to wind or flight of the primary aerial vehicle 102. The progressive nesting may allow the bottom 223 of the secondary aerial vehicle 200 to align with the bottom 116 of the primary aerial vehicle 102 when stowed. The bottom 223 of the secondary aerial vehicle 200 may align with the bottom 116 of the primary aerial vehicle 102 with relatively tight tolerances. The tighter fit may result in reduced drag, improved stability, and an improved aesthetic appearance for the aerial vehicle system 100.

After retraction, the secondary aerial vehicle 200 may be connected within or to the primary aerial vehicle 102. The primary aerial vehicle 102 may carry the secondary aerial vehicle 200 and the payload 175 to a first location above the delivery location. At the first location, the secondary aerial vehicle 200 may be deployed from the primary aerial vehicle 102. During deployment, the navigation assembly 900 may determine environmental characteristics such as wind speed or object distances relative to the secondary 200 or primary aerial vehicle 102. The navigation assembly 900 may also determine an orientation or position of the secondary vehicle 200.

To release the secondary aerial vehicle 200, the tether assembly 400 may be selectively released from the retraction assembly 500. The retraction assembly 500 may dispense tether 150 to allow the secondary aerial vehicle 200 to descend. Gravity or the retraction assembly 500 may provide a downward force to direct the secondary aerial vehicle 200 towards the delivery location. The retraction assembly 500 may limit or control the downward velocity, such as a maximum downwards velocity, of the secondary aerial vehicle 102. Information gathered by the navigation assembly 900 may be used to determine a descent rate or orientation of the secondary aerial vehicle 200.

During descent, the secondary aerial vehicle 200 may encounter wind or the primary aerial vehicle 102 may be in motion. The aerodynamic body 210 and features of the secondary aerial vehicle 200 may assist in aligning the secondary aerial vehicle into or against the direction of the airflow. For example, the convex shape of the front 232 or bottom 223 may assist in stabilizing the secondary aerial vehicle 200. Rapid descent of the secondary vehicle 200 may also reduce instability of the secondary vehicle 200 or promote an improved descent profile. Improving the actual and visible stability of the descent of the secondary aerial vehicle 200 may improve or increase a recipient's experience and belief in the effectiveness of the delivery system 100.

The tether assembly 400 may assist in stabilizing the secondary aerial vehicle. The tether assembly 400 and the tension on the tether 150 from the weight of the secondary aerial vehicle 200 may reduce or inhibit rolling of the secondary aerial vehicle 200 during disturbances such as wind gusts.

The propulsion assembly 600 may assist in controlling the secondary aerial vehicle 200 during deployment. The one or more thrusters of the propulsion assembly 600 may be selectively activated in response to a disturbance. The one or more thrusters may counter disturbances, such as wind, by generating corresponding or opposite thrust. Additionally, or alternatively, the propulsion assembly 600 may enable the secondary aerial vehicle 200 to account for location errors or limitations of the primary aerial vehicle 102 and navigate to the delivery location.

At the delivery location, the secondary aerial vehicle 200 may land on a delivery surface at the delivery location. The feet 280 of the secondary aerial vehicle 200 may define a clearance between the payload release assembly 350 and the delivery surface. The clearance may be sufficient for the payload release assembly 350 to move to an open configuration from a closed configuration. To reach the open configuration, one or more doors 355 or other rigid supports of the payload release assembly 355 may pivotally rotate to expose the payload bay 242.

In the open configuration, the payload 175 may exit the payload bay 242, e.g., due to gravity, the payload 175 may “fall” from the payload bay 242 to the delivery surface. In many embodiments, the system 100 is configured to reduce the length of travel of the payload 175, e.g., the payload bay 242 may open a short distance above the ground or other delivery surface.

After release, the secondary aerial vehicle 200 may be lifted off the delivery surface. To confirm delivery of the payload, the navigation assembly 900 may include an imaging system to verify the payload 175 is out of the payload bay 242 and at the delivery location. In some examples, a tension on the tether 150 may be detected, and a before release tension and an after release tension are compared to determine whether the payload 175 has been released. In the event payload delivery is not confirmed, the secondary aerial vehicle 200 may land and attempt delivery again.

After confirmation of delivery, the secondary aerial vehicle 200 may be retracted to the primary aerial vehicle 102. During ascent, the one or more features of the secondary aerial vehicle 200 may provide control or assistance in orienting the secondary aerial vehicle 200. After the secondary aerial vehicle 200 is coupled to the primary aerial vehicle 102, the aerial vehicle system may return to a pickup location.

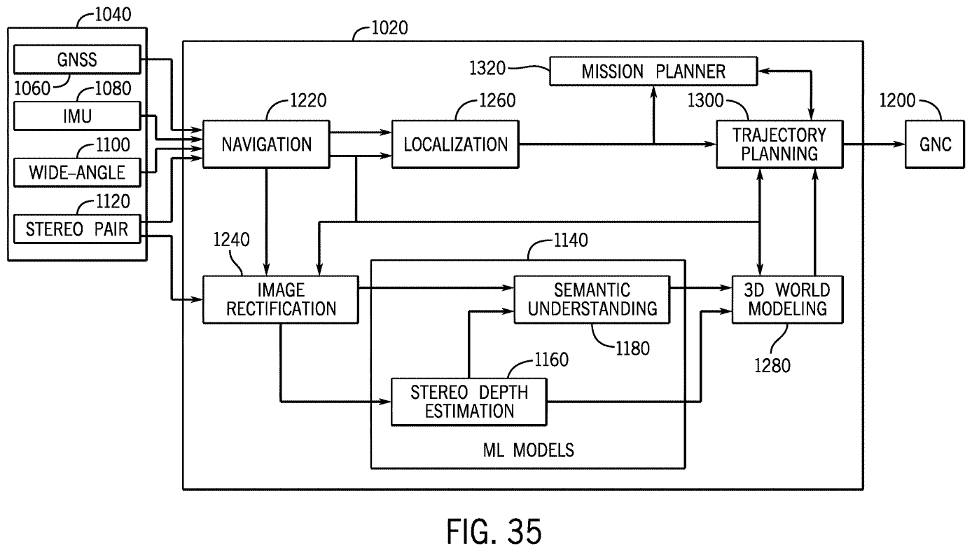

FIG. 35 is a schematic diagram of compute resources 1020 in an aerial vehicle, such as aerial vehicle 200. The compute resources 1020 may include the navigation assembly 900, or one or more components of the navigation assembly. The compute resources 1020 may generally include various machine learning and/or artificial intelligence (ML/AI) models and provide other functionality to navigate the aerial vehicle through various environments. For example, the compute resources 1020 may include components for implementing perception scene understanding and planning within an environment to navigate the aerial vehicle through the environment. Such navigation may, in some examples, allow the aerial vehicle to augment information (such as GPS coordinates) to deliver at an identified delivery location. For example, the aerial vehicle may be a secondary vehicle which is deployed from a primary vehicle (e.g., by a tether) to make deliveries. The perception scene understanding and planning within the environment may further allow the aerial vehicle to avoid and navigate around obstacles, deliver to precise locations such as under overhangs and awnings, and determine a delivery location. For example, perception scene understanding and planning may provide the aerial vehicle with depth information for an environment, allowing the vehicle to ascertain its position within the environment as well as to determine altitude of various obstacles such as electrical wires, fences, and the like.

The compute resources 1020 may generally receive various information from sensors 1040 of the aerial vehicle. For example, the sensors 1040 may include a global navigation satellite system (GNSS) 1060, an inertial measurement unit (IMU) 1080, a wide-angle camera 1100, and a pair of stereo cameras 1120. The computer resources 1020 and sensors 1040 may correspond to one or more components of the navigation assembly 900. In various examples, more sensors may be included in the sensors 1040 of the aerial vehicle and may provide additional input to the compute resources 1020 for navigation of the aerial vehicle. For example, the sensors may include a barometer and/or additional global positioning satellite (e.g. GPS) sensors in various implementations. In various examples, the pair of stereo cameras 1120 may provide depth estimation of various aspects of the environment and may be spaced apart on a bottom surface or underside of the aerial vehicle.

In various examples, the aerial vehicle may be provided with active illumination, such as infrared (IR) illumination to allow the aerial vehicle to navigate at night as well as during the day. Such IR illumination may provide for illumination of the environment within a certain distance from the aerial vehicle (e.g., 10 m) and may be outside of the visible spectrum, such that the aerial vehicle may deliver payload at night without additional lighting, which may disturb humans close to the delivery area. In such examples, the wide-angle camera 1100 and the stereo camera pair 1120 may be able to collect images in both the visible light spectrum (e.g., during the day) and the IR spectrum (e.g., when active illumination is used at night).

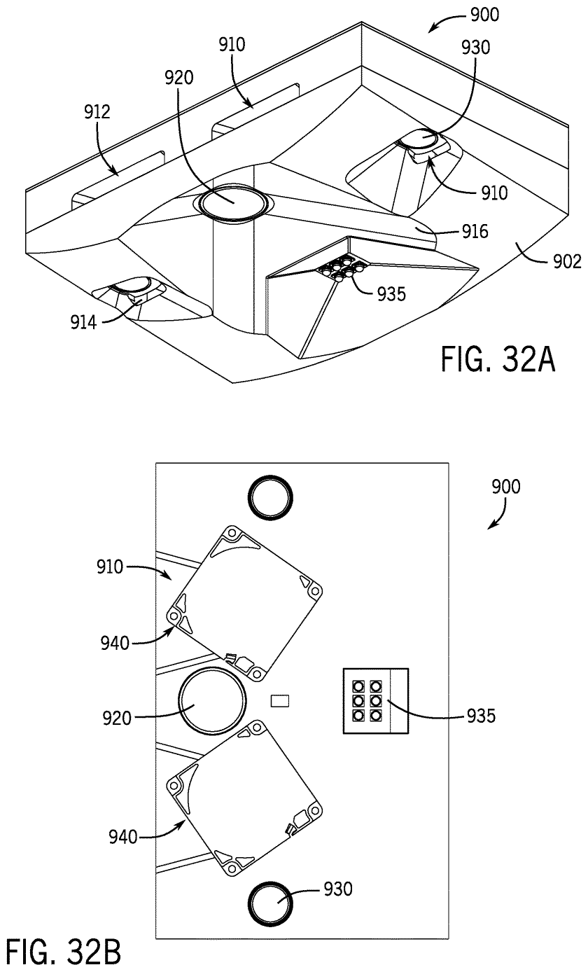

The compute resources 1020 may generally include processing and memory resources. For example, memory resources may store instructions which, when executed by the processors of the compute resources 1020, implement the components shown in FIG. 32B. The compute resources 1020 may communicate with additional computing devices not integrated into or located on the aerial vehicle. Such communication may use wireless and/or wired interfaces. For example, the sensors 1040 may, in some examples, collect data used to train models at another computing device. Such data may then be transmitted to the other computing device through a wired or wireless interface to the compute resources 1020. Similarly, models used by or implemented at the compute resources 1020 may be generated or trained at another computing device, and the trained models may be communicated from another computing device to the compute resources 1020 using various communication interfaces. The compute resources 1020 may further provide output to other systems or components of the aerial vehicle, such as guidance, navigation, and control (GNC) systems 1200. Such GNC 1200 may use output from the compute resources 1020, such as planned trajectories or instructions for maneuvering the aerial vehicle, to maneuver the aerial vehicle through an environment.

The ML models 1140 may generally receive data and other input from the sensors 1040 of the aerial vehicle, including output from the stereo camera pair 1120 and/or the wide angle camera 1100. The ML models 1140 may generally be trained to produce depth information about an environment based on input received from the sensors 1040, which may include top-down two-dimensional imagery collected using the stereo camera pair 1120 and/or the wide angle camera 1100. In some examples, the depth information may include a three-dimensional model of an environment thorough which the aerial vehicle is navigating. In various examples the ML models 1140 may, collectively or individually, obtain, from two-dimensional imagery on an environment, depth information about each pixel within the two-dimensional imagery. Such information may allow the aerial vehicle to determine how far away obstacles in the environment are from the aerial vehicle during its descent (e.g., using the three-dimensional model of the environment). Such a three-dimensional model and/or other depth information may therefore be utilized to navigate the aerial vehicle through an environment.

The ML models 1140 may include, in various examples, a stereo depth estimation model 1160 and a semantic understanding model 1180. In some examples, the ML models 1140 may provide information to one another. For example, the semantic understanding model 1180 may receive output from the stereo depth estimation model 1160 as input. Generally, the stereo depth estimation model 1160 may estimate depth of pixels in two-dimensional image data provided to the stereo depth estimation model 1160. In various examples, the stereo depth estimation model 1160 may be a deep learned model which is able to infer context from other areas of the two-dimensional image data where, for example, the two-dimensional image data is otherwise difficult for the model to interpret. Without the ability to infer context, the model would generally not be able to estimate depth for such areas of the two-dimensional image. The semantic understanding model 1180 may receive the two-dimensional image data and the estimated depth information from the stereo depth estimation model 1160 to perform semantic segmentation to identify particular features in the images. For example, the semantic understanding model 1180 may identify common objects such as fences, power lines, and the like.

Each of the stereo depth estimation model 1160 and the semantic understanding model 1180 may be implemented using neural networks trained at another computing device. For example, stereo camera data may be collected using various aerial vehicles similar to the aerial vehicle. Such stereo camera data may be paired with LiDAR data or other methods of measuring depth to create training data sets to train the ML models 1140. In some examples, the training data may further include images with tagged elements or features, which may be used to train the semantic understanding model 1180. For example, the stereo depth estimation model 1160 may be trained using supervised training and training data including image data collected from stereo camera and LiDAR data providing depth information for objects in such image data. The semantic understanding model 1180 may also be trained using supervised learning, and may be further trained using tagged images or the like.

In some examples, the training data may be synthetic or computer generated training data. For example, synthetic training data may be simulated sets of data representative of objects or environments existing in the real world, in these examples, the synthetic data may include representative features of environmental objects and include tagged information regarding the “depth” of the environmental objects. The synthetic training data may include representative objects and known or accurate characteristics of those objects in a variety of lighting or weather conditions. For example, the synthetic training data may include known or accurate distances to the objects, light interactions with objects (e.g. IR, visible, or other ranges of the spectrum), physical interactions between representative objects (e.g. wind, movement), and the like. The synthetic training data may provide information regarding or assist in training the neural networks for conditions missing from the training data, difficult to replicate in the training data, or for important or likely real world scenarios where additional information may be beneficial. It should be noted that the use of synthetic data may generate more accurate models as the “depth” of the various objects represented in the synthetic images may be completely accurate as compared to real images where the depth may be estimated or within a range since it needs to be separately calculated. Thus, by using synthetic data the models can be trained more quickly and be more accurate.

The ML models 1140 may further, in some examples, be updated or improved over time as the aerial vehicle makes more deliveries utilizing the ML models 1140. For example, customers or recipients of deliveries may provide feedback regarding accuracy of delivery location. Such feedback may be provided to the ML models 1140 to increase their accuracy over time.

During navigation of the aerial vehicle, the sensors 1040 may provide input to both navigation 1220 and image rectification 1240 components of the compute resources 1020. Image rectification 1240 may generally utilize input from the sensors 1040 to generate two-dimensional image data, which is then provided to the stereo depth estimation 1160 and semantic understanding 1180 models. The ML models 1140 may utilize the two-dimensional image data to generate depth information and classifications for the pixels in the two-dimensional image data. Such depth information and classifications may be provided to 3D world modeling 1280, which may generate a three-dimensional model of the environment being navigated. The three-dimensional model may, in various examples, be a three-dimensional point cloud or other geometrically accurate three-dimensional reconstruction of an environment. 3D world modeling 1280 may also utilize information received from image rectification 1240, navigation 1220, and/or other components of the compute resources 1020 to generate the three-dimensional model.

Navigation 1220 may utilize information from the sensors to understand the location of the aerial vehicle relative to, for example, a primary aerial vehicle from which the aerial vehicle was deployed to complete a delivery. Such understanding may include estimated satellite determined (e.g. GPS) coordinates of the aerial vehicle based on the data from sensors 1040 reflecting the movement of the aerial vehicle from a known GPS location of the primary vehicle at deployment of the aerial vehicle from the primary vehicle. For example, output from GNSS 1060, IMU 1080, wide angle cameras 1100, and/or the stereo camera pair 1120 may be used to determine how the aerial vehicle has moved since deployment from the primary vehicle. Such motion information may be used to create an updated estimation of the satellite determined or GPS location of the aerial vehicle. In some examples, sensor fusion output from two or more of the sensors 1040 may be used in such a determination to increase accuracy of the updated estimation of the GPS location of the aerial vehicle.

Localization 1260 may receive output from navigation 1220 and image rectification 1240 to localize the location of the aerial vehicle within the obtained image data. Both the localization information generated by localization 1260 and the three-dimensional model generated by 3D world modeling 1280 may be provided to trajectory planning 1300, which may utilize such input, along with input from the mission planner 1320, to provide instructions to GNC systems 1200 of the aerial vehicle, causing the aerial vehicle to navigate to the delivery location in accordance with the directions and information generated by the compute resources 1020.

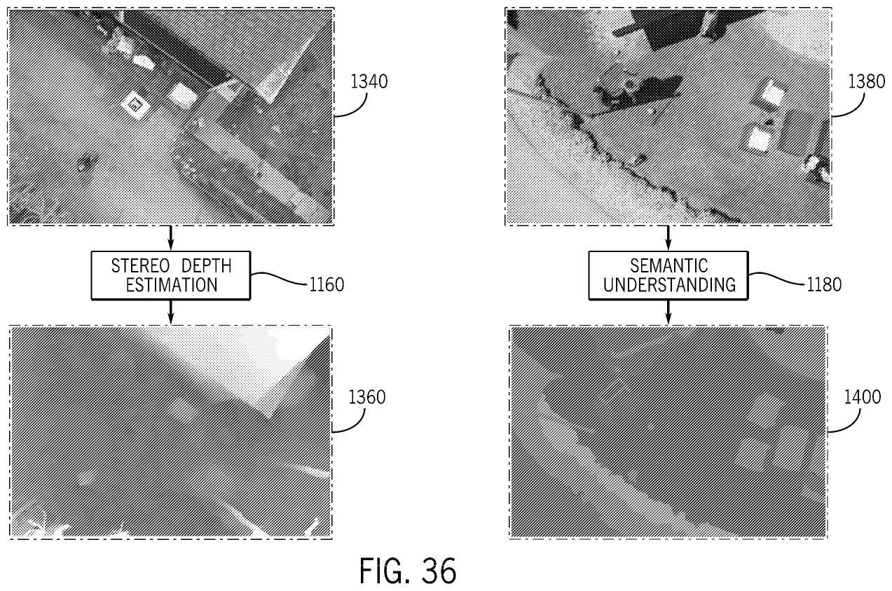

FIG. 36 illustrates example input to and output from the stereo depth estimation 1160 and semantic understanding 1180 models. As shown, input 1340 to stereo depth estimation 1160 and input 1380 to semantic understanding 1180 may be two-dimensional image data collected using the wide angle camera 1100 and/or the stereo camera pair 1120 on the aerial vehicle. The stereo depth estimation model 1160 may generally generate output 1360 which identifies depth information (e.g., distance from the aerial vehicle) for the elements in the two-dimensional image. For example, features which are closer to the aerial vehicle may be illustrated or labeled to a user as more brightly colored or in contrast with surroundings in the output 1360. Such depth information helps the aerial vehicle to navigate the environment during descent by avoiding closer objects during such descent.

Input 1380 to the semantic understanding model 1180 may similarly be two-dimensional image data collected using the wide angle camera 1100 and/or the stereo camera pair 1120 on the aerial vehicle. In some examples, the semantic understanding model 1180 may further receive the output 1360 from the stereo depth estimation model 1160 as input. The output 1400 from the semantic understanding model 1180 may provide classifications for various features or elements within the two-dimensional image data provided as input 1380. For example, the semantic understanding model 1180 may identify pavement or other solid surfaces, dirt, plants, grassy areas, static items (e.g., lawn furniture, tools, and the like), and humans. Such identifications may provide additional context for the aerial vehicle to maneuver during descent and/or to locate delivery areas where a precise delivery location is not identified. For example, the aerial vehicle may prioritize avoidance of certain identified categories (e.g., people, moving vehicles, and the like) and/or may select landing locations in certain other categories, such as in large areas identified as grass.

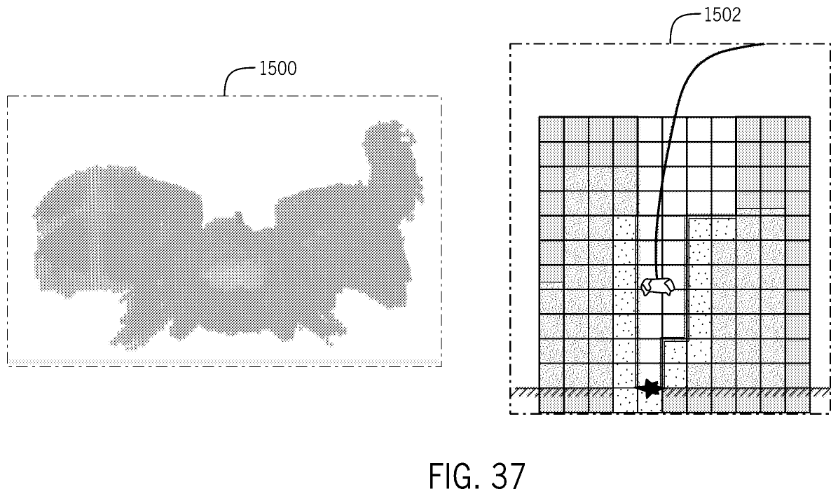

FIG. 37 illustrates example depth information which may be generated using the semantic understanding model 1180 and/or the stereo depth estimation model 1160. Generally, a three-dimensional model 1500 may be generated by 3D world modeling 1280 based on output from the semantic understanding model 118 and the stereo depth estimation model 1160. Trajectory planning 1300 may utilize the three-dimensional model 1500 when planning flight paths for the aerial vehicle, such as by querying the three-dimensional model 1500 for depth information about certain pixels within the model. The three-dimensional model 1500 generally shows a flat or preferred landing spot between two obstacles (e.g., vegetation, structures, or other obstacles). In various examples, 3D world modeling 1280 may identify areas within the three-dimensional model as preferred landing or delivery areas, such as those areas without marked objects or as indicated by changes in shading such as lighter or contrasting regions, or areas marked in green in the three-dimensional model 1500.

In various examples, 3D world modeling 1280 may utilize a three-dimensional occupancy grid 1502 to generate the three-dimensional model 1500. The occupancy grid is generally a representation of an environment where each grid cell (or voxel) is provided with a value reflecting a probability that the voxel is free or occupied. The occupancy grid may be visually represented for review by a user, developer, or the like. For example, in the three-dimensional occupancy grid 1502, voxels, as visually represented, may be shown in white are free, while voxels shown in shading or a color (e.g. dotted shading or blue) are occupied. The occupancy grid 1502 may also utilize additional values, shading, patterns, or colors to visually represent that a voxel includes an obstacle to be avoided by the aerial vehicle (e.g., moderately shaded or red voxels in the three-dimensional occupancy grid 1502) or that the voxel is unobserved or has an unknown status (e.g., darker shading or grey voxels in the three-dimensional occupancy grid 1502).

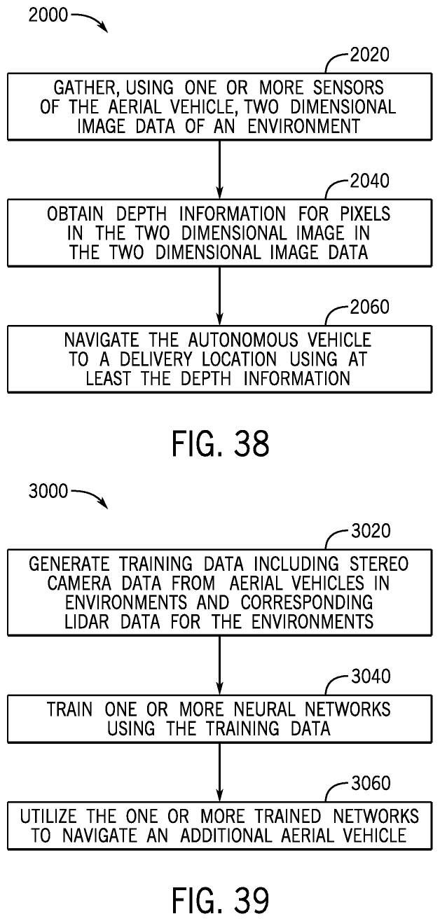

FIG. 38 illustrates an example method 2000 of navigating an aerial vehicle in an environment using depth information for the environment. At block 2020, two dimensional image data of an environment is gathered using one or more sensors of the aerial vehicle. Two dimensional image data may be gathered, for example, by the wide angle camera 1100 and/or the stereo camera pair 1120. In some examples, additional information may be collected with the two dimensional image data. For example, data from other sensors 1040, such as GNSS 1060 and/or IMU 1080 may help to provide additional context about the location of the aerial vehicle in the environment.

Depth information is obtained for pixels in the two dimensional image data at block 2040. The depth information may be obtained using the ML models 1140. In some examples, the two dimensional image data may be provided to image rectification 1240, which may then provide the two dimensional image data as input to the stereo depth estimation model 1160 and/or the semantic understanding model 1180. The stereo depth estimation model 1160 may generally estimate depth (e.g., distance from the aerial vehicle) for each pixel (or groupings of pixels) in the two dimensional image data. The semantic understanding model 1180 may utilize the two dimensional image data and the depth estimations to categorize pixels or groups of pixels within the two dimensional image data. For example, the semantic understanding model 1180 may identify plants, grassy areas, static objects, humans, vehicles, power lines, fence lines, and the like.

At block 2060, the aerial vehicle navigates to a delivery location using at least the depth information. 3D world modeling 1280 and/or trajectory planning 1300 may utilize output from the ML models 1140, including the depth estimation information, to determine how to maneuver the aerial vehicle given the depth estimation information generated by the stereo depth estimation model 1160 and/or the segmentation generated by the semantic understanding model 1180. Trajectory planning 1300 may, for example, modify paths created by a mission planner 1320 using the output from the ML models 1140 to avoid obstacles, navigate around obstacles, locate a particular delivery location, and the like. Trajectory planning 1300 may communicate with other control components of the aerial vehicle, such as GNC 1200 to maneuver the aerial vehicle in accordance with output from trajectory planning 1300.

In some examples, at block 2060, 3D world modeling 1280 and/or trajectory planning 1300 may utilize output from the ML models 1140, including depth estimation information and semantic understanding to generate landability criteria. Such landability criteria may be utilized to, for example, determine a precise delivery location and navigate to the precise delivery location. In some examples, landability criteria may be generated for a number of possible landing locations in a given area (e.g., within property boundaries, within a particular radius of a selected or planned landing location, or the like).

In various examples, landability criteria may be determined for potential landing locations based on fitness of a particular area for landing and/or delivering payload. Such fitness may be determined based on, for example, obstacles near the location (e.g., fences, power lines, people, and the like), flatness of the location, distance of the location to an initially selected location, surface type of the location (e.g., grass, dirt, concrete, and the like), or other criteria. The landability criteria may be expressed, for example, as a numerical score, a set of values, or the like. In some examples, an optimization algorithm or similar may be utilized to select a landing location from several landing locations based on the landability criteria. The aerial vehicle may navigate to the selected landing location as described herein.

FIG. 39 illustrates an example method 3000 of training neural networks for navigation of an aerial vehicle. At block 302, training data is generated for various environments. The training data may generally include depth or distance information captured by various depth sensors. For example, stereo camera data from aerial vehicles in the environments or LiDAR data for the environments may be utilized. For example, aerial vehicles may be maneuvered through various environments with LiDAR sensors. Two dimensional image data collected by wide angle cameras, stereo pairs of cameras, and the like, may be paired with LiDAR data indicating depth for various objects in the two dimensional image data to generate training data for the stereo depth estimation model 1160 and/or the semantic understanding model 1180. In various examples, the training data may further include annotated versions of two dimensional images including categorizations for various objects within the two dimensional images. Such annotated images may be used to train the semantic understanding model 1180 to perform semantic segmentation on two dimensional images. In some examples, training data for the semantic understanding model 1180 may further include stereo depth estimations, which may be produced by the stereo depth estimation model 1160 and/or be obtained from LiDAR data. In some examples, the training data may include the synthetic or computer generated training data. Synthetic training data may be generated to cover a predetermined or requested variety of characteristics. In some examples, synthetic training data may be modeled after real world conditions and generate alternative, additional, or similar training data as compared to real world or captured training data. For example, the data may include images configured to represent real environmental objects, such as houses, trees, power lines, or the like, and the images may include depth information which is the depth at which each object is generated. This depth may be completely accurate as compared to real images where the depth needs to be separately calculated and tagged as part of the data.

One or more networks are trained using the training data at block 3040. The stereo depth estimation model 1160 may generally be trained using supervised learning techniques and utilizing depth sensor information. For example, the depth sensor information may include two dimensional image data and LiDAR data as training data. The semantic understanding model 1180 may similarly be trained using supervised learning techniques and utilizing the two dimensional image data, annotated image data, and/or depth estimations as training data. In some examples, the training may include providing the synthetic training information to the neural network. In some examples, only synthetic training data may be used. In some examples, synthetic training and real world or captured training data may be used together. For example, synthetic training data may be initially provided and real world or captured training data may be used to fine tune or refine the neural network models.

At block 3060, the one or more trained networks are utilized to navigate an additional aerial vehicle. In various examples, the stereo depth estimation model 1160 and the semantic understanding model 1180 may be trained using compute resources separate from the aerial vehicle. In such examples, the trained stereo depth estimation model 1160 and semantic understanding model 1180 may be provided to compute resources 1020 (e.g., through a wired or wireless communication interface to the aerial vehicle). The aerial vehicle may then utilize the trained ML models 1140 (as described, for example, in the method 2000 with respect to FIG. 37) to navigate descent and delivery in various environments.

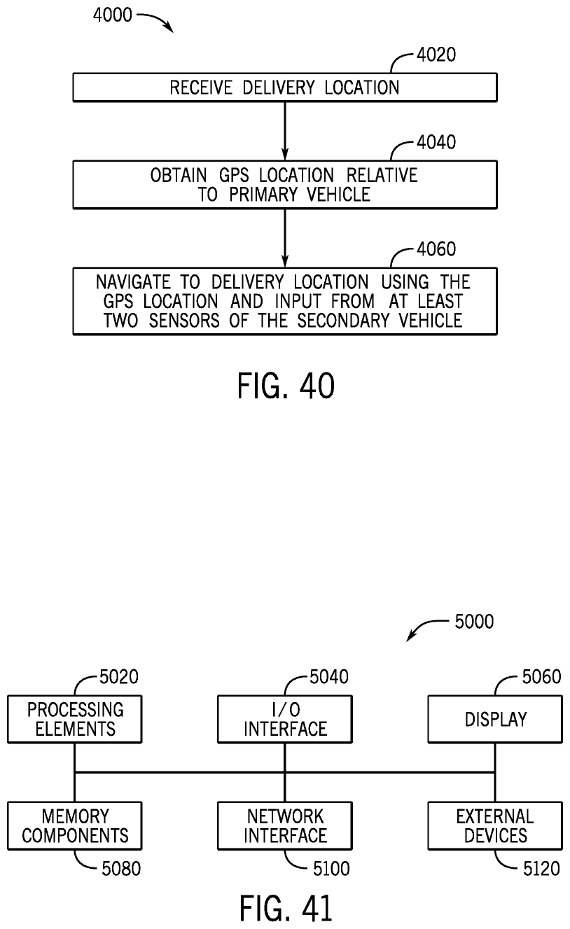

FIG. 40 illustrates an example method 4000 of navigating a secondary aerial vehicle from a primary aerial vehicle to a delivery location. At block 4020, the secondary vehicle receives a delivery location. The delivery location may be, in various examples, an address, GPS coordinates, selection within an image of a larger area, or the like.

The secondary vehicle obtains a GPS location relative to the primary vehicle at block 4040. Generally, the secondary vehicle may be deployed by the primary vehicle to navigate to the delivery location. The secondary vehicle may, at deployment, receive a first GPS location of the primary vehicle. The secondary vehicle may generally utilize the first GPS location of the primary vehicle during descent to determine its own location in an environment. For example, the GPS location of the primary vehicle may be used by the secondary vehicle as a reference point in determining GPS location of the secondary vehicle.

At block 4060, the secondary vehicle navigates to the delivery location using the GPS location and input from at least two sensors of the secondary vehicle. During descent, the secondary vehicle may utilize data from sensors 1040 to determine its position relative to the first satellite determined or GPS location of the primary vehicle. The secondary vehicle may utilize sensor fusion to obtain a more accurate GPS location relative to the primary vehicle. For example, the secondary vehicle may use data about motion of the vehicle provided by both the IMU 1080 and the stereo camera pair 1120 to estimate the relative GPS location. In other examples, different combinations of sensors 1040 may be used, such as IMU 1080 and GNSS 1060. The secondary vehicle may be capable of utilizing different combinations of the sensors 1040 for this purpose, such that the secondary vehicle may continue to navigate accurately in case of failure of any of the sensors 1040. The secondary vehicle may generally utilize its position relative to the GPS location of the primary vehicle to navigate precisely to the delivery location.

Such navigation using sensor fusion may allow the secondary vehicle to more precisely deliver to delivery locations when compared to use of GPS data by itself. For example, visual input can correct GPS data or provide more precision to collected GPS data, giving the secondary vehicle the ability to deliver more accurately to the delivery location (e.g., with error margins up to 10 cm rather than meters). Such accuracy is helpful where deliveries occur in crowded and/or small areas. For example, a payload is less likely to be delivered on the wrong side of a fence or to a wrong address.

FIG. 41 is a schematic diagram of an example computer system 5000 for implementing various embodiments in the examples described herein. A computer system 5000 may be used to implement the compute resources 1020 or may be utilized to train or generate the ML models 1140. For example, the compute resources 1020 may include one or more of the components of the computer system 5000 shown in FIG. 41. The computer system 5000 is used to implement or execute one or more of the components or operations disclosed in at least FIGS. 35-40. In FIG. 41, the computer system 5000 may include one or more processing elements 5020, an input/output interface 5040, a display 5060, one or more memory components 5080, a network interface 5100, and one or more external devices 5120. Each of the various components may be in communication with one another through one or more buses, communication networks, such as wired or wireless networks.

The processing element 5020 may be any type of electronic device capable of processing, receiving, and/or transmitting instructions. For example, the processing element 5020 may be a central processing unit, microprocessor, processor, or microcontroller. Additionally, it should be noted that some components of the computer 5000 may be controlled by a first processor and other components may be controlled by a second processor, where the first and second processors may or may not be in communication with each other.

The memory components 5080 are used by the computer 5000 to store instructions for the processing element 5020, as well as store data, such as the trained ML models 1140 and the like. The memory components 5080 may be, for example, magneto-optical storage, read-only memory, random access memory, erasable programmable memory, flash memory, or a combination of one or more types of memory components.

The display 5060 provides visual feedback to a user. Optionally, the display 5060 may act as an input element. The display 5060 may be a liquid crystal display, plasma display, organic light-emitting diode display, and/or other suitable display. In embodiments where the display 5060 is used as an input, the display may include one or more touch or input sensors, such as capacitive touch sensors, a resistive grid, or the like.

The I/O interface 5040 allows a user to enter data into the computer 5000, as well as provides an input/output for the computer 5000 to communicate with other devices or services. For example, an I/O interface 5040 to the compute resources 1020 may allow a user to provide the trained ML models 1140 and/or other data to the compute resources 1020 for use in navigation of the aerial vehicle. The I/O interface 5040 can include one or more input buttons, touch pads, and so on.

The network interface 5100 provides communication to and from the computer 5000 to other devices. For example, the network interface 5100 allows the may allow the compute resources 1020 to communicate with a primary aerial vehicle and/or with other computing systems. The network interface 5100 may include one or more communication protocols, such as, but not limited to WiFi, Ethernet, Bluetooth, and so on. The network interface 5100 may also include one or more hardwired components, such as a Universal Serial Bus (USB) cable, or the like. The configuration of the network interface 5100 depends on the types of communication desired and may be modified to communicate via Wifi, Bluetooth, and so on.

The external devices 5120 are one or more devices that can be used to provide various inputs to the computing device 5000, e.g., mouse, microphone, keyboard, trackpad, or the like. The external devices 5120 may be local or remote and may vary as desired. In some examples, the external devices 5120 may also include one or more additional sensors.

The technology described herein may be implemented as logical operations and/or modules in one or more systems. The logical operations may be implemented as a sequence of processor implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and Band C). Further, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1-134. (canceled)

135. A system comprising:
a first aerial vehicle; and
a second aerial vehicle coupled to the first aerial vehicle, the second aerial vehicle comprising:
a body defining a payload bay configured to receive a payload;
at least one door configured to selectively cover a bottom of the payload bay; and
a linkage coupling the at least one door to the body, such that the at least one door opens in a sweeping motion towards a side of the body.

136. The system of claim 135, further comprising a pivot, the linkage defining a path of rotation about the pivot to sweep the at least one door around the body.

137. The system of claim 135, wherein the body defines an aperture into the payload bay for removing or releasing the payload, and wherein the at least one door comprises a first door and a second door that together selectively cover the aperture.

138. The system of claim 137, wherein each of the first door and the second door comprises:
an outer region shaped to align with a portion of a perimeter of the aperture; and
an inner region shaped to contact the other door to cover the aperture.

139. The system of claim 137, wherein the linkage is shaped to open the first door and the second door in a direction that follows a shape of the aperture.

140. The system of claim 137, further comprising an actuator coupled to the linkage, the actuator configured to move the first door and the second door towards each other to cover the aperture.

141. The system of claim 140, wherein the actuator comprises a gear assembly.

142. An aerial vehicle comprising:
a body;
a first thruster coupled to the body;
a second thruster coupled to the body;
a first duct in fluid communication with the first thruster, wherein the first duct defines a first intake and a first outlet for the first thruster; and
a second duct in fluid communication with the second thruster, wherein the second duct defines a second intake and a second outlet for the second thruster.

143. The aerial vehicle of claim 142, wherein the first thruster is bidirectional, and wherein the first duct is configured to facilitate a bidirectional generation of thrust by the first thruster.

144. The aerial vehicle of claim 143, wherein the second thruster is bidirectional, and wherein the second duct is configured to facilitate a bidirectional generation of thrust by the second thruster.

145. The aerial vehicle of claim 142, wherein the first intake, the first outlet, the second intake, and the second outlet are defined by flared openings at an exterior of the body.

146. The aerial vehicle of claim 142, wherein each of the first duct and the second duct extends across a width of the aerial vehicle.

147. The aerial vehicle of claim 142, further comprising a third thruster coupled to the body.

148. The aerial vehicle of claim 147, wherein the third thruster is configured to provide a forward or rearward thrust relative to the aerial vehicle, and wherein the first thruster and the second thruster are configured to provide a lateral thrust relative to the aerial vehicle.

149. A system comprising:
a first aerial vehicle;
a second aerial vehicle;
a tether coupling the second aerial vehicle to the first aerial vehicle; and
a retraction assembly configured to provide a deployment or retraction of the tether to adjust a position of the second aerial vehicle relative to the first aerial vehicle

150. The system of claim 149, wherein the retraction assembly comprises:
a spool configured to store an excess length of the tether; and
a winch configured to rotate the spool to retract or extend the tether.

151. The system of claim 150, further comprising a pulley configured to change a direction of the tether between the spool and the second aerial vehicle.

152. The system of claim 151, wherein the first aerial vehicle comprises a frame, and wherein the spool, the winch, and the pulley are coupled to the frame.

153. The system of claim 149, further comprising a receiver associated with the tether and configured to guide the second aerial vehicle to a locked position relative to the first aerial vehicle.

154. The system of claim 149, wherein the first aerial vehicle comprises a bay to receive the second aerial vehicle when the tether is retracted.
